(19) United States
(12) Patent Application Publication
(10) Pub. No.: US 2025/0344093 A1
(43) Pub. Date: Nov. 6, 2025

(54) MEASUREMENT RESOURCE CONFIGURATIONS AND REPORT FORMATS FOR UE-INITIATED BEAM OPERATIONS

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/187,925

(22) Filed: Apr. 23, 2025

Related U.S. Application Data
(60) Provisional application No. 63/642,448, filed on May 3, 2024.
(60) Provisional application No. 63/643,828, filed on May 7, 2024.
(60) Provisional application No. 63/644,881, filed on May 9, 2024.
(60) Provisional application No. 63/645,605, filed on May 10, 2024.
(60) Provisional application No. 63/646,455, filed on May 13, 2024.
(60) Provisional application No. 63/647,457, filed on May 14, 2024.
(60) Provisional application No. 63/682,650, filed on Aug. 13, 2024.

(51) Int. Cl. H04W 24/10; H04B 7/06

(52) U.S. Cl. CPC H04W 24/10; H04B 7/0626; H04B 7/06952

(57) ABSTRACT

Apparatuses and methods for measurement resource configurations and report formats for a user equipment (UE)-initiated beam operation in a wireless communication system. A method includes receiving first information related to an event, receiving second information related to a channel state information (CSI) report, and determining, based on the first and second information, one or more first reference signals (RSs), from a configured set of RSs, that satisfy the event. The method further includes determining the CSI report with a report content including one or more first report quantities corresponding to the one or more first RSs, determining a number of zero values to be padded in the CSI report, and transmitting the CSI report including one or more first indicators each corresponding to a CSI field in the CSI report. Each of the first indicators indicates a presence or absence of a first report quantity in the corresponding CSI field.

### CROSS-REFERENCE TO RELATED APPLICATIONS AND CLAIM OF PRIORITY

The present application claims priority to:
U.S. Provisional Patent Application No. 63/624,448, filed on May 3, 2024;
U.S. Provisional Patent Application No. 63/643,828, filed on May 7, 2024;
U.S. Provisional Patent Application No. 63/644,881, filed on May 9, 2024;
U.S. Provisional Patent Application No. 63/645,605, filed on May 10, 2024;
U.S. Provisional Patent Application No. 63/646,455, filed on May 13, 2024;
U.S. Provisional Patent Application No. 63/647,457, filed on May 14, 2024; and
U.S. Provisional Patent Application No. 63/682,650, filed on Aug. 13, 2024. The contents of the above-identified patent documents are incorporated herein by reference.

### TECHNICAL FIELD

The present disclosure relates generally to wireless communication systems and, more specifically, the present disclosure relates to measurement resource configurations and report formats for a user equipment (UE)-initiated beam operation in a wireless communication system.

### BACKGROUND

5th generation (5G) or new radio (NR) mobile communications has recently gained momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to measurement resource configurations and report formats for a UE-initiated beam operation in a wireless communication system.

In one embodiment, a user equipment (UE) is provided. The UE includes a transceiver configured to receive first information related to an event and receive second information related to a channel state information (CSI) report. The UE further includes a processor operably coupled with the transceiver. The processor is configured to determine, based on the first and second information, one or more first reference signals (RSs), from a configured set of RSs, that satisfy the event, determine, based on the second information, the CSI report with a report content including one or more first report quantities corresponding to the one or more first RSs, and determine, based on the second information and the report content, a number of zero values to be padded in the CSI report. The transceiver is further configured to transmit the CSI report including one or more first indicators each corresponding to a CSI field in the CSI report. Each of the one or more first indicators indicates a presence or absence of a first report quantity in the corresponding CSI field.

In another embodiment, a base station (BS) is provided. The BS includes a processor and a transceiver operably coupled with the processor. The transceiver is configured to transmit first information related to an event, transmit second information related to a CSI report, and receive the CSI report including one or more first indicators each corresponding to a CSI field in the CSI report. The CSI report further includes a report content including one or more first report quantities corresponding to one or more first RSs, from a configured set of RSs, that satisfy the event and a number of zero values padded in the CSI report that are based on the second information and the report content. Each of the one or more first indicators indicates a presence or absence of a first report quantity in the corresponding CSI field.

In yet another embodiment, A method performed by a UE is provided. The method includes receiving first information related to an event, receiving second information related to a CSI report, and determining, based on the first and second information, one or more first RSs, from a configured set of RSs, that satisfy the event. The method further includes determining, based on the second information, the CSI report with a report content including one or more first report quantities corresponding to the one or more first RSs, determining, based on the second information and the report content, a number of zero values to be padded in the CSI report, and transmitting the CSI report including one or more first indicators each corresponding to a CSI field in the CSI report. Each of the one or more first indicators indicates a presence or absence of a first report quantity in the corresponding CSI field.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be provided. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6 illustrates an example of antenna structure according to embodiments of the present disclosure;

FIG. 7 illustrates an example of beam in a wireless communication system according to embodiments of the present disclosure;

FIG. 8 illustrates an example of multi-beams in a wireless communication system according to embodiments of the present disclosure; and

FIG. 9 illustrates an example method performed by a UE in a wireless communication system according to embodiments of the present disclosure.

### DETAILED DESCRIPTION

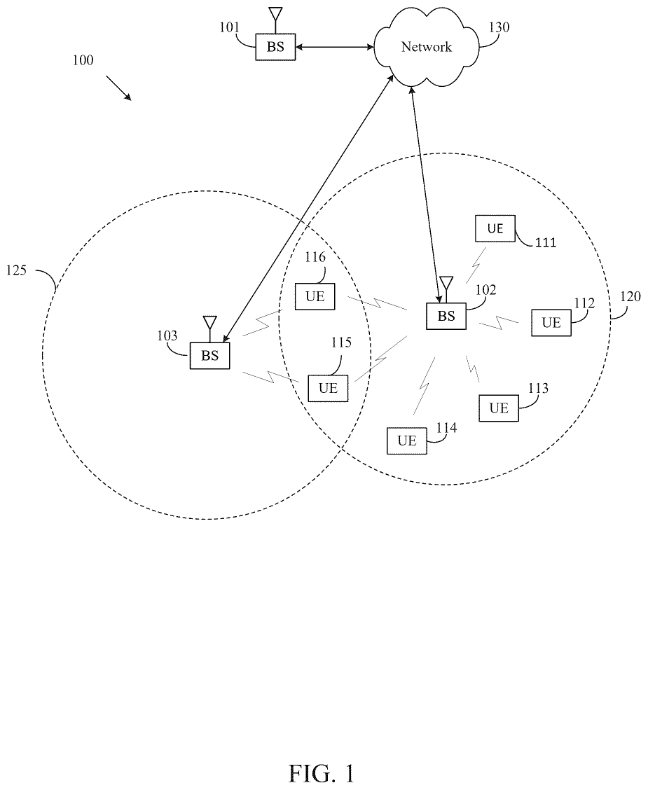

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, embodiments of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for measurement resource configurations and report formats for a UE-initiated beam operation in a wireless communication system. In certain embodiments, and one or more of the gNBs 101-103 includes circuitry, programing, or a combination thereof, for supporting measurement resource configurations and report formats for a UE-initiated beam operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

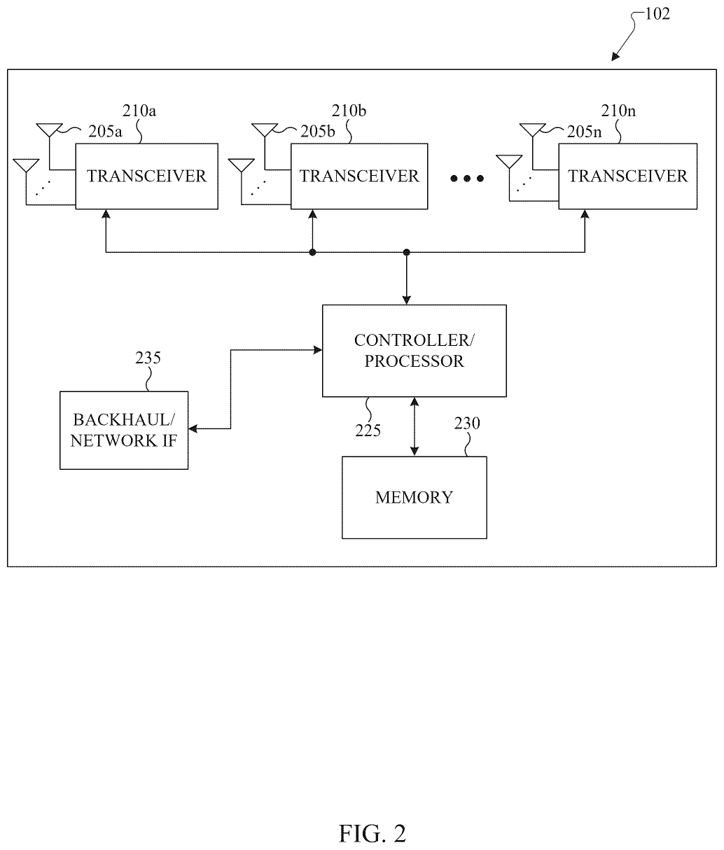

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels or signals and the transmission of DL channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting measurement resource configurations and report formats for a UE-initiated beam operation in a wireless communication system. The controller/processor 225 can move data into or out of the memory 230 as executed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

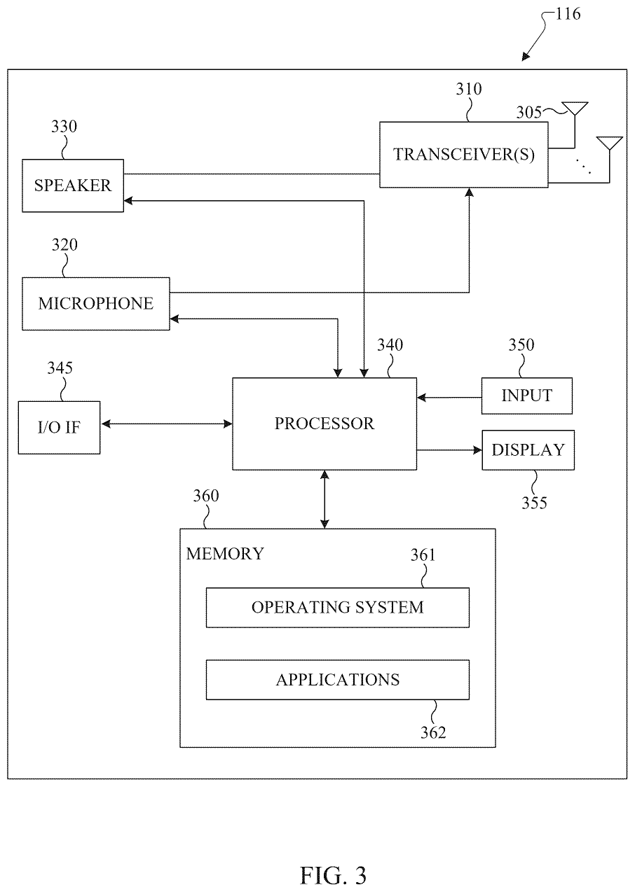

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals, the transmission of UL channels or signals, and reception and transmission of SL channels or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for measurement resource configurations and report formats for a UE-initiated beam operation in a wireless communication system.

The processor 340 can move data into or out of the memory 360 as provided by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

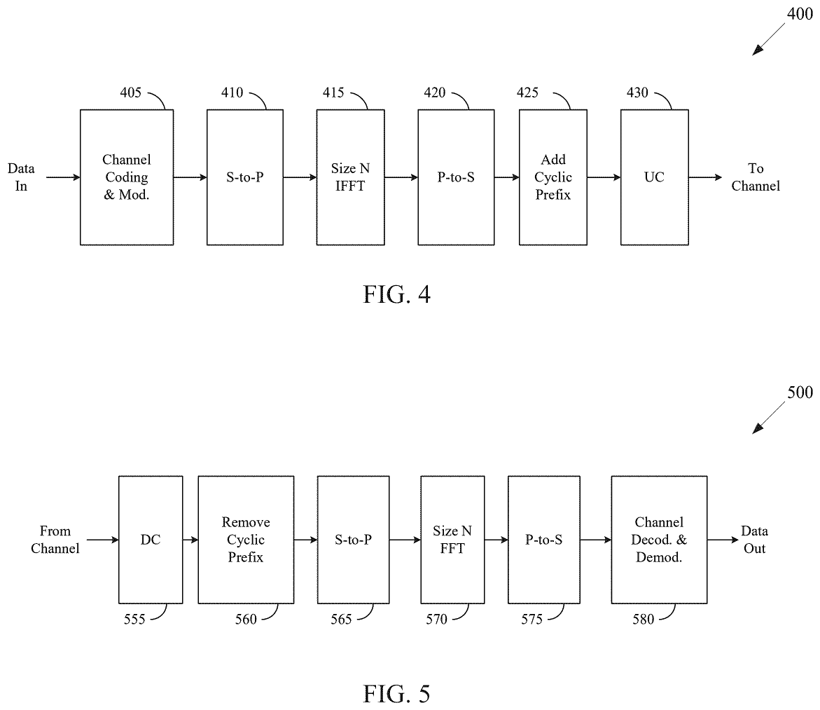

FIG. 4 and FIG. 5 illustrate example wireless transmit and receive paths according to the present disclosure. The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or another UE arrives at the UE 116 after passing through the wireless channel, and reverse operations to those at the gNB 102 or another UE are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or transmitting in the sidelink to another UE and may implement the receive path 500 for receiving in the downlink from the gNBs 101-103 or receiving in the sidelink from another UE. In some embodiments, the transmit path 400 and/or receive path 500 is configured to support measurement resource configurations and report formats for a UE-initiated beam operation in a wireless communication system as described in embodiments of the present disclosure.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In NR, quasi-co-colocation (QCL) properties refers to large scale properties of signals. Two-signals that have a same QCL property are said to be quasi-co-located (QCLed) with respect to that QCL property. QCL properties can be frequency domain-related such Doppler spread or Doppler shift, time domain-related such as average delay or delay spread, or spatial domain-related, for example based on the spatial domain filter transmission filter (transmit beam) or spatial domain reception filter (receive beam). When using the QCL framework, a source reference signal (e.g., source RS) provides a QCL Type (one or more QCL properties) for a target signal or channel. This assists a receiver to receive the target signal or channel. For example, using the QCL framework, a PDSCH DMRS can be QCLed with source RS (e.g., CSI-RS) with respect to a set of QCL properties, the UE is indicated this QCL relation, which assists the UE to receive the PDSCH channel.

In NR, the TCI state framework provides linkage between source RS and QCL Type and is used for QCL information indication for a target RS to the UE.

In the present disclosure, a beam can be determined by any of: (i) a TCI state, that establishes a quasi-colocation (QCL) relationship or spatial relation between a source reference signal (e.g., SSB and/or CSI-RS) and a target reference signal, and/or (ii) a spatial relation information that establishes an association to a source reference signal, such as SSB or CSI-RS or SRS.

Alternatively, a beam can be determined by any of: (i) a port with a static/fixed (e.g., for FR1) or dynamic virtualization (e.g., FR2, FR3), and/or a port group (PG) comprising multiple ports, with a dynamic indication/assignment of one (or two) ports from the multiple ports and associated QCL property=QCL TypeD or spatial relation.

In either case, the ID of the source reference signal or the one (or two) port(s) identifies the beam.

According to embodiments as disclosed in the present disclosure, the TCI state and/or the spatial relation reference RS can determine a spatial Rx filter for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter for reception of uplink channels at the gNB.

Alternatively, for embodiments as disclosed in the present disclosure, the port with dynamic virtualization and/or the PG with dynamic indication of one (or two) ports can determine a spatial Rx filter or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or a port or a PG for reception of uplink channels at the gNB.

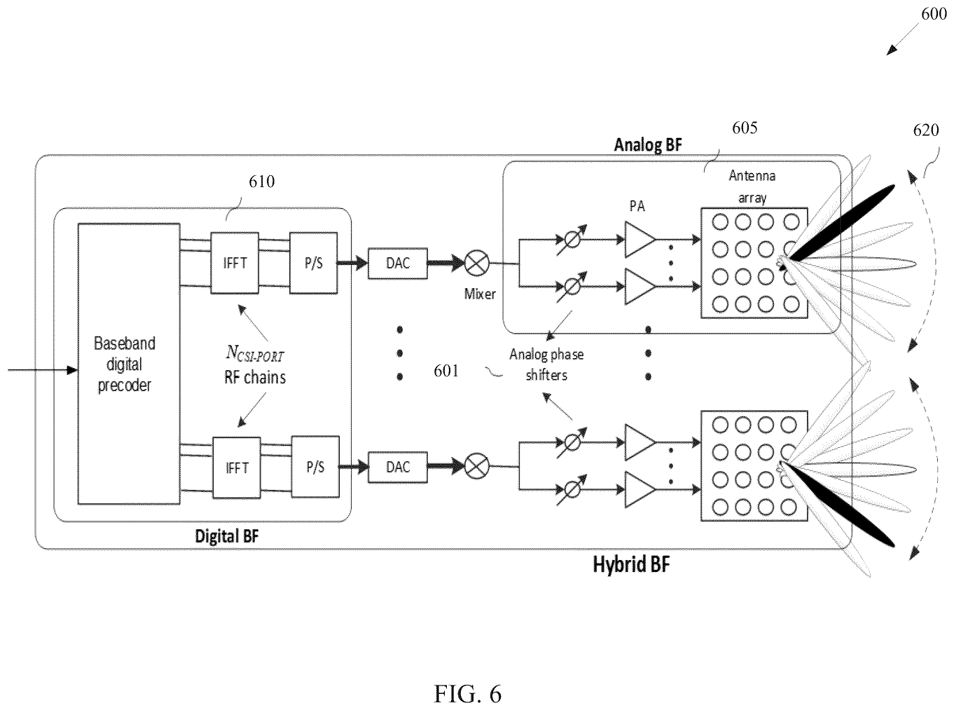

FIG. 6 illustrates an example antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting,” respectively), and receiving a DL or UL or SL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100m distance), larger number of and sharper analog beams (hence larger number of radiators in the array) may be used to compensate for the additional path loss.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

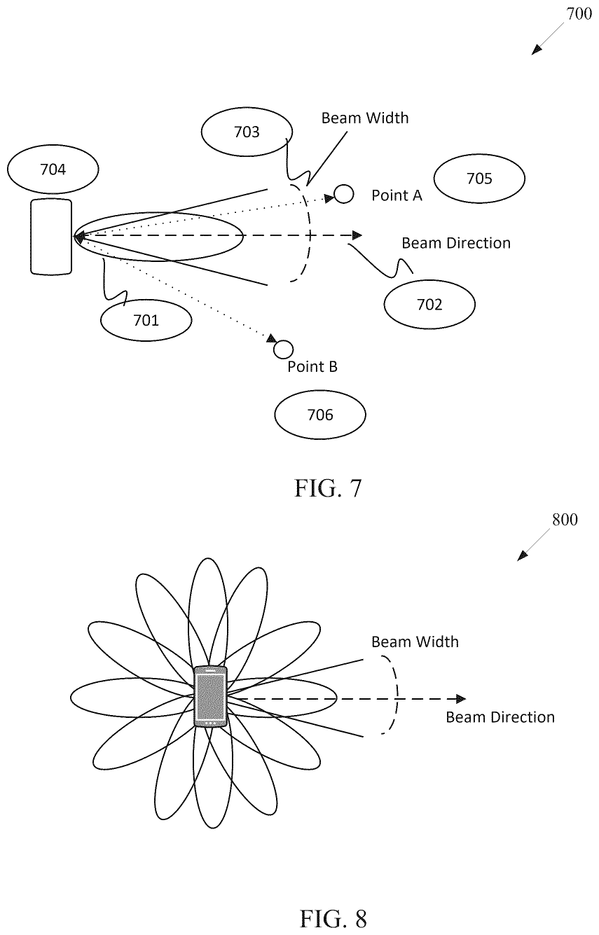

FIG. 7 illustrates an example of beam 700 in a wireless communication system according to embodiments of the present disclosure. An embodiment of the beam 700 shown in FIG. 7 is for illustration only.

As illustrated in FIG. 7, in a wireless system a beam (701), for a device (704), can be characterized by a beam direction (702) and a beam width (703). For example, a device (704) transmits radio frequency (RF) energy in a beam direction and within a beam width. A device (704) receives RF energy in a beam direction and within a beam width. As illustrated in FIG. 7, a device at point A (705) can receive from and transmit to device (704) as Point A is within a beam width and direction of a beam from device (704). As illustrated in FIG. 7, a device at point B (706) cannot receive from and transmit to device (704) as Point B is outside a beam width and direction of a beam from device (704). While FIG. 7, for illustrative purposes, shows a beam in 2-dimensions (2D), it should be apparent to those skilled in the art, that a beam can be in 3-dimensions (3D), where the beam direction and beam width are defined in space.

FIG. 8 illustrates an example of multi-beams 800 in a wireless communication system according to embodiments of the present disclosure. An embodiment of the multi-beams 800 shown in FIG. 8 is for illustration only.

In a wireless system, a device can transmit and/or receive on multiple beams. This is known as “multi-beam operation” and is illustrated in FIG. 8. While FIG. 8, for illustrative purposes, a beam is in a two dimension (2D), it should be apparent to those skilled in the art, that a beam can be 3D, where a beam can be transmitted to or received from any direction in space.

In the present disclosure, a beam is determined by either of: (i) a TCI state, that establishes a quasi-colocation (QCL) relationship between a source reference signal (e.g., SSB and/or CSI-RS) and a target reference signal; and/or (ii) a spatial relation information that establishes an association to a source reference signal, such as SSB or CSI-RS or SRS. In either case, the identifier (ID) of the source reference signal identifies the beam.

The TCI state and/or the spatial relation reference RS can determine a spatial Rx filter for reception of downlink channels at the UE, or a spatial TX filter for transmission of uplink channels from the UE.

In NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although a UE-initiated reporting and/or beam switching and/or beam activation/deactivation can be beneficial, efficient designs are needed to ensure that the latency is reduced and, at the same time, error events can be minimized. Therefore, there is a necessary operation for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g., for beam report, the event can be a beam failure, and for CSI, the event can be a user throughput degradation or increasing retransmission rate).

The present disclosure provides various novel and detailed examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated beam operations. In addition, the present disclosure also provides various report formats customized for the UE-initiated beam reporting, and specifies different conditions or settings to apply or use different report formats.

In the present disclosure, a UE detects (or determines) an operation for transmitting a UE-initiated/UE-triggered report (or initiation/triggering) of a (report-)type (A), (B), or (C), where: (i) (A) includes an initiator/trigger/pre-notification message; (ii) (B) includes a report/content (comprising one or multiple report quantities); and (iii) (C) includes both a trigger/pre-notification message and a (corresponding) report/content.

The UE could send to the network the UE-initiated (UEI)/UE-triggered report of a (report-)type (A), (B) and/or (C) according to one or more of: (i) a fixed rule(s) in system specification(s): for example, the UE could always send to the network a UEI report of a (report-)type (A), or a (report-)type (B), or a (report-)type (C), or a (report-)type (A) followed by a (report-)type (B); (ii) network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with “00” indicating a UEI report of a (report-)type (A), “01” indicating a UEI report of a (report-)type (B), “10” indicating a UEI report of a (report-)type (C), and “11” indicating a UEI report of a (report-)type (A) followed by a (report-)type (B); and/or (iii) UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g., NW/gNB or another device) and the UE, and the content (if reported) can include a quantity or quantities. At least one of the following examples can be used/configured for the content.

In one example, the content includes beam-related quantity/quantities. For example, up to N≥1 indicators {Iᵢ} or pairs of {(Iᵢ,Jᵢ)}, where Iᵢ is a beam (source RS) indicator (e.g., CRI, SSBRI) and Jᵢ is a beam metric (e.g., L1-RSRP, L1-SINR).

In one example, the content includes CSI-related quantity/quantities. For example, at least one of (RI, PMI, CQI, CRI, LI).

In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g., (auto-)correlation values corresponding to a few dominant lags/delays).

In one example, the content includes other (e.g., non-beam, non-CSI, non-TDCP) quantity/quantities.

In one example, quantity/quantities comprises a selector/indicator indicating selection of one (or >1) of either: (i) beam (TCI state) TCI states (e.g., DL TCI state, UL TCI state, or unified (joint) DL/UL TCI state), (ii) panel(s) (e.g., UE panels for DL reception or/and UL transmission), (iii) antenna(e) (e.g., UE antennae for DL reception or/and UL transmission), or (iv) antenna port(s) (e.g., UE antenna ports for DL reception or/and UL transmission).

In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g., this switching is for DL reception or/and UL transmission).

In one example, the content includes beam-related quantity/quantities (as disclosed in the present disclosure) and at least one other quantity/quantities (as disclosed in the present disclosure).

In one example, the content includes CSI-related quantity/quantities (as disclosed in the present disclosure) and at least one other quantity/quantities (as disclosed in the present disclosure).

In one example, the content includes TDCP-related quantity/quantities (as disclosed in the present disclosure) and at least one other quantity/quantities (as disclosed in the present disclosure).

In one example, the content includes beam-related quantity/quantities (as disclosed in the present disclosure) and CSI-related quantity/quantities (as disclosed in the present disclosure).

In one example, the content includes beam-related quantity/quantities (as disclosed in the present disclosure) and TDCP-related quantity/quantities (as disclosed in the present disclosure).

In one example, the content includes TDCP-related quantity/quantities (as disclosed in the present disclosure) and CSI-related quantity/quantities (as disclosed in the present disclosure).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when the UE detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/beam/TDCP | (A) | Yes (e.g., non-CSI-related event) | No |
| | (B) | No | Yes |
| | (C) | Yes (e.g., non-CSI-related event) | Yes |
| 4. other (content-free/less events) | (A) | Yes (no need for content) | No |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), content- | No |
| | specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a “hint/alarm/cue” to the target entity (or purpose of the PN message/trigger as specified herein in the present disclosure) according to at least one of the following examples.

For example, the hint (or purpose of the PN message/trigger as specified herein in the present disclosure) is about the communication link/channel. For example, it can imply a necessary operation for a new or updated report (e.g., beam or CSI or TDCP). In this case, it is up to NW whether to configure a report for the content (separately).

For another example, the hint (or purpose of the PN message/trigger as specified herein in the present disclosure) is about an RS transmission. For example, it can imply a necessary operation for an aperiodic or semi-persistent RS (e.g., CSI-RS, SRS) transmission. The RS transmission can be from the target entity, or from the UE.

For another example, the hint (or purpose of the PN message/trigger as specified herein in the present disclosure) is about a selection/switch. For example, it can imply a necessary operation for switching from current A to another A, where A is one of current panel(s), TRP(s)/RRH(s), resource sets, antenna groups, antenna port groups.

For another example, the hint (or purpose of the PN message/trigger as specified herein in the present disclosure) is about beam/CSI parameters. For example, the parameter can be codebook type (e.g., from Type I to Type II or vice versa), or rank restriction (e.g., from high rank to low rank or vice versa).

For another example, the hint (or purpose of the PN message/trigger as specified herein in the present disclosure) is about RS parameters. For example, the parameter can be related to an AP RS trigger, or RS periodicity, or number of SRS ports (panel switch, 1 panel to 2 panel or vice versa) or number of RS resources.

For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g., CRI-i1 or CRI-i1-CQI or LI-CRI-i1 or LI-CRI-i1-CQI), or based on single TRP to multi-TRP switch (or vice versa).

For another example, the hint (or purpose of the PN message/trigger as specified herein in the present disclosure) is about transmission parameters, e.g., MCS, or number of CWs.

For another example, when there is no pre-notification message/trigger associated with a content, i.e., the report-type is (B), the content can be transmitted using UL resource(s) configured (e.g., configured-grant PUSCH), or reserved for the UE-initiated report, or via a RACH procedure.

For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of following examples.

In one example, fixed rule(s) in system specification(s): for example, the PN message is always used to initiate or request or notify to the network (or the purpose of the PN message is always about) a transmission of a (beam) report/content, which could comprise one or more indicators/triggers and/or report quantities as specified/described herein in the present disclosure.

In another example, network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.

In yet another example, UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of examples.

In one example, fixed rule(s) in system specification(s): for example, the UE could always send to the network a UEI report comprising only a PN message, or comprising only a content according to those specified herein in the present disclosure, or comprising both a PN message and a corresponding content.

In another example, network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with “00” indicating a UEI report comprising only a PN message, “01” indicating a UEI report comprising only a content according to those specified herein in the present disclosure, “10”/“11” indicating a UEI report comprising both a PN message and a corresponding content.

In yet another example, UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of following instances.

In one instance, fixed rule(s) in system specification(s): for example, the UE could always send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could always send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).

In another instance, network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with “0” (or “1”) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and “1” (or “0”) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).

In yet another instance, UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc.

Table 6A and Table 6B show the UEI reporting formats

TABLE 6A
UEI reporting format

| CSI report | |
|---|---|
| number | CSI fields |
| UEI (CSI) | Report content(s)/quantity(s) # I for current serving beam(s) |
| report #n | . . . |
| | Report content(s)/quantity(s) #Nserv for current |
| | serving beam(s) |
| | Report content(s)/quantity(s) #I for candidate beam(s) |
| | . . . |
| | Report content(s)/quantity(s) #Ncand for candidate beam(s) |

Report content(s)/quantity(s) includes: SSBRI/CRI, L1-RSRP/L 1-SINR and/or etc.

TABLE 6B
UEI reporting format

| CSI report | |
|---|---|
| number | CSI fields |
| UEI (CSI) | First indicator (set index/indicator) |
| report #n | Report content(s)/quantity(s) # I for current serving beam(s) |
| | . . . |
| | Report content(s)/quantity(s) #Nserv for current |
| | serving beam(s) |
| | Second indicator (set index/indicator) |
| | Report content(s)/quantity(s) #I for candidate beam(s) |
| | . . . |
| | Report content(s)/quantity(s) #Ncand for candidate beam(s) |

Report content(s)/quantity(s) includes: SSBRI/CRI, L1-RSRP/L 1-SINR and/or etc.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).

For example, the UE could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report may comprise (1), (2) and/or (3) as disclosed in the present disclosure; for instance, when a higher layer RRC signaling/parameter denoted by “servBeamInclusion” is provided or configured, the UEI report may comprise (1) and/or (3); otherwise, the UEI report may comprise (2).

Alternatively, when a higher layer RRC signaling/parameter, e.g., denoted by ueiReportContent is set to “servBeamOnly,” the UEI report may comprise (a), when the higher layer RRC signaling/parameter ueiReportContent is set to “candBeamOnly,” the UEI report may comprise (b), and/or when the higher layer RRC signaling/parameter ueiReportContent is set to “bothServAndCandBeam,” the UEI report may comprise (c). In this case, for (c), i.e., when the UE is configured to send a UEI report comprising report quantity(s)/content(s)—including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).

For another example, the UE could autonomously determine, select or decide whether or not the UEI report may comprise (a), (b) and/or (c) as disclosed in the present disclosure, and indicate to the network, e.g., in/by part of the UEI report including the PN message, their determination or selection or decision.

In one example, the UE could send to the network a/the PN message to indicate to the network whether or not the UEI report comprises (a), (b) and/or (c) as disclosed in the present disclosure. For instance, the PN message could be or could comprise a one-bit indicator; when the one-bit indicator is set to “0” (or “1”), the UEI report comprises (a) and/or (c); otherwise, the UEI report comprises (b). Alternatively, the PN message could be or could comprise a multi-bit indicator (e.g., a two-bit indicator); when the two-bit indicator is set to “00” (“01,” “10,” or “11”), the UEI report comprise (a), when the two-bit indicator is set to “01” (“00,” “10,” or “11”), the UEI report comprises (b), and/or when the two-bit indicator is set to “10” or “11” (“00” or “01”), the UEI report comprises (c).

In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when a bit position/entry of the bitmap is set to “0” (or “1”), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when a bit position/entry of the bitmap is set to “1” (or “0”), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).

In another example, each of the report content(s)/quantity(s) including a resource indicator such as an SSBRI/CRI or a beam metric such as a L1-RSRP/L1-SINR in a UEI report could be associated with an indicator provided in the same UEI report. In this case, the indicator could be a one-bit indicator; when the one-bit indicator is set to “0” (or “1”), the resource indicator (including SSBRI and/or CRI) and/or the beam metric (including L1-RSRP and/or L1-SINR) associated/corresponding to the one-bit indicator could correspond to a current serving beam, and/or when the one-bit indicator is set to “1” (or “0”), the resource indicator (including SSBRI and/or CRI) and/or the beam metric (including L1-RSRP and/or L1-SINR) associated/corresponding to the one-bit indicator could correspond to a candidate beam.

In another example, each of the report content(s)/quantity(s) including a resource indicator such as an SSBRI/CRI or a beam metric such as a L1-RSRP/L1-SINR in a UEI report could be associated with an on/off indicator provided in the same UEI report. In this case, when the indicator is on or present in the UEI report or set to “on,” the resource indicator (including SSBRI and/or CRI) and/or the beam metric (including L1-RSRP and/or L1-SINR) associated/corresponding to the indicator could correspond to a current serving beam, and/or when the indicator is off or absent from the UEI report or set to “off,” the resource indicator (including SSBRI and/or CRI) and/or the beam metric (including L1-RSRP and/or L1-SINR) associated/corresponding to the indicator could correspond to a candidate beam.

In another example, for (c), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s).

Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s). One conceptual example characterizing the UEI reporting format as disclosed in the present disclosure is presented in Table 6A.

In another example, for (c), a first indicator and/or a second indicator could be provided, reported, sent, comprised, included, contained or transmitted in a/the UEI report as specified herein in the present disclosure. For this example, the first indicator could be specific/associated/corresponding to or could be used to indicate a serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure, and/or the second indicator could be specific/associated/corresponding to or could be used to indicate a candidate beam(s) RS set and/or information related to report content(s)/quantity(s) including resource indicator(s) such as SSBRI(s)/CRI(s) and/or beam metric(s) such as L1-RSRP(s)/L1-SINR(s) for one or more candidate beams according to those specified herein in the present disclosure.

In particular, the first indicator could correspond to a set index/indicator for a serving beam(s) RS set denoted by so according to those specified herein in the present disclosure—e.g., the set index/indicator for the serving beam(s) RS set, and therefore, the first indicator, could be “0” (or “1” or “2”); optionally or alternatively, the first indicator could correspond to a one-bit indicator (e.g., a one-bit set index/indicator) with “0” (or “1” or “2”) corresponding to/indicating the serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure.

Furthermore, the second indicator could correspond to a set index/indicator for a candidate beam(s) RS set denoted by s̅₁ according to those specified herein in the present disclosure—e.g., the set index/indicator for the candidate beam(s) RS set, and therefore, the second indicator, could be “1” (or “0” or “2”); optionally or alternatively, the second indicator could correspond to a one-bit indicator (e.g., a one-bit set index/indicator) with “1” (or “0” or “2”) corresponding to/indicating the candidate beam(s) RS set and/or information related to report content(s)/quantity(s) including resource indicator(s) such as SSBRI(s)/CRI(s) and/or beam metric(s) such as L1-RSRP(s)/L1-SINR(s) for the candidate beam(s) according to those specified herein in the present disclosure. Denote the number of the report content(s)/quantity(s) including resource indicator(s) such as SSBRI(s)/CRI(s) and/or beam metric(s) such as L1-RSRP(s)/L1-SINR(s) corresponding to current serving beam(s) in a/the UEI report by Nserv, the first Nserv CSI fields in the UEI report following the CSI field that provides, carries or conveys the first indicator could be used to provide, carry or convey the Nserv report content(s)/quantity(s) specific to/for the current serving beam(s).

In addition, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) in a/the UEI report by Ncand, the first Ncand CSI fields in the UEI report following the CSI field that provides, carries or conveys the second indicator could be used to provide, carry or convey the Ncand report content(s)/quantity(s) specific to/for the candidate beam(s). The CSI field that provides, carries or conveys the first indicator in a/the UEI report, and/or the CSI field that provides, carries or conveys the second indicator in a/the UEI report, could be fixed—e.g., the CSI field that provides, carries or conveys the first (or second) indicator could correspond to the first (or 1^{st}) CSI field in a/the UEI report, and/or the CSI field that provides, carries or conveys the second (or first) indicator could correspond the first (or 1^{st}) CSI field that follows or is after the last CSI field that provides, carries or conveys the report content(s)/quantity(s) including resource indicator(s) such as SSBRI(s)/CRI(s) and/or beam metric(s) such as L1-RSRP(s)/L1-SINR(s) corresponding to the current serving (or candidate) beam(s)—in Table 6B, a conceptual example capturing the UEI reporting format according to those specified herein in the present disclosure is provided.

Furthermore, the CSI field that provides, carries or conveys the first indicator in a/the UEI report, and/or the CSI field that provides, carries or conveys the second indicator in a/the UEI report, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network via various UL channels/signals including PUCCH, PUSCH, PRACH, and/or etc.

In another example, for (c), each of the report contents/quantities (such as resource indicators SSBRIs/CRIs and/or beam metrics L1-RSRPs/L1-SINRs) in a UEI report could be associated/corresponding/specific to an indicator, which could be conveyed, provided, indicated, contained, included or comprised in the (same) UEI report. For example, the indicator could correspond to a set index/indicator for a serving beam(s) RS set denoted by s̅₀ according to those specified herein in the present disclosure or a candidate beam(s) RS set denoted by ŝ₁ according to those specified herein in the present disclosure—e.g., the indicator (or equivalently, the set index/indicator) could be “0” (or “1” or ‘2’) for the serving beam(s) RS set, and “1” (or “0” or ‘2’) for the candidate beam(s) RS set.

For another example, the indicator could correspond to a one-bit indicator with “0” (or “1” or ‘2’) corresponding to/indicating the serving beam(s) RS set and/or information related to current serving beam(s), and “1” (or “0” or ‘2’) corresponding to/indicating the candidate beam(s) RS set and/or information related to candidate beam(s). In this case, when an indicator associated/corresponding/specific to a report content/quantity as specified/defined herein in the present disclosure in a UEI report is set to “0” (or “1” or ‘2’), the report content/quantity could be associated/corresponding/specific to the current serving beam(s), and when an indicator associated/corresponding/specific to a report content/quantity as specified/defined herein in the present disclosure in a UEI report is set to “1” (or “0” or ‘2’), the report content/quantity could be associated/corresponding/specific to the candidate beam(s).

In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when a bit position/entry of the bitmap is set to “0” (or “1”), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when a bit position/entry of the bitmap is set to “1” (or “0”), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).

In another example, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when a beam metric such as a L1-RSRP or a L1-SINR reported in the UEI report is below (or beyond) the first threshold, the report content(s)/quantity(s) including a resource indicator such as an SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when a beam metric such as a L1-RSRP or a L1-SINR reported in the UEI report is beyond (or below) the second threshold, the report content(s)/quantity(s) including a resource indicator such as an SSBRI or a CRI associated/corresponding to the beam metric could be or could correspond to a candidate beam.

In the examples, the value(s) of Nserv and/or Ncand could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

For instance, the UE could send or transmit PN message(s) to indicate the value(s) of Nserv and/or Ncand, and/or to indicate information related to the value(s) of Nserv and/or Ncand, wherein the PN message(s) could be in part 1 of a two-part UEI report (or a two-part UCI). Optionally, according to those specified herein in the present disclosure, a UEI report could comprise a mixture of both CRI(s) and SSBRI(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the CRI(s) and/or SSBRI(s) reported in the same UEI report. In addition, one or more of the resource indicators reported in the UEI report could be associated or corresponding or specific to an indicator (provided, indicated, contained, included or comprised in the same UEI report). The indicator(s) could indicate whether the resource indicator(s) associated or corresponding or specific to the indicator(s) is CRI(s) or SSBRI(s).

For instance, the indicator(s) could be one-bit indicator(s), and when an indicator is set to “0” (or “1”), the resource indicator(s) associated or corresponding or specific to the indicator in a UEI report could correspond to an SSBRI, and when an indicator is set to “1” (or “0”), the resource indicator(s) associated or corresponding or specific to the indicator in the UEI report could correspond to a CRI. Furthermore, a UEI report could also comprise a mixture of both L1-RSRP(s) and L1-SINR(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the L1-RSRP(s) and/or L1-SINR(s) reported in the same UEI report. In addition, one or more of the radio link/beam quality(s) or metric(s) reported in the UEI report could be associated or corresponding or specific to an indicator (provided, indicated, contained, included or comprised in the same UEI report). The indicator(s) could indicate whether the radio link/beam quality(s)/metric(s) associated or corresponding or specific to the indicator(s) is L1-RSRP(s) or L1-SINR(s).

For instance, the indicator(s) could be one-bit indicator(s), and when an indicator is set to “0” (or “1”), the radio link/beam quality(s)/metric(s) associated or corresponding or specific to the indicator in a UEI report could correspond to a L1-RSRP, and when an indicator is set to “1” (or “0”), the radio link/beam quality(s)/metric(s) associated or corresponding or specific to the indicator in the UEI report could correspond to a L1-SINR.

For one or more measurement instances or one or more measurement occasions corresponding to one or more measurement RSs for one or more current serving beams, a UE could detect or declare or identify or determine an instance for a first event (denoted by Event-1) when the UE has identified or determined that radio link or beam quality(s)—including at least L1-RSRP(s)—of the one or more measurement RSs for the one or more current serving beams is below or less than or equal to a threshold-A, wherein the threshold-A value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, (a) when Event-1 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventOneConfig (e.g., set to “enabled”) and/or a higher layer parameter eventType set to “Event-1,” and/or (b) when the UE has determined or identified or detected that within a time window/period/gap/offset, a number of instances of the first event (denoted by N_1) according to or following those specified/defined herein in the present disclosure is greater than or equal to a minimum value/number denoted by N_min, and/or (c) when the UE has determined or identified or detected an instance of the first event according to or following those specified/defined herein in the present disclosure, the UE could increase a number of count in a counter (e.g., specific to the Event-1) by 1 and/or when the number of counts (denoted by N_1) in the counter reaches to a maximum number of counts denoted by N_max before a timer (e.g., specific to the Event-1) has expired, the UE could declare (occurrence of) the first event (i.e., the Event-1), and initiate/trigger the corresponding beam reporting. For (c), the corresponding MAC entity may be for each serving cell configured for UE-initiated (UEI)/event-driven reporting according to those specified herein in the present disclosure.

Table 7 shows the initiation of the triggering UEI/event driven reporting.

TABLE 7
the initiation of the triggering UEI/event driven reporting

| 1> | to initiate or trigger a UEI/event-driven reporting based on or according to detection or declaration | |
|---|---|---|
| | of the first event (or the Event-1): | |
| | 2> | if an indication for an instance for the first event or Event-1 as specified/defined herein in the |
| | | present disclosure has been received from lower layers: |

| | |
|---|---|
| 3> | start or restart the firstEventInstanceDetectionTimer (higher layer configured for the first |
| | event - when applicable) |
| 3> | increment firstEvent_COUNTER (higher layer configured for the first event - when |
| | applicable) by 1; |
| 3> | if firstEvent_COUNTER >= firstEventInstanceMaxCount or N_max (configured for the first |
| | event - when applicable), wherein the firstEventInstanceMaxCount or N_max is higher |
| | layer configured for the first event - when applicable: |

| | |
|---|---|
| 4> | trigger a UEI (beam) reporting corresponding/specific to the first event - when |
| | applicable - for this serving cell. |

| | |
|---|---|
| 2> | if the firstEventInstanceDetectionTimer (for the first event - when applicable) expires; and/or |
| 2> | if the firstEventInstanceDetectionTimer (for the first event - when applicable), |
| | firstEvent_COUNTER (for the first event - when applicable), or any of the reference signals |
| | used for UEI reporting - e.g., including that/those specific to/for the current serving beam(s) |
| | and/or the candidate beam(s) as specified or defined herein in the present disclosure specific |
| | to/for the first event - is reconfigured by upper layers associated with this serving cell; and/or |
| 2> | if the reference signal(s) associated with this serving cell used for |
| | detection/declaration/indication for the first event as specified/defined herein in the present |
| | disclosure is changed and/or reconfigured by upper layers associated with this serving cell; |
| | and/or |
| 2> | if the UE has received or detected or determined or identified a network's response to the UE- |
| | initiated/event-driven beam reporting corresponding/specific to the first event - when |
| | applicable - for this serving cell: |

| | |
|---|---|
| 3> | set firstEvent_COUNTER (for the first event - when applicable) to 0; and/or |
| 3> | stop firstEventInstanceDetectionTimer (for the first event - when applicable); and/or |
| 3> | stop the ueiReportingTimer, if configured; and/or |
| 3> | consider the UE-initiated (UEI) reporting procedure triggered or initiated with respect to the |
| | first event successfully completed, and/or cancel all the UEI report(s) triggered or initiated |
| | with respect to at least the first event for this serving cell. |

The value(s) of the N_min N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Furthermore, the network's response to the UE-initiated/event-driven reporting corresponding/specific to the first event (or the Event-1) could be in form of or could comprise one or more of the following components as shown in following examples.

In one example, a PDCCH reception in a search space set provided by beamReportingEventOneSearchSpaceId for which the UE could detect a DCI format with CRC scrambled by C-RNTI or MCS-C-RNTI.

In another example, a PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure).

In yet another example, a PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value.

In yet another example, a one-bit indicator set to “1” (or “0”) or an ACK provided/indicated in a DCI format (e.g., DCI format 0_0_1, 0_2, 0_3, 1_0, 1_1, 1_2, 1_3, and/or etc.).

In yet another example, TCI state(s) update/indication via a MAC CE activation/deactivation command or a DCI (e.g., DCI format 1_1/1_2 with or without DL assignment and/or DCI format 1_3) or a MAC CE cell switching command (CSC), wherein the updated/indicated TCI state(s) could correspond to beam(s) (or RS(s)) reported by the UE in the UE-initiated/event-driven beam report(s).

In yet another example, TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s).

In yet another example, TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s).

In yet another example, a non-zero CSI request field (and therefore, a corresponding trigger state) in a DCI (e.g., of a DCI format 0_1 or 02).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “on.”

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “off” or without the higher layer parameter repetition (or equivalently, the higher layer parameter repetition is not present or is absent).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info.

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent).

Furthermore, the network's response to the UE-initiated/event-driven reporting corresponding/specific to the first event (or the Event-1) and/or the medium/container such as RRC signaling(s), MAC CE command(s) and/or DCI format(s) used to carry/convey the network's response to the UE-initiated/event-driven reporting corresponding/specific to the first event (or the Event-1) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When an/the event-driven or event-triggered (beam) reporting for L1/L2 triggered mobility (LTM) is configured or enabled (e.g., when the UE is provided a higher layer RRC signaling/parameter LTM-Config/LTM-CSI-ResourceConfig/LTM-CSI-ReportConfig and/or “event-driven reporting” in LTM-Config/LTM-CSI-ResourceConfig/LTM-CSI-ReportConfig set to “enabled”), the first event or the Event-1 as disclosed in the present disclosure could be denoted by or referred to as a first LTM event or a LTM Event-1.

For the first LTM event or the LTM Event-1, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more candidate/new beams, a UE could detect or declare or identify or determine an instance for a second event (denoted by Event-2) when the UE has identified or determined that radio link or beam quality(s)—including at least L1-RSRP(s)—of the one or more measurement RSs for the one or more candidate/new beams is below or less than or equal to a threshold-B, wherein the threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, (a) when Event-2 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventTwoConfig (e.g., set to “enabled”) and/or a higher layer parameter eventType set to “Event-2,” and/or (b) when the UE has determined or identified or detected that within a time window/period/gap/offset, a number of instances of the second event (denoted by N_2) according to or following those specified/defined herein in the present disclosure is greater than or equal to a minimum value/number denoted by N_min, and/or (c) when the UE has determined or identified or detected an instance of the second event according to or following those specified/defined herein in the present disclosure, the UE could increase a number of count in a counter (e.g., specific to the Event-2) by 1 and/or when the number of counts (denoted by N_2) in the counter reaches to a maximum number of counts denoted by N_max before a timer (e.g., specific to the Event-2) has expired, the UE could declare (occurrence of) the second event (i.e., the Event-2), and initiate/trigger the corresponding beam reporting. For (c), the corresponding MAC entity may be for each serving cell configured for UE-initiated (UEI)/event-driven reporting according to those specified herein in the present disclosure. Table 8 shows the initiation of the triggering UEI/event driven reporting.

TABLE 8
the initiation of the triggering UEI/event driven reporting

| 1> | to initiate or trigger a UEI/event-driven reporting based on or according to detection or declaration | |
|---|---|---|
| | of the second event (or the Event-2): | |
| | 2> | if an indication for an instance for the second event or Event-2 as specified/defined herein in |
| | | the present disclosure has been received from lower layers: |

| | |
|---|---|
| 3> | start or restart the secondEventInstanceDetectionTimer (higher layer configured for the |
| | second event - when applicable) |
| 3> | increment secondEvent_COUNTER (higher layer configured for the second event - when |
| | applicable) by 1; |
| 3> | if secondEvent_COUNTER >= secondEventInstanceMaxCount or N_max (configured for |
| | the second event - when applicable), wherein the secondEventInstanceMaxCount or N_max |
| | is higher layer configured for the second event - when applicable: |

| | |
|---|---|
| 4> | trigger a UEI (beam) reporting corresponding/specific to the second event - when |
| | applicable - for this serving cell. |

| | |
|---|---|
| 2> | if the secondEventInstanceDetectionTimer (for the second event - when applicable) expires; |
| | and/or |
| 2> | if the secondEventInstanceDetectionTimer (for the second event - when applicable), |
| | secondEvent_COUNTER (for the second event - when applicable), or any of the reference |
| | signals used for UEI reporting - e.g., including that/those specific to/for the current serving |
| | beam(s) and/or the candidate beam(s) as specified or defined herein in the present disclosure |
| | specific to/for the second event - is reconfigured by upper layers associated with this serving |
| | cell; and/or |
| 2> | if the reference signal(s) associated with this serving cell used for |
| | detection/declaration/indication for the second event as specified/defined herein in the present |
| | disclosure is changed and/or reconfigured by upper layers associated with this serving cell; |
| | and/or |
| 2> | if the UE has received or detected or determined or identified a network's response to the UE- |
| | initiated/event-driven beam reporting corresponding/specific to the second event - when |
| | applicable - for this serving cell: |

| | |
|---|---|
| 3> | set secondEvent_COUNTER (for the second event - when applicable) to 0; and/or |
| 3> | stop secondEventInstanceDetectionTimer (for the second event - when applicable); and/or |
| 3> | stop the ueiReportingTimer, if configured; and/or |
| 3> | consider the UE-initiated (UEI) reporting procedure triggered or initiated with respect to the |
| | second event successfully completed, and/or cancel all the UEI report(s) triggered or |
| | initiated with respect to at least the second event for this serving cell. |

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Furthermore, the network's response to the UE-initiated/event-driven reporting corresponding/specific to the second event (or the Event-2) could be in form of or could comprise one or more of the following components as shown in following example.

In one example, a PDCCH reception in a search space set provided by beamReportingEventTwoSearchSpaceId for which the UE could detect a DCI format with CRC scrambled by C-RNTI or MCS-C-RNTI.

In another example, a PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure).

In yet another example, a PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value.

In yet another example, a one-bit indicator set to “1” (or “0”) or an ACK provided/indicated in a DCI format (e.g., DCI format 0_0, 0_1, 0_2, 0_3, 1_0, 1_1, 1_2, 1_3, and/or etc.).

In yet another example, TCI state(s) update/indication via a MAC CE activation/deactivation command or a DCI (e.g., DCI format 1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s).

In yet another example, TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s).

In yet another example, TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s).

In yet another example, a non-zero CSI request field (and therefore, a corresponding trigger state) in a DCI (e.g., of a DCI format 0_1 or 02).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “on.”

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “off” or without the higher layer parameter repetition (or equivalently, the higher layer parameter repetition is not present or is absent).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info.

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent).

Furthermore, the network's response to the UE-initiated/event-driven reporting corresponding/specific to the second event (or the Event-3) and/or the medium/container such as RRC signaling(s), MAC CE command(s) and/or DCI format(s) used to carry/convey the network's response to the UE-initiated/event-driven reporting corresponding/specific to the second event (or the Event-2) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When an/the event-driven or event-triggered (beam) reporting for L1/L2 triggered mobility (LTM) is configured or enabled (e.g., when the UE is provided a higher layer RRC signaling/parameter LTM-Config/LTM-CSI-ResourceConfig/LTM-CSI-ReportConfig and/or “event-driven reporting” in LTM-Config/LTM-CSI-ResourceConfig/LTM-CSI-ReportConfig set to “enabled”), the second event or the Event-2 as disclosed in the present disclosure could be denoted by or referred to as a second LTM event or a LTM Event-2. For the second LTM event or the LTM Event-2, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more current serving beams and/or one or more measurement RSs for one or more candidate/new beams, a UE could detect or declare or identify or determine an instance for a third event (denoted by Event-3) when the UE has identified or determined that the radio link or beam quality(s)—including at least L1-RSRP(s)—of the one or more measurement RSs for the one or more current serving beams is below or less than or equal to a threshold-A, and the radio link or beam quality(s)—including at least L1-RSRP(s)—of the one or more measurement RSs for the one or more candidate/new beams is beyond or greater than or equal to a threshold-B, wherein the threshold-A and/or threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

In this case, (a) when Event-3 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventThreeConfig (e.g., set to “enabled”) and/or a higher layer parameter eventType set to “Event-3,” and/or (b) when the UE has determined or identified or detected that within a time window/period/gap/offset, a number of instances of the third event (denoted by N_3) according to or following those specified/defined herein in the present disclosure is greater than or equal to a minimum value/number denoted by N_min, and/or (c) when the UE has determined or identified or detected an instance of the third event according to or following those specified/defined herein in the present disclosure, the UE could increase a number of count in a counter (e.g., specific to the Event-3) by 1 and/or when the number of counts (denoted by N_3) in the counter reaches to a maximum number of counts denoted by N_max before a timer (e.g., specific to the Event-3) has expired, the UE could declare (occurrence of) the third event (i.e., the Event-3), and initiate/trigger the corresponding beam reporting. For (c), the corresponding MAC entity may be for each serving cell configured for UE-initiated (UEI)/event-driven reporting according to those specified herein in the present disclosure. Table 9 shows the initiation or triggering the UEI/event-driven reporting.

TABLE 9
The initiation or triggering the UEI/event-driven reporting.

| 1> | to initiate or trigger a UEI/event-driven reporting based on or according to detection or declaration | |
|---|---|---|
| | of the third event (or the Event-3): | |
| | 2> | if an indication for an instance for the third event or Event-3 as specified/defined herein in the |
| | | present disclosure has been received from lower layers: |

| | |
|---|---|
| 3> | start or restart the thirdEventInstanceDetectionTimer (higher layer configured for the third |
| | event - when applicable) |
| 3> | increment thirdEvent_COUNTER (higher layer configured for the third event - when |
| | applicable) by 1; |
| 3> | if thirdEvent_COUNTER >= thirdEventInstanceMaxCount or N_max (configured for the |
| | third event - when applicable), wherein the thirdEventInstanceMaxCount |
| | higher layer configured for the third event - when applicable: or N_max is |

| | |
|---|---|
| 4> | trigger a UEI (beam) reporting corresponding/specific to the third event - when |
| | applicable - for this serving cell. |

| | |
|---|---|
| 2> | if the thirdEventInstanceDetectionTimer (for the third event - when applicable) expires; and/or |
| 2> | if the thirdEventInstanceDetectionTimer (for the third event - when applicable), |
| | thirdEvent COUNTER (for the third event - when applicable), or any of the reference signals |
| | used for UEI reporting - e.g., including that/those specific to/for the current serving beam(s) |
| | and/or the candidate beam(s) as specified or defined herein in the present disclosure specific |
| | to/for the third event - is reconfigured by upper layers associated with this serving cell; and/or |
| 2> | if the reference signal(s) associated with this serving cell used for |
| | detection/declaration/indication for the third event as specified/defined herein in the present |
| | disclosure is changed and/or reconfigured by upper layers associated with this serving cell; |
| | and/or |
| 2> | if the UE has received or detected or determined or identified a network's response to the UE- |
| | initiated/event-driven beam reporting corresponding/specific to the third event - when |
| | applicable - for this serving cell: |

| | |
|---|---|
| 3> | set thirdEvent_COUNTER (for the third event - when applicable) to 0; and/or |
| 3> | stop thirdEventInstanceDetectionTimer (for the third event - when applicable); and/or |
| 3> | stop the ueiReportingTimer, if configured; and/or |
| 3> | consider the UE-initiated (UEI) reporting procedure triggered or initiated with respect to the |
| | third event successfully completed, and/or cancel all the UEI report(s) triggered or initiated |
| | with respect to at least the third event for this serving cell. |

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Furthermore, the network's response to the UE-initiated/event-driven reporting corresponding/specific to the third event (or the Event-3) could be in form of or could comprise one or more of the following components as shown in following examples.

In one example, a PDCCH reception in a search space set provided by beamReportingEventThreeSearchSpaceId for which the UE could detect a DCI format with CRC scrambled by C-RNTI or MCS-C-RNTI.

In another example, a PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure).

In yet another example, a PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value.

In yet another example, a one-bit indicator set to “1” (or “0”) or an ACK provided/indicated in a DCI format (e.g., DCI format 0_0, 0_1, 0_2, 0_3, 1_0, 1_1, 1_2, 1_3, and/or etc.).

In yet another example, TCI state(s) update/indication via a MAC CE activation/deactivation command or a DCI (e.g., DCI format 1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s).

In yet another example, TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s).

In yet another example, TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s).

In yet another example, a non-zero CSI request field (and therefore, a corresponding trigger state) in a DCI (e.g., of a DCI format 0_1 or 02).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “on.”

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “off” or without the higher layer parameter repetition (or equivalently, the higher layer parameter repetition is not present or is absent).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info.

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent)

Furthermore, the network's response to the UE-initiated/event-driven reporting corresponding/specific to the third event (or the Event-3) and/or the medium/container such as RRC signaling(s), MAC CE command(s) and/or DCI format(s) used to carry/convey the network's response to the UE-initiated/event-driven reporting corresponding/specific to the third event (or the Event-3) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When an/the event-driven or event-triggered (beam) reporting for L1/L2 triggered mobility (LTM) is configured or enabled (e.g., when the UE is provided a higher layer RRC signaling/parameter LTM-Config/LTM-CSI-ResourceConfig/LTM-CSI-ReportConfig and/or “event-driven reporting” in LTM-Config/LTM-CSI-ResourceConfig/LTM-CSI-ReportConfig set to “enabled”), the third event or the Event-3 as disclosed in the present disclosure could be denoted by or referred to as a third LTM event or a LTM Event-3. For the third LTM event or the LTM Event-3, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more current serving beams and/or one or more measurement RSs for one or more candidate/new beams, a UE could detect or declare or identify or determine an instance for a fourth event (denoted by Event-4) when the UE has identified or determined that the radio link or beam quality(s)—including at least L1-RSRP(s)—of the one or more measurement RSs for the one or more (or at least one) candidate/new beams is beyond or greater than the radio link or beam quality(s)—including at least L1-RSRP(s)—of the one or more measurement RSs for the one or more current serving beams by a threshold-C, wherein the threshold-C value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

In this case, (a) when Event-4 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventFourConfig (e.g., set to “enabled”) and/or a higher layer parameter eventType set to “Event-4,” and/or (b) when the UE has determined or identified or detected that within a time window/period/gap/offset, a number of instances of the fourth event (denoted by N_4) according to or following those specified/defined herein in the present disclosure that have at least one same candidate/new beam determined/identified during the measurement instance(s)/occasion(s) is greater than or equal to a minimum value/number denoted by N_min, and/or (c) when the UE has determined or identified or detected an instance of the fourth event (i.e., an Event-4 instance) according to or following those specified/defined herein in the present disclosure and a candidate/new beam, the UE could increase a number of count in a counter (e.g., specific to the Event-4 or the Event-4 instance or the candidate/new beam) by 1 and/or when the number of counts (denoted by N_4) in the counter reaches to a maximum number of counts denoted by N_max before a timer (e.g., specific to the Event-4 or the Event-4 instance or the candidate/new beam) has expired, the UE could declare (occurrence of) the fourth event (i.e., the Event-4), and initiate/trigger the corresponding beam reporting.

For (c), the corresponding MAC entity may be for each serving cell configured for UE-initiated (UEI)/event-driven reporting according to those specified herein in the present disclosure. Table 10 shows the initiation or triggering the UEI/event-driven reporting.

TABLE 10
The initiation or triggering the UEI-event-driven reporting.

| 1> | to initiate or trigger a UEI/event-driven reporting based on or according to detection or declaration | |
|---|---|---|
| | of the fourth event (or the Event-4): | |
| | 2> | if an indication for an instance for the fourth event or Event-4 as specified/defined herein in the |
| | | present disclosure has been received from lower layers, and/or |
| | 2> | if an indication for a candidate/new beam determined/identified for the instance for the fourth |
| | | event or Event-4 has been received from lower layers: |

| | |
|---|---|
| 3> | start or restart the fourthEventInstanceDetectionTimer (higher layer configured for the |
| | fourth event - when applicable) |

| | |
|---|---|
| 2> | if an indication for another instance for the fourth event or Event-4 as specified/defined herein |
| | in the present disclosure has been received from lower layers, and/or |
| 2> | if an indication for the (same) candidate/new beam determined/identified for another instance |
| | for the fourth event or Event-4 has been received from lower layers: |

| | |
|---|---|
| 3> | increment fourthEvent_COUNTER (higher layer configured for the fourth event - when |
| | applicable) by 1; |
| 3> | if fourthEvent_COUNTER >= fourthEventInstanceMaxCount or N_max (configured for the |
| | fourth event - when applicable), wherein the fourthEventInstanceMaxCount or N_max is |
| | higher layer configured for the fourth event - when applicable: |

| | |
|---|---|
| 4> | trigger a UEI (beam) reporting corresponding/specific to the fourth event - when |
| | applicable - for this serving cell. |

| | |
|---|---|
| 2> | if the fourthEventInstanceDetectionTimer (for the fourth event - when applicable) expires; |
| | and/or |
| 2> | if the fourthEventInstanceDetectionTimer (for the fourth event - when applicable), |
| | fourthEvent_COUNTER (for the fourth event - when applicable), or any of the reference |
| | signals used for UEI reporting - e.g., including that/those specific to/for the current serving |
| | beam(s) and/or the candidate beam(s) as specified or defined herein in the present disclosure |
| | specific to/for the fourth event - is reconfigured by upper layers associated with this serving |
| | cell; and/or |
| 2> | if the reference signal(s) associated with this serving cell used for |
| | detection/declaration/indication for the fourth event as specified/defined herein in the present |
| | disclosure is changed and/or reconfigured by upper layers associated with this serving cell; |
| | and/or |
| 2> | if the UE has received or detected or determined or identified a network's response to the UE- |
| | initiated/event-driven beam reporting corresponding/specific to the fourth event - when |
| | applicable - for this serving cell: |

| | |
|---|---|
| 3> | set fourthEvent_COUNTER (for the fourth event - when applicable) to 0; and/or |
| 3> | stop fourthEventInstanceDetectionTimer (for the fourth event - when applicable); and/or |
| 3> | stop the ueiReportingTimer, if configured; and/or |
| 3> | consider the UE-initiated (UEI) reporting procedure triggered or initiated with respect to the |
| | fourth event successfully completed, and/or cancel all the UEI report(s) triggered or initiated |
| | with respect to at least the fourth event for this serving cell. |

The value(s) of the N_min N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Furthermore, the network's response to the UE-initiated/event-driven reporting corresponding/specific to the fourth event (or the Event-4) could be in form of or could comprise one or more of the following components as shown in following examples.

In one example, a PDCCH reception in a search space set provided by beamReportingEventFourSearchSpaceId for which the UE could detect a DCI format with CRC scrambled by C-RNTI or MCS-C-RNTI.

In another example, a PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure).

In yet another example, a PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value.

In yet another example, a one-bit indicator set to “1” (or “0”) or an ACK provided/indicated in a DCI format (e.g., DCI format 0_0, 0_1, 0_2, 0_3, 1_0, 1_1, 1_2, 1_3, and/or etc.).

In yet another example, TCI state(s) update/indication via a MAC CE activation/deactivation command or a DCI (e.g., DCI format 1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s).

In yet another example, TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s).

In yet another example, TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s).

In yet another example, a non-zero CSI request field (and therefore, a corresponding trigger state) in a DCI (e.g., of a DCI format 0_1 or 02).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “on.”

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “off” or without the higher layer parameter repetition (or equivalently, the higher layer parameter repetition is not present or is absent).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info.

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent).

Furthermore, the network's response to the UE-initiated/event-driven reporting corresponding/specific to the fourth event (or the Event-4) and/or the medium/container such as RRC signaling(s), MAC CE command(s) and/or DCI format(s) used to carry/convey the network's response to the UE-initiated/event-driven reporting corresponding/specific to the fourth event (or the Event-4) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When an/the event-driven or event-triggered (beam) reporting for L1/L2 triggered mobility (LTM) is configured or enabled (e.g., when the UE is provided a higher layer RRC signaling/parameter LTM-Config/LTM-CSI-ResourceConfig/LTM-CSI-ReportConfig and/or “event-driven reporting” in LTM-Config/LTM-CSI-ResourceConfig/LTM-CSI-ReportConfig set to “enabled”), the fourth event or the Event-4 as disclosed in the present disclosure could be denoted by or referred to as a fourth LTM event or a LTM Event-4. For the fourth LTM event or the LTM Event-4, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more current serving beams and/or one or more measurement RSs for one or more candidate/new beams, a UE could detect or declare or identify or determine an instance for a fifth event (denoted by Event-5) according to or based on one or more of and/or a combination of one or more of following examples.

In one example, (an instance for the first event, i.e., Event-1): when the UE has identified or determined that radio link or beam quality(s)—including at least L1-RSRP(s)—of the one or more measurement RSs for the one or more current serving beams is below or less than or equal to a threshold-A, wherein the threshold-A value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

In another example, (an instance for the second event, i.e., Event-2): when the UE has identified or determined that radio link or beam quality(s)—including at least L1-RSRP(s)—of the one or more measurement RSs for the one or more candidate/new beams is below or less than or equal to a threshold-B, wherein the threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

In yet another example, (an instance for the third event, i.e., Event-3): when the UE has identified or determined that the radio link or beam quality(s)—including at least L1-RSRP(s)—of the one or more measurement RSs for the one or more current serving beams is below or less than or equal to a threshold-A, and the radio link or beam quality(s)—including at least L1-RSRP(s)—of the one or more measurement RSs for the one or more candidate/new beams is beyond or greater than or equal to a threshold-B, wherein the threshold-A and/or threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

In yet another example, (an instance for the fourth event, i.e., Event-4): when the UE has identified or determined that the radio link or beam quality(s)—including at least L1-RSRP(s)—of the one or more measurement RSs for the one or more (or at least one) candidate/new beams is beyond or greater than the radio link or beam quality(s)—including at least L1-RSRP(s)—of the one or more measurement RSs for the one or more current serving beams by a threshold-C, wherein the threshold-C value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

The UE could send to the network a capability signaling to indicate whether or not they are capable of supporting detecting or declaring an instance of the fifth event (i.e., Event-5), and/or which (combination(s)) of an instance for the first event (Event-1), an instance for the second event (Event-2), an instance for the third event (Event-3) and/or an instance for the fourth event (Event-4) they are capable of supporting as an instance for the fifth event (Event-5); for instance, the capability or capability signaling could comprise one or more of the following components as an instance for the fifth event (i.e., the Event-5):
Component-1: {an instance for the first event};
Component-2: {an instance for the second event};
Component-3: {an instance for the third event};
Component-4: {an instance for the fourth event};
Component-5: {instances for the first, second, third and fourth events};
Component-6: {instances for the first, second and third events};
Component-7: {instances for the first, second and fourth events};
Component-8: {instances for the first, third and fourth events};
Component-9: {instances for the first and second events};
Component-10: {instances for the first and third events};
Component-11: {instances for the first and fourth events};
Component-12: {instances for the second, third and fourth events};
Component-13: {instances for the second and third events};
Component-14: {instances for the second and fourth events}; and/or
Component-15: {instances for the third and fourth events}.

Accordingly, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling as defined/specified herein in the present disclosure, which (combination(s)) of an instance for the first event (Event-1), an instance for the second event (Event-2), an instance for the third event (Event-3) and/or an instance for the fourth event (Event-4) could be considered, used or applied as an instance for the fifth event (Event-5), and/or which one or more of the Component-1-Component-15 as defined herein could be considered, used or applied as an instance for the fifth event (Event-5).

In one example, an instance for the fifth event (Event-5) may not comprise any component(s) related/corresponding to an instance for the fourth event (Event-4), and/or an instance for the fifth event (Event-5) does not comprise, include or contain an instance for the fourth event (Event-4), and/or detection, determination or identification of the fifth event (Event-5) may not be according to or based on any component(s) related/corresponding to an instance for the fourth event (Event-4). In this case, (a) when Event-5 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventFiveConfig (e.g., set to “enabled”) and/or a higher layer parameter eventType set to “Event-5,” and/or (b) when the UE has determined or identified or detected that within a time window/period/gap/offset, a number of instances of the fifth event (denoted by N_5) according to or following those specified/defined herein in the present disclosure is greater than or equal to a minimum value/number denoted by N_min, and/or (c) when the UE has determined or identified or detected an instance of the fifth event according to or following those specified/defined herein in the present disclosure, the UE could increase a number of count in a counter (e.g., specific to the Event-5) by 1 and/or when the number of counts (denoted by N_5) in the counter reaches to a maximum number of counts denoted by N_max before a timer (e.g., specific to the Event-5) has expired, the UE could declare (occurrence of) the fifth event (i.e., the Event-5), and initiate/trigger the corresponding beam reporting.

For (c), the corresponding MAC entity may be for each serving cell configured for UE-initiated (UEI)/event-driven reporting according to those specified herein in the present disclosure. Table 11 shows the initiation or triggering a UEI/event-driven reporting.

TABLE 11
The initiation or triggering a UEI/event-driven reporting

| 1> | to initiate or trigger a UEI/event-driven reporting based on or according to detection or declaration | |
|---|---|---|
| | of the fifth event (or the Event-5): | |
| | 2> | if an indication for an instance for the fifth event or Event-5 as specified/defined herein in the |
| | | present disclosure has been received from lower layers: |

| | |
|---|---|
| 3> | start or restart the fifthEventInstanceDetectionTimer (higher layer configured for the fifth |
| | event - when applicable) |
| 3> | increment fifthEvent_COUNTER (higher layer configured for the fifth event - when |
| | applicable) by 1; |
| 3> | if fifthEvent_COUNTER >= fifthEventInstanceMaxCount or N_max (configured for the |
| | fifth event - when applicable), wherein the fifthEventInstanceMaxCount or N_max is |
| | higher layer configured for the fifth event - when applicable: |

| | |
|---|---|
| 4> | trigger a UEI (beam) reporting corresponding/specific to the fifth event - when |
| | applicable - for this serving cell. |

| | |
|---|---|
| 2> | if the fifthEventInstanceDetectionTimer (for the fifth event - when applicable) expires; and/or |
| 2> | if the fifthEventInstanceDetectionTimer (for the fifth event - when applicable), |
| | fifthEvent_COUNTER (for the fifth event - when applicable), or any of the reference signals |
| | used for UEI reporting - e.g., including that/those specific to/for the current serving beam(s) |
| | and/or the candidate beam(s) as specified or defined herein in the present disclosure specific |
| | to/for the fifth event - is reconfigured by upper layers associated with this serving cell; and/or |
| 2> | if the reference signal(s) associated with this serving cell used for |
| | detection/declaration/indication for the fifth event as specified/defined herein in the present |
| | disclosure is changed and/or reconfigured by upper layers associated with this serving cell; |
| | and/or |
| 2> | if the UE has received or detected or determined or identified a network's response to the UE- |
| | initiated/event-driven beam reporting corresponding/specific to the fifth event - when |
| | applicable - for this serving cell: |

| | |
|---|---|
| 3> | set fifthEvent_COUNTER (for the fifth event - when applicable) to 0; and/or |
| 3> | stop fifthEventInstanceDetectionTimer (for the fifth event - when applicable); and/or |
| 3> | stop the ueiReportingTimer, if configured; and/or |
| 3> | consider the UE-initiated (UEI) reporting procedure triggered or initiated with respect to |
| | the fifth event successfully completed, and/or cancel all the UEI report(s) triggered or |
| | initiated with respect to at least the fifth event for this serving cell. |

The value(s) of the N_min N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

In another example, an instance for the fifth event (Event-5) could comprise component(s) related/corresponding to an instance for the fourth event (Event-4), and/or an instance for the fifth event (Event-5) could comprise, include or contain an instance for the fourth event (Event-4), and/or detection, determination or identification of the fifth event (Event-5) could be according to or based on component(s) related/corresponding to at least an instance for the fourth event (Event-4). In this case, (a) when Event-5 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventFiveConfig (e.g., set to “enabled”) and/or a higher layer parameter eventType set to “Event-5,” and/or (b) when the UE has determined or identified or detected that within a time window/period/gap/offset, a number of instances of the fifth event (denoted by N_5) according to or following those specified/defined herein in the present disclosure that have at least one same candidate/new beam determined/identified during the measurement instance(s)/occasion(s) is greater than or equal to a minimum value/number denoted by N_min and/or (c) when the UE has determined or identified or detected an instance of the fifth event (i.e., an Event-5 instance) according to or following those specified/defined herein in the present disclosure and a candidate/new beam, the UE could increase a number of count in a counter (e.g., specific to the Event-5 or the Event-5 instance or the candidate/new beam) by 1 and/or when the number of counts (denoted by N_5) in the counter reaches to a maximum number of counts denoted by N_max before a timer (e.g., specific to the Event-5 or the Event-5 instance or the candidate/new beam) has expired, the UE could declare (occurrence of) the fifth event (i.e., the Event-5), and initiate/trigger the corresponding beam reporting.

For (c), the corresponding MAC entity may be for each serving cell configured for UE-initiated (UEI)/event-driven reporting according to those specified herein in the present disclosure. Table 12 show the initiation or triggering a UEI/event-drive reporting.

TABLE 12
The initiation or triggering a UEI/event-drive reporting

| 1> | to initiate or trigger a UEI/event-driven reporting based on or according to detection or declaration | |
|---|---|---|
| | of the fifth event (or the Event-5): | |
| | 2> | if an indication for an instance for the fifth event or Event-5 as specified/defined herein in the |
| | | present disclosure has been received from lower layers, and/or |
| | 2> | if an indication for a candidate/new beam determined/identified for the instance for the fifth |
| | | event or Event-5 has been received from lower layers: |

| | |
|---|---|
| 3> | start or restart the fifthEventInstanceDetectionTimer (higher layer configured for the fifth |
| | event - when applicable) |

| | |
|---|---|
| 2> | if an indication for another instance for the fifth event or Event-5 as specified/defined herein |
| | in the present disclosure has been received from lower layers, and/or |
| 2> | if an indication for the (same) candidate/new beam determined/identified for the another |
| | instance for the fifth event or Event-5 has been received from lower layers: |

| | |
|---|---|
| 3> | increment fifthEvent_COUNTER (higher layer configured for the fifth event - when |
| | applicable) by 1; |
| 3> | if fifthEvent_COUNTER >= fifthEventInstanceMaxCount or N_max (configured for the |
| | fifth event - when applicable), wherein the fifthEventInstanceMaxCount or N_max is |
| | higher layer configured for the fifth event - when applicable: |

| | |
|---|---|
| 4> | trigger a UEI (beam) reporting corresponding/specific to the fifth event - when |
| | applicable - for this serving cell. |

| | |
|---|---|
| 2> | if the fifthEventInstanceDetectionTimer (for the fifth event - when applicable) expires; and/or |
| 2> | if the fifthEventInstanceDetectionTimer (for the fifth event - when applicable), |
| | fifthEvent_COUNTER (for the fifth event - when applicable), or any of the reference signals |
| | used for UEI reporting - e.g., including that/those specific to/for the current serving beam(s) |
| | and/or the candidate beam(s) as specified or defined herein in the present disclosure specific |
| | to/for the fifth event - is reconfigured by upper layers associated with this serving cell; and/or |
| 2> | if the reference signal(s) associated with this serving cell used for |
| | detection/declaration/indication for the fifth event as specified/defined herein in the present |
| | disclosure is changed and/or reconfigured by upper layers associated with this serving cell; |
| | and/or |
| 2> | if the UE has received or detected or determined or identified a network's response to the UE- |
| | initiated/event-driven beam reporting corresponding/specific to the fifth event - when |
| | applicable - for this serving cell: |

| | |
|---|---|
| 3> | set fifthEvent_COUNTER (for the fifth event - when applicable) to 0; and/or |
| 3> | stop fifthEventInstanceDetectionTimer (for the fifth event - when applicable); and/or |
| 3> | stop the ueiReportingTimer, if configured; and/or |

| | |
|---|---|
| 3> | consider the UE-initiated (UEI) reporting procedure triggered or initiated with respect to the fifth |

event successfully completed, and/or cancel all the UEI report(s) triggered or initiated with respect to at
least the fifth event for this serving cell.

The value(s) of the N_min N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

Furthermore, the network's response to the UE-initiated/event-driven reporting corresponding/specific to the fifth event (or the Event-5) could be in form of or could comprise one or more of the following components as shown in following examples.

In one example, a PDCCH reception in a search space set provided by beamReportingEventFiveSearchSpaceId for which the UE could detect a DCI format with CRC scrambled by C-RNTI or MCS-C-RNTI.

In another example, a PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure).

In yet another example, a PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value.

In yet another example, a one-bit indicator set to “1” (or “0”) or an ACK provided/indicated in a DCI format (e.g., DCI format 0_0, 0_1, 0_2, 0_3, 1_0, 1_1, 1_2, 1_3, and/or etc.).

In yet another example, TCI state(s) update/indication via a MAC CE activation/deactivation command or a DCI (e.g., DCI format 1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s).

In yet another example, TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s).

In yet another example, TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s).

In yet another example, a non-zero CSI request field (and therefore, a corresponding trigger state) in a DCI (e.g., of a DCI format 0_1 or 02).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “on.”

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to “off” or without the higher layer parameter repetition (or equivalently, the higher layer parameter repetition is not present or is absent).

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info.

In yet another example, CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent)

Furthermore, the network's response to the UE-initiated/event-driven reporting corresponding/specific to the fifth event (or the Event-5) and/or the medium/container such as RRC signaling(s), MAC CE command(s) and/or DCI format(s) used to carry/convey the network's response to the UE-initiated/event-driven reporting corresponding/specific to the fifth event (or the Event-5) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When an/the event-driven or event-triggered (beam) reporting for L1/L2 triggered mobility (LTM) is configured or enabled (e.g., when the UE is provided a higher layer RRC signaling/parameter LTM-Config/LTM-CSI-ResourceConfig/LTM-CSI-ReportConfig and/or “vent-driven reporting” in LTM-Config/LTM-CSI-ResourceConfig/LTM-CSI-ReportConfig set to “enabled”), the fifth event or the Event-5 as disclosed in the present disclosure could be denoted by or referred to as a fifth LTM event or a LTM Event-5.

For the fifth LTM event or the LTM Event-5, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

In the present disclosure, a UE could indicate or send or transmit to the network a capability signaling indicating whether or not the UE can support one or more of the events as specified herein in the present disclosure. For instance, the corresponding capability or capability signaling could comprise one or more of the following components—i.e., if the corresponding capability or capability signaling comprises {Event-1, Event-4}, the UE could indicate or send or transmit to the network that they could support or could be capable of supporting the Event-1 and Event-4 in the present disclosure:
{Event-1};
{Event-2};
{Event-3};
{Event-4};
{Event-5};
{Event-1, Event-2};
{Event-1, Event-3};
{Event-1, Event-4};
{Event-1, Event-5};
{Event-2, Event-3};
{Event-2, Event-4};
{Event-2, Event-5};
{Event-3, Event-4};
{Event-3, Event-5};
{Event-4, Event-5};
{Event-1, Event-2, Event-3};
{Event-1, Event-2, Event-4};
{Event-1, Event-2, Event-5};
{Event-1, Event-3, Event-4};
{Event-1, Event-3, Event-5};
{Event-1, Event-4, Event-5};
{Event-2, Event-3, Event-4};
{Event-2, Event-3, Event-5};
{Event-2, Event-4, Event-5};
{Event-3, Event-4, Event-5};
{Event-1, Event-2, Event-3, Event-4};
{Event-1, Event-2, Event-3, Event-5};
{Event-1, Event-3, Event-4, Event-5};
{Event-2, Event-3, Event-4, Event-5}; and/or
{Event-1, Event-2, Event-3, Event-4, Event-5}.

Furthermore, all UEs that could or would support the UE-initiated or event-driven reporting may support or indicate their support of one or more of the events—such as Event-4; i.e., the one or more of the events—such as Event-4 in the present disclosure—could be specified or regarded or considered as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as disclosed in the present disclosure, that one or more (e.g., only one or more than one) of the events (e.g., Event-1 and/or Event-4) can be enabled. For instance, a higher layer parameter eventType could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting, and/or in the higher layer parameter(s) LTM-Config, LTM-CSI-ResourceConfig, LTM-CSI-ReportConfig and/or etc. that provides or configures information or settings for the L1/L2 triggered mobility (LTM) operation(s). For example, when the eventType is set to “Event-1” or “one” or “1” or “first” or “enabled” (or “disabled”) or 1 (or 0), the Event-1 as disclosed in the present disclosure is enabled; and when the eventType is set to “Event-4” or “four” or “4” or “fourth” or “two” or “2” or “second” or “disabled” (or “enabled”) or 0 (or 1), the Event-4 as disclosed in the present disclosure is enabled. For another example, when the eventType is set to “Event-1 and Event-4” or “one and four” or “1 and 4” or “first and fourth” or “enabled” (or “disabled”) or 1 (or 0) or “00” (or “01” or “10” or “11”), both the Event-1 and Event-4 as specified/defined herein in the present disclosure are enabled. In the present disclosure, discussions, descriptions, specifications and etc. for when one/an event (e.g., Event-1 or Event-4) is enabled (e.g., detection, declaration, triggering and etc. of the event) can be equally applied or extended to when more than one events (e.g., both Event-1 and Event-4) are enabled (e.g., detection, declaration, triggering and etc. of the more than one events).

For a first event, wherein the radio link or beam quality(s) of one or more current serving beams is below or less than or equal to a threshold-A (an instance for the first event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described in the present disclosure for the current serving beam(s). In this case, a/the UEI report, e.g., for the first event, could comprise one or more of the following components for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure as shown in following examples.

In one example, Component-1a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.

In another example, Component-1b: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.

In yet another example, Component-1c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1a for the one or more first current serving beams; differential RSRP/SINR reporting could be applied to Component-1c according to those specified herein in the present disclosure.

In yet another example, Component-1d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1b for the one or more second current serving beams; differential RSRP/SINR reporting could be applied to Component-1d according to those specified herein in the present disclosure.

In yet another example, Component-1e: indicator(s) or bitmap(s) indicating the one or more first current serving beams—e.g., out of all the current serving beams.

In yet another example, Component-1f: indicator(s) or bitmap(s) indicating the one or more second current serving beams—e.g., out of all the current serving beams or out of all the first current serving beam(s).

In yet another example, Component-1g: a number of the one or more first current serving beams in the UEI report(s).

In yet another example, Component-1h: a number of the one or more second current serving beams in the UEI report(s).

In yet another example, Component-1i: indicator(s) indicating occurrence of the first event and/or an event index/ID associated/specific/corresponding to the first event.

In yet another example, Component-1j: difference(s) between the beam metric(s) such as L1-RSRP(s)/L1-SINR(s) for the one or more first current serving beams and the threshold-A; For instance, if a (differential) L1-RSRP/L1-SINR value computed with respect to or regarding or for a first current serving beam is x dBm, and the threshold-A is y dBm, a difference delta_diff_A=|x−y| dBm could be reported in the UEI report as a report content/quantity, and a corresponding one-bit sign indicator indicating either positive or negative of the difference could also be reported in the same UEI report. Or the difference delta_diff_A=(x−y) and/or (y−x) dBm could be reported in the UEI report as a report content/quantity. Optionally, the value of delta_diff_A could be quantized to a u-bit value with a v dB step size with respect to the threshold-A.

In yet another example, Component-1k: difference(s) between the beam metric(s) such as L1-RSRP(s)/L1-SINR(s) for the one or more second current serving beams and the threshold-A; For instance, if a (differential) L1-RSRP/L1-SINR value computed with respect to or regarding or for a second current serving beam is x′ dBm, and the threshold-A is y dBm, a difference delta_diff_A′=|x′−y| dBm could be reported in the UEI report as a report content/quantity, and a corresponding one-bit sign indicator indicating either positive or negative of the difference could also be reported in the same UEI report. Or the difference delta_diff_A′=(x′−y) and/or (y−x′) dBm could be reported in the UEI report as a report content/quantity.

In yet another example, Component-1l: indicator(s) indicating presence or absent of Component-1a in the UEI report(s); e.g., the indicator(s) could be a one-bit indicator with “1” (or “0”) indicating presence and “0” (or “1”) indicating absence of Component-1a in the UEI report(s). Optionally, the value of delta_diff_A′ could be quantized to a u-bit value with a v dB step size with respect to the threshold-A.

In yet another example, Component-1m: indicator(s) indicating presence or absent of Component-1b in the UEI report(s); e.g., the indicator(s) could be a one-bit indicator with “1” (or “0”) indicating presence and “0” (or “1”) indicating absence of Component-1b in the UEI report(s).

In yet another example, Component-1n: indicator(s) indicating presence or absent of Component-1c in the UEI report(s); e.g., the indicator(s) could be a one-bit indicator with “1” (or “0”) indicating presence and “0” (or “1”) indicating absence of Component-1c in the UEI report(s).

In yet another example, Component-1o: indicator(s) indicating presence or absent of Component-1d in the UEI report(s); e.g., the indicator(s) could be a one-bit indicator with “1” (or “0”) indicating presence and “0” (or “1”) indicating absence of Component-1d in the UEI report(s).

In yet another example, Component-1p: indicator(s) indicating presence or absence of Component-1j in the UEI report(s); e.g., the indicator(s) could be a one-bit indicator with “1” (or “0”) indicating presence and “0” (or “1”) indicating absence of Component-1j in the UEI report(s).

In yet another example, Component-1q: indicator(s) indicating presence or absence of Component-1k in the UEI report(s); e.g., the indicator(s) could be a one-bit indicator with “1” (or “0”) indicating presence and “0” (or “1”) indicating absence of Component-1k in the UEI report(s). The value(s) of threshold-A, threshold-A′, Ns, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Ns>1. In another example, Ns≥1.

For a second event, wherein the radio link or beam quality(s) of one or more candidate beams is beyond or greater than or equal to a threshold-B (an instance for the second event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described in the present disclosure for the candidate beam(s)—in the present disclosure, a candidate beam is equivalent to a candidate new beam or a new beam. In this case, a/the UEI report, e.g., for the second event, could comprise one or more of the following components for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure as shown in following examples.

In one example, Component-2a: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.

In another example, Component-2b: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.

In yet another example, Component-2c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2a for the one or more first candidate beams; differential RSRP/SINR reporting could be applied to Component-2c according to those specified herein in the present disclosure.

In yet another example, Component-2d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2b for the one or more second candidate beams; differential RSRP/SINR reporting could be applied to Component-2d according to those specified herein in the present disclosure.

In yet another example, Component-2e: indicator(s) or bitmap(s) indicating the one or more first candidate beams—e.g., out of all the candidate beams.

In yet another example, Component-2f: indicator(s) or bitmap(s) indicating the one or more second candidate beams—e.g., out of all the candidate beams or out of all the first candidate beam(s).

In yet another example, Component-2g: a number of the one or more first candidate beams in the UEI report(s).

In yet another example, Component-2h: a number of the one or more second candidate beams in the UEI report(s).

In yet another example, Component-2i: indicator(s) indicating occurrence of the second event and/or an event index/ID associated/specific/corresponding to the second event.

In yet another example, Component-2j: difference(s) between the beam metric(s) such as L1-RSRP(s)/L1-SINR(s) for the one or more first candidate beams and the threshold-B; For instance, if a (differential) L1-RSRP/L1-SINR value computed with respect to or regarding or for a first candidate beam is x dBm, and the threshold-B is y dBm, a difference delta_diff_B=|x−y| dBm could be reported in the UEI report as a report content/quantity, and a corresponding one-bit sign indicator indicating either positive or negative of the difference could also be reported in the same UEI report. Or the difference delta_diff_B=(x−y) and/or (y−x) dBm could be reported in the UEI report as a report content/quantity. Optionally, the value of delta_diff_B could be quantized to a u-bit value with a v dB step size with respect to the threshold-B.

In yet another example, Component-2k: difference(s) between the beam metric(s) such as L1-RSRP(s)/L1-SINR(s) for the one or more second candidate beams and the threshold-B; For instance, if a (differential) L1-RSRP/L1-SINR value computed with respect to or regarding or for a second candidate beam is x′ dBm, and the threshold-B is y dBm, a difference delta_diff_B′=|x′−y| dBm could be reported in the UEI report as a report content/quantity, and a corresponding one-bit sign indicator indicating either positive or negative of the difference could also be reported in the same UEI report. Or the difference delta_diff_B′=(x′−y) and/or (y−x′) dBm could be reported in the UEI report as a report content/quantity. Optionally, the value of delta_diff_B′ could be quantized to a u-bit value with a v dB step size with respect to the threshold-B.

In yet another example, Component-2l: indicator(s) indicating presence or absent of Component-2a in the UEI report(s); e.g., the indicator(s) could be a one-bit indicator with “1” (or “0”) indicating presence and “0” (or “1”) indicating absence of Component-2a in the UEI report(s).

In yet another example, Component-2m: indicator(s) indicating presence or absent of Component-2b in the UEI report(s); e.g., the indicator(s) could be a one-bit indicator with “1” (or “0”) indicating presence and “0” (or “1”) indicating absence of Component-2b in the UEI report(s).

In yet another example, Component-2n: indicator(s) indicating presence or absent of Component-2c in the UEI report(s); e.g., the indicator(s) could be a one-bit indicator with “1” (or “0”) indicating presence and “0” (or “1”) indicating absence of Component-2c in the UEI report(s).

In yet another example, Component-2o: indicator(s) indicating presence or absent of Component-2d in the UEI report(s); e.g., the indicator(s) could be a one-bit indicator with “1” (or “0”) indicating presence and “0” (or “1”) indicating absence of Component-2d in the UEI report(s).

In yet another example, Component-2p: indicator(s) indicating presence or absence of Component-2j in the UEI report(s); e.g., the indicator(s) could be a one-bit indicator with “1” (or “0”) indicating presence and “0” (or “1”) indicating absence of Component-2j in the UEI report(s).

In yet another example, Component-2q: indicator(s) indicating presence or absence of Component-2k in the UEI report(s); e.g., the indicator(s) could be a one-bit indicator with “1” (or “0”) indicating presence and “0” (or “1”) indicating absence of Component-2k in the UEI report(s). The value(s) of threshold-B, threshold-B′, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1. In another example, Nc≥1.

For a third event, wherein the radio link or beam quality(s) of one or more current serving beams is below or less than or equal to a threshold-A (an instance for the third event), and the radio link or beam quality(s) of one or more candidate beams is beyond or greater than or equal to a threshold-B, a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described in the present disclosure for the current serving beam(s), and/or report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described in the present disclosure for the candidate beam(s).

In this case, a/the UEI report, e.g., for the third event, could comprise one or more of the Component-1a to Component-1q as specified/defined herein in the present disclosure for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure, and one or more of the Component-2a to Component-2q for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure, and/or Component-3: indicator(s) indicating occurrence of the third event and/or an event index/ID associated/specific/corresponding to the third event.

For a fourth event, wherein the radio link or beam quality(s) of one or more (or at least one) candidate beams is beyond or greater than the radio link or beam quality(s) of one or more current serving beams by a threshold-C (an instance for the fourth event), a/the UEI report could comprise report content(s)/quantity(s) including resource indicator(s) such as SSBRI(s)/CRI(s) and/or beam metric(s) such as L1-RSRP(s)/L1-SINR(s) for the current serving beam(s), and/or report content(s)/quantity(s) including resource indicator(s) such as SSBRI(s)/CRI(s) and/or beam metric(s) such as L1-RSRP(s)/L1-SINR(s) for the candidate beam(s), and/or information related to presence or absence of one or more of the report contents/quantities as described in the present disclosure for the current serving beam(s), and/or information related to presence or absence of one or more of the report contents/quantities as described in the present disclosure for the candidate beam(s), and/or quality metric(s) such as first difference(s) between the beam metric(s) such as L1-RSRP(s)/L1-SINR(s) for the current serving beam(s) and the beam metric(s) such as L1-RSRP(s)/L1-SINR(s) for the candidate beam(s), second difference(s) between the first difference(s) and the threshold-C.

In this case, a/the UEI report, e.g., for the fourth event, could comprise one or more of the following components for one or more first current serving beams, wherein the one or more first current serving beams could comprise one or more (e.g., Ns) second current serving beams with their associated/corresponding radio link/beam quality(s) greater than or equal to or beyond a threshold-C′ or with their associated/corresponding radio link/beam quality(s) corresponding to the highest (or lowest) Ns radio link/beam quality(s) among the one or more first current serving beams as defined/specified herein in the present disclosure, and/or for one or more first candidate beams, wherein the one or more first candidate beams could comprise one or more (e.g., Nc) second candidate beams with their associated/corresponding radio link/beam quality(s) greater than or equal to or beyond a threshold-C″ or with their associated/corresponding radio link/beam quality(s) corresponding to the highest (or lowest) Nc radio link/beam quality(s) among the one or more first candidate beams as defined/specified herein in the present disclosure; in this case, as disclosed in the present disclosure, the radio link or beam quality(s) of the first candidate beam(s) is beyond or greater than the radio link or beam quality(s) of the first current serving beam(s) by the threshold-C as shown in following examples.

In one example, Component-4a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.

In another example, Component-4b: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.

In yet another example, Component-4c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4a for the one or more first current serving beams; differential RSRP/SINR reporting could be applied to Component-4c according to those specified herein in the present disclosure.

In yet another example, Component-4d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4b for the one or more first candidate beams; differential RSRP/SINR reporting could be applied to Component-4c according to those specified herein in the present disclosure.

In yet another example, Component-4e: first difference(s) between the beam metric(s) such as L1-RSRP(s)/L1-SINR(s) for the one or more first current serving beams and the beam metric(s) such as L1-RSRP(s)/L1-SINR(s) for the one or more first candidate beams; For instance, if a (differential) L1-RSRP/L1-SINR value computed with respect to or regarding or for a first current serving beam is x1 dBm, and a (differential) L1-RSRP/L1-SINR value computed with respect to or regarding or for a first candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.

In yet another example, Component-4f: second difference(s) between the first difference(s) in Component-4e and the threshold-C; For instance, for a first difference delta_diff_C (or |delta_diff_C|) specified/defined or obtained in Component-4e and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this example.

In yet another example, Component-4g: indicator(s) or bitmap(s) indicating the one or more first current serving beams—e.g., out of all the current serving beams.

In yet another example, Component-4h: indicator(s) or bitmap(s) indicating the one or more first candidate beams—e.g., out of all the candidate beams.

In yet another example, Component-4i: a number of the one or more first current serving beams in the UEI report(s).

In yet another example, Component-4j: a number of the one or more first candidate beams in the UEI report(s).

In yet another example, Component-4k: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.

In yet another example, Component-4l: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.

In yet another example, Component-4m: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4k for the one or more second current serving beams; differential RSRP/SINR reporting could be applied to Component-4m according to those specified herein in the present disclosure.

In yet another example, Component-4n: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4l for the one or more second candidate beams; differential RSRP/SINR reporting could be applied to Component-4n according to those specified herein in the present disclosure.

In yet another example, Component-4o: first difference(s) between the beam metric(s) such as L1-RSRP(s)/L1-SINR(s) for the one or more second current serving beams and the beam metric(s) such as L1-RSRP(s)/L1-SINR(s) for the one or more second candidate beams; For instance, if a (differential) L1-RSRP/L1-SINR value computed with respect to or regarding or for a second current serving beam is x1 dBm, and a (differential) L1-RSRP/L1-SINR value computed with respect to or regarding or for a second candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.

In yet another example, Component-4p: second difference(s) between the first difference(s) in Component-4o and the threshold-C; For instance, for a first difference delta_diff_C (or |delta_diff_C) specified/defined or obtained in Component-4o and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this example.

In yet another example, Component-4q: indicator(s) or bitmap(s) indicating the one or more second current serving beams—e.g., out of all the current serving beams or out of all the first current serving beam(s).

In yet another example, Component-4r: indicator(s) or bitmap(s) indicating the one or more second candidate beams—e.g., out of all the candidate beams or out of all the first candidate beam(s).

In yet another example, Component-4s: a number of the one or more second current serving beams in the UEI report(s).

In yet another example, Component-4t: a number of the one or more second candidate beams in the UEI report(s).

In yet another example, Component-4u: indicator(s) indicating occurrence of the fourth event and/or an event index/ID associated/specific/corresponding to the fourth event.

In yet another example, Component-5a: indicator(s) indicating presence or absent of Component-4a in the UEI report(s); e.g., the indicator(s) could be a one-bit indicator with “1” (or “0”) indicating presence and “0” (or “1”) indicating absence of Component-4a in the UEI report(s).

In yet another example, Component-5b: indicator(s) indicating presence or absent of Component-4b in the UEI report(s); e.g., the indicator(s) could be a one-bit indicator with “1” (or “0”) indicating presence and “0” (or “1”) indicating absence of Component-4b in the UEI report(s).

In yet another example, Component-5c: indicator(s) indicating presence or absent of Component-4c in the UEI report(s); e.g., the indicator(s) could be a one-bit indicator with “1” (or “0”) indicating presence and “0” (or “1”) indicating absence of Component-4c in the UEI report(s).

In yet another example, Component-5d: indicator(s) indicating presence or absent of Component-4d in the UEI report(s); e.g., the indicator(s) could be a one-bit indicator with “1” (or “0”) indicating presence and “0” (or “1”) indicating absence of Component-4d in the UEI report(s).

In yet another example, Component-5e: indicator(s) indicating presence or absence of Component-4e in the UEI report(s); e.g., the indicator(s) could be a one-bit indicator with “1” (or “0”) indicating presence and “0” (or “1”) indicating absence of Component-4e in the UEI report(s).

In yet another example, Component-5f: indicator(s) indicating presence or absence of Component-4f in the UEI report(s); e.g., the indicator(s) could be a one-bit indicator with “1” (or “0”) indicating presence and “0” (or “1”) indicating absence of Component-4f in the UEI report(s).

In yet another example, Component-5g: indicator(s) indicating presence or absent of Component-4k in the UEI report(s); e.g., the indicator(s) could be a one-bit indicator with “1” (or “0”) indicating presence and “0” (or “1”) indicating absence of Component-4k in the UEI report(s).

In yet another example, Component-5h: indicator(s) indicating presence or absent of Component-41 in the UEI report(s); e.g., the indicator(s) could be a one-bit indicator with “1” (or “0”) indicating presence and “0” (or “1”) indicating absence of Component-4l in the UEI report(s).

In yet another example, Component-5i: indicator(s) indicating presence or absent of Component-4m in the UEI report(s); e.g., the indicator(s) could be a one-bit indicator with “1” (or “0”) indicating presence and “0” (or “1”) indicating absence of Component-4m in the UEI report(s).

In yet another example, Component-5j: indicator(s) indicating presence or absent of Component-4n in the UEI report(s); e.g., the indicator(s) could be a one-bit indicator with “1” (or “0”) indicating presence and “0” (or “1”) indicating absence of Component-4n in the UEI report(s).

In yet another example, Component-5k: indicator(s) indicating presence or absence of Component-4o in the UEI report(s); e.g., the indicator(s) could be a one-bit indicator with “1” (or “0”) indicating presence and “0” (or “1”) indicating absence of Component-4o in the UEI report(s).

In yet another example, Component-5l: indicator(s) indicating presence or absence of Component-4p in the UEI report(s); e.g., the indicator(s) could be a one-bit indicator with “1” (or “0”) indicating presence and “0” (or “1”) indicating absence of Component-4p in the UEI report(s).

The value(s) of threshold-C, threshold-C′, threshold-C″, Ns, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1 and/or Ns>1. In another example, Nc≥1 and/or Ns≥1.

For each (or one or more) of the first, second, third and fourth events, and/or for a UE to declare each (or one or more) of the first, second, third and fourth events, and/or for a UE to formulate, construct, transmit and/or send the UEI report(s) with the report content(s)/quantity(s) corresponding to each (or one or more) of the first, second, third and fourth events according to examples in the present disclosure, and/or for a UE to use/apply each (or one or more) of the first, second, third and fourth events for triggering or initiating the UEI reporting according to examples in the present disclosure, the corresponding MAC entity may be for each serving cell configured for UEI reporting according to those specified herein in the present disclosure. Table 13 shows the initiation or triggering a UEI reporting.

TABLE 13
The initiation or triggering a UEI reporting.

| 1> | to initiate or trigger a UEI reporting based on or according to detection or declaration of one or | |
|---|---|---|
| | each of the first, second, third and fourth events, individually: | |
| | 2> | if an indication for an instance for an event (e.g., the first, second, third or fourth event) has |
| | | been received from lower layers: |

| | |
|---|---|
| 3> | start or restart the firstEventInstanceDetectionTimer, secondEventInstanceDetectionTimer, |
| | thirdEventInstanceDetectionTimer or fourthEventInstanceDetectionTimer (higher layer |
| | configured respectively for the first, second, third or fourth event - when applicable) |
| 3> | increment firstEvent_COUNTER, secondEvent_COUNTER, thirdEvent_COUNTER or |
| | fourthEvent_COUNTER (higher layer configured respectively for the first, second, third or |
| | fourth event - when applicable) by 1; |
| 3> | if firstEvent_COUNTER >= firstEventInstanceMaxCount, secondEvent_COUNTER >= |
| | secondEventInstanceMaxCount, thirdEvent_COUNTER >= thirdEventInstanceMaxCount |
| | or fourthEvent_COUNTER >= fourthEventInstanceMaxCount (respectively for the first, |
| | second, third or fourth event - when applicable), wherein the firstEventInstanceMaxCount, |
| | secondEventInstanceMaxCount, thirdEventInstanceMaxCount or |
| | fourthEventInstanceMaxCount is higher layer configured respectively for the first, second, |
| | third or fourth event - when applicable: |

| | |
|---|---|
| 4> | trigger a UEI (beam) reporting specific to the first, second, third or fourth event - when |
| | applicable - for this serving cell, wherein the report content(s)/quantity(s) in the UEI |
| | report(s) is specific to the first, second, third or fourth event - when applicable - |
| | according to examples in the present disclosure. |

| | |
|---|---|
| 2> | if the firstEventInstanceDetectionTimer, secondEventInstanceDetectionTimer, |
| | thirdEventInstanceDetection Timer or fourthEventInstanceDetectionTimer (respectively for the |
| | first, second, third or fourth event - when applicable) expires; or |
| 2> | if the firstEventInstanceDetectionTimer, secondEventInstanceDetectionTimer, |
| | thirdEventInstanceDetection Timer or fourthEventInstanceDetection Timer (respectively for the |
| | first, second, third or fourth event - when applicable), firstEvent_COUNTER, |
| | secondEvent_COUNTER, thirdEvent_COUNTER or fourthEvent_COUNTER (respectively for |
| | the first, second, third or fourth event - when applicable), or any of the reference signals used |
| | for UEI reporting - e.g., including that/those specific to/for the current serving beam(s) and/or |
| | the candidate beam(s) as specified or defined herein in the present disclosure specific to/for the |
| | first, second, third or fourth event - is reconfigured by upper layers associated with this serving |
| | cell; or |
| 2> | if the reference signal(s) associated with this serving cell used for |
| | detection/declaration/indication for the first, second, third or fourth event as specified/defined |
| | herein in the present disclosure is changed and/or reconfigured by upper layers associated with |
| | this serving cell: |

| | |
|---|---|
| 3> | set firstEvent_COUNTER, secondEvent_COUNTER, thirdEvent_COUNTER or |
| | fourthEvent_COUNTER (respectively for the first, second, third or fourth event - when |
| | applicable) to 0; and/or |
| 3> | stop the ueiReportingTimer, if configured; and/or |
| 3> | consider the UE-initiated (UEI) reporting procedure triggered or initiated with respect to the |
| | first, second, third or fourth event successfully completed, and/or cancel all the UEI |
| | report(s) triggered or initiated with respect to the first, second, third or fourth event for this |
| | serving cell. |

The MAC entity and the corresponding operation(s)/procedure(s) are for triggering or initiating one or more UEI report(s) according to or based on detection or declaration of one of the first, second, third and fourth events according to examples in the present disclosure. To trigger or initiate a UEI reporting based on or according to detection or declaration of more than one or multiple events—e.g., the third and fourth events—jointly or simultaneously, the corresponding MAC entity—e.g., for the third and fourth events—may be for each serving cell configured for UEI reporting according to those specified herein in the present disclosure. Table 14 shows the initiation or triggering a UEI reporting.

TABLE 14
The initiation or triggering a UEI reporting.

| 1> | to initiate or trigger a UEI reporting based on or according to detection or declaration of the third | |
|---|---|---|
| | and fourth events, jointly or simultaneously: | |
| | 2> | if an indication for an instance for the third event has been received from lower layers, and/or |
| | | if an indication for an instance for the fourth event has been received from lower layers: |

| | |
|---|---|
| 3> | start or restart the thirdEventInstanceDetectionTimer and/or |
| | fourthEventInstanceDetectionTimer (higher layer configured for the third and/or fourth |
| | event(s) - when applicable) |
| 3> | increment thirdEvent_COUNTER and/or fourthEvent_COUNTER (higher layer configured |
| | for the third and/or fourth event(s) - when applicable) by 1; |
| 3> | if both thirdEvent_COUNTER >= thirdEventInstanceMaxCount and |
| | fourthEvent_COUNTER >= fourthEventInstanceMaxCount (for the third and fourth events - |
| | when applicable), wherein the thirdEventInstanceMaxCount and |
| | fourthEventInstanceMaxCount are higher layer configured respectively for the third and |
| | fourth events - when applicable: |

| | |
|---|---|
| 4> | trigger a UEI (beam) reporting specific to the third and fourth events for this serving cell, |
| | wherein the report content(s)/quantity(s) in the UEI report(s) is specific to the third and |
| | fourth events - when applicable - according to examples in the present disclosure. |

| | |
|---|---|
| 2> | if the thirdEventInstanceDetection Timer and/or fourthEventInstanceDetectionTimer |
| | (respectively for the third and/or fourth event(s) - when applicable) expires; or |
| 2> | if the thirdEventInstanceDetection Timer and/or fourthEventInstanceDetection Timer |
| | (respectively for the third and/or fourth event(s) - when applicable), thirdEvent_COUNTER |
| | and/or fourthEvent_COUNTER (respectively for the third and/or fourth event(s) - when |
| | applicable), or any of the reference signals used for UEI reporting - e.g., including that/those |
| | specific to/for the current serving beam(s) and/or the candidate beam(s) as specified or defined |
| | herein in the present disclosure for the third and/or fourth event(s) - is reconfigured by upper |
| | layers associated with this serving cell; or |
| 2> | if the reference signal(s) associated with this serving cell used for |
| | detection/declaration/indication for the third and/or fourth event(s) as specified/defined herein |
| | in the present disclosure is changed and/or reconfigured by upper layers associated with this |
| | serving cell: |

| | |
|---|---|
| 3> | set thirdEvent_COUNTER and/or fourthEvent_COUNTER (respectively for the third and/or |
| | fourth event(s) - when applicable) to 0; and/or |
| 3> | stop the ueiReportingTimer, if configured; and/or |

| | |
|---|---|
| 3> | consider the UE-initiated (UEI) reporting procedure triggered or initiated with respect to both |

the third and fourth events successfully completed, and/or cancel all the UEI report(s) triggered or
initiated with respect to the third and fourth events for this serving cell.

The MAC entity(s) and the corresponding operation(s)/procedure(s) could be applied or extended to when more than two events could be configured and/or enabled by the network and/or applied or used by the UE for initiating or triggering the UEI reporting.

In one embodiment, configuration and determination of measurement RS resource(s) for UEI reporting are provided.

As specified in Rel-17, a unified TCI framework could indicate/include N≥1 DL TCI states and/or M≥1 UL TCI states, wherein the indicated TCI state could be at least one of: (i) a DL TCI state and/or its corresponding/associated TCI state ID; (ii) an UL TCI state and/or its corresponding/associated TCI state ID; (iii) a joint DL and UL TCI state and/or its corresponding/associated TCI state ID; and/or (iv) separate DL TCI state and UL TCI state and/or their corresponding/associated TCI state ID(s).

There could be various options/channels to indicate to the UE a beam (i.e., a TCI state) for the transmission/reception of a PDCCH or a PDSCH. As described in the 3GPP Rel-17.

In one example, a MAC CE could be used to indicate to the UE a beam (i.e., a TCI state and/or a TCI state ID) for the transmission/reception of a PDCCH or a PDSCH.

In another example, a DCI could be used to indicate to the UE a beam (i.e., a TCI state and/or a TCI state ID) for the transmission/reception of a PDCCH or a PDSCH.

In such example, a DL related DCI (e.g., DCI format 1_0, DCI format 1_1 or DCI format 12) could be used to indicate to the UE a beam (i.e., a TCI state and/or a TCI state ID) for the transmission/reception of a PDCCH or a PDSCH, wherein the DL related DCI may or may not include a DL assignment.

In such example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.

In such example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (i) in case of joint TCI state indication, wherein a same beam is used for DL and UL channels, a joint TCI state that can be used at least for UE-dedicated DL channels and UE-dedicated UL channels; (ii) in case of separate TCI state indication, wherein different beams are used for DL and UL channels, a DL TCI state can be used at least for UE-dedicated DL channels; and/or (iii) in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

The RS(s) or RS resource(s) or RS resource index(es) of/for a current serving beam—denoted by current serving beam RS(s) or RS resource(s) or RS resource index(es)—could be identified or determined according to one or more of following examples.

In one example, one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.

In another example, one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In yet another example, a set so of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set so of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure.

In yet another example, a set so of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set so of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to “on”), the UE could follow examples as disclosed in the present disclosure to determine or identify the current serving beam RS(s)/RS resource(s)/RS resource index(es). In another example, when the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow examples as disclosed in the present disclosure to determine or identify the current serving beam RS(s)/RS resource(s)/RS resource index(es), but instead, the UE could expect to be provided or configured or indicated by the network a/the set so of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those examples in the present disclosure.

Furthermore, the UE could assess or evaluate the radio link/beam quality(s), e.g., by measuring L1-RSRP(s)/L1-SINR(s), of a current serving beam based on or according to one or more of following examples.

In one example, the UE could assess or evaluate the radio link/beam quality(s), e.g., by measuring L1-RSRP(s)/L1-SINR(s), of all the RS(s) or RS resource(s) or RS resource index(es) determined (e.g., examples as disclosed in the present disclosure) and/or configured (e.g., examples as disclosed in the present disclosure) for the current serving beam(s) in the UEI/event-driven beam reporting.

In another example, the UE could assess or evaluate the radio link/beam quality(s), e.g., by measuring L1-RSRP(s)/L1-SINR(s), of one or more of the RS(s) or RS resource(s) or RS resource index(es) determined (e.g., examples as disclosed in the present disclosure) and/or configured (e.g., examples as disclosed in the present disclosure) for the current serving beam(s) in the UEI/event-driven beam reporting according to (or that has the same RS(s) or RS resource(s) or RS resource index(es) as to).

In one instance, one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.

In one instance, one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to one or more of following examples.

In one example, a set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet, and/or higher layer parameter(s) UEI-ReportConfig, UEI-ResourceConfig and/or etc. dedicated/configured for the UEI reporting as specified herein in the present disclosure.

In another example, a set s̅₁ of SS/PBCH block indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In yet another example, one or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.

In yet another example, one or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In yet another example, one or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.

In yet another example, one or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to “on”), the UE could follow examples as disclosed in the present disclosure to determine or identify the candidate/actual candidate/new beam RS(s)/RS resource(s)/RS resource index(es). In another example, when the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow examples as disclosed in the present disclosure to determine or identify the candidate/actual candidate/new beam RS(s)/RS resource(s)/RS resource index(es), but instead, the UE could expect to be provided or configured or indicated by the network a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to examples in the present disclosure.

Furthermore, the UE could identify or determine a subset of the candidate RS(s) or RS resource(s) or RS resource index(es) configured in examples/embodiments as disclosed in the present disclosure as the RS(s) or RS resource(s) or RS resource index(es) for the actual measurement for/of one or more candidate/new beams.

In one example, the UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.

In one instance, the one or more indicators could be or could correspond to a set of RS resource index(es)—e.g., a set of CSI-RS resource configuration index(es) and/or SSB index(es). For this example, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples as disclosed in the present disclosure), the one or more indicators (or equivalently, the set of RS resource index(es)) could provide or indicate or contain or include or comprise one or more indexes each belonging to {1, . . . , K}. Specifically, when the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.

In one instance, for another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when an entry/bit position of the bitmap is set to “1” (or “0”), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples disclosed in the present disclosure), the entries/bit positions in the bitmap associated/corresponding to the RS index #1, RS index #2 and RS index #K are set to “1”s while the entry(s)/bit position(s) in the bitmap associated/corresponding to the RS index(es) other than the RS index #1, RS index #2 and RS index #K are set to “0”s. In this case, the RSs or RS resources corresponding/associated to the RS index #1, RS index #2 and RS index #K in the set s̅₁ corresponding/associated to the entries/bit positions in the bitmap that are set to “1”s could be used/applied as the RS(s) or RS resource(s) for the actual measurement for/of the one or more candidate/new beams.

In one instance, the one or more indicators could be or could correspond to one or more 1-bit indicators each corresponding/associated to a candidate RS/RS resource/RS resource index or one of the candidate RS(s) or RS resource(s) or RS resource index(es). In this case, when a 1-bit indicator is set to “1” (or “0”), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples disclosed in the present disclosure), the 1-bit indicators associated/corresponding to the RS index #1, RS index #2 and RS index #K are set to “1”s while the 1-bit indicators associated/corresponding to the RS index(es) other than the RS index #1, RS index #2 and RS index #K are set to “0”s. In this case, the RSs or RS resources corresponding/associated to the RS index #1, RS index #2 and RS index #K in the set s̅₁ corresponding/associated to the 1-bit indicators that are set to “1”s could be used/applied as the RS(s) or RS resource(s) for the actual measurement for/of the one or more candidate/new beams.

In another example, the UE could determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams according to one or more of the followings, based on e.g., (1) fixed rule(s) in system specification(s) or per RRC (re)configuration, (ii) network's configuration(s) or indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection.

In one instance, the first (or last) L≥1 candidate RS(s) or RS resource(s) or RS resource index(es) or the L≥1 candidate RS(s) or RS resource(s) with the lowest (or highest) resource index(es)—among all the K configured/determined candidate RS(s) or RS resource(s) or RS resource index(es) with L≤K—could be used/applied as the RS(s) or RS resource(s) or RS resource index(es) for the actual measurement for/of the one or more candidate/new beams. Optionally, the first (or last) half of all the K configured/determined candidate RS(s) or RS resource(s) or RS resource index(es) or the half of all the K configured/determined candidate RS(s) or RS resource(s) with the lowest (or highest) resource index(es) could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (e.g., examples disclosed in the present disclosure), the RSs or RS resources corresponding/associated to the RS index #1 and RS index #2 in the set s̅₁ (i.e., the first half) could be used/applied as the RS(s) or RS resource(s) for the actual measurement for/of the one or more candidate/new beams.

In one instance, the even-ordered or even-numbered or even-indexed candidate RS(s) or RS resource(s) or RS resource index(es) or the candidate RS(s) or RS resource(s) with even-valued resource index(es)—among all the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (e.g., examples disclosed in the present disclosure), the RSs or RS resources corresponding/associated to the RS index #2 and RS index #4 (even-valued RS resource indexes) in the set s̅₁ could be used/applied as the RS(s) or RS resource(s) for the actual measurement for/of the one or more candidate/new beams.

In one instance, the odd-ordered or odd-numbered or odd-indexed candidate RS(s) or RS resource(s) or RS resource index(es) or the candidate RS(s) or RS resource(s) with odd-valued resource index(es)—among all the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (e.g., examples disclosed in the present disclosure), the RSs or RS resources corresponding/associated to the RS index #1 and RS index #3 (odd-valued RS resource indexes) in the set s̅₁ could be used/applied as the RS(s) or RS resource(s) for the actual measurement for/of the one or more candidate/new beams.

In another example, the UE could indicate or transmit or send to the network, e.g., by/in part of a/the UEI beam report, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.

In one instance, the one or more indicators could be or could correspond to a set of RS resource index(es)—e.g., a set of CSI-RS resource configuration index(es) and/or SSB index(es). For this example, each of the RS resource index(es) in the set could correspond/point to or represent a candidate RS/RS resource/RS resource index or one of the candidate RS(s) or RS resource(s) or RS resource index(es). In this case, the UE could determine/identify and/or indicate to the network that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples disclosed in the present disclosure), the one or more indicators (or equivalently, the set of RS resource index(es)) could provide or indicate or contain or include or comprise one or more indexes each belonging to {1, . . . , K}. Specifically, when the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.

In one instance, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when an entry/bit position of the bitmap is set to “1” (or “0”), the UE could determine/identify and/or indicate to the network that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples disclosed in the present disclosure), the entries/bit positions in the bitmap associated/corresponding to the RS index #1, RS index #2 and RS index #K are set to “1”s while the entry(s)/bit position(s) in the bitmap associated/corresponding to the RS index(es) other than the RS index #1, RS index #2 and RS index #K are set to “0”s. In this case, the RSs or RS resources corresponding/associated to the RS index #1, RS index #2 and RS index #K in the set s̅₁ corresponding/associated to the entries/bit positions in the bitmap that are set to “1”s could be used/applied as the RS(s) or RS resource(s) for the actual measurement for/of the one or more candidate/new beams.

In one instance, the one or more indicators could be or could correspond to one or more 1-bit indicators each corresponding/associated to a candidate RS/RS resource/RS resource index or one of the candidate RS(s) or RS resource(s) or RS resource index(es). In this case, when a 1-bit indicator is set to “1” (or “0”), the UE could determine/identify and/or indicate to the network that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K}configured/provided by the network (e.g., examples disclosed in the present disclosure), the 1-bit indicators associated/corresponding to the RS index #1, RS index #2 and RS index #K are set to “1”s while the 1-bit indicators associated/corresponding to the RS index(es) other than the RS index #1, RS index #2 and RS index #K are set to “0”s. In this case, the RSs or RS resources corresponding/associated to the RS index #1, RS index #2 and RS index #K in the set s̅₁ corresponding/associated to the 1-bit indicators that are set to “1”s could be used/applied as the RS(s) or RS resource(s) for the actual measurement for/of the one or more candidate/new beams.

As specified herein in the present disclosure, a UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. In particular, the one or more indicators as defined/specified herein in the present disclosure could be provided or indicated or contained or comprised or included or configured in a/the higher layer parameter TCI-State or TCI-UL-State that configures or provides the indicated TCI state.

In one example, the one or more indicators could be or could correspond to a set of RS resource index(es)—e.g., a set of CSI-RS resource configuration index(es) and/or SSB index(es). As discussed/specified herein in the present disclosure, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples disclosed in the present disclosure), the one or more indicators (or equivalently, the set of RS resource index(es)) provided, indicated, contained, comprised, configured or included in a/the higher layer parameter TCI-State or TCI-UL-State that configures or provides the indicated TCI state could provide or indicate or contain or include or comprise one or more indexes each belonging to {1, . . . , K}. Specifically, when the RS resource indexes in the set provided, indicated, contained, comprised, configured or included in a/the higher layer parameter TCI-State or TCI-UL-State that configures or provides the indicated TCI state correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.

In another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). As discussed/specified herein in the present disclosure, when an entry/bit position of the bitmap is set to “1” (or “0”), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples disclosed in the present disclosure), the entries/bit positions in the bitmap provided, indicated, contained, comprised, configured or indicated in a/the higher layer parameter TCI-State or TCI-UL-State that configures or provides the indicated TCI state associated/corresponding to the RS index #1, RS index #2 and RS index #K are set to “1”s while the entry(s)/bit position(s) in the bitmap provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to “0”s. In this case, the RSs or RS resources corresponding/associated to the RS index #1, RS index #2 and RS index #K in the set s̅₁ corresponding/associated to the entries/bit positions in the bitmap provided, indicated, contained, comprised, configured or indicated in a/the higher layer parameter TCI-State or TCI-UL-State that configures or provides the indicated TCI state that are set to “1”s could be used/applied as the RS(s) or RS resource(s) for the actual measurement for/of the one or more candidate/new beams.

In another example, the one or more indicators could be or could correspond to one or more 1-bit indicators each corresponding/associated to a candidate RS/RS resource/RS resource index or one of the candidate RS(s) or RS resource(s) or RS resource index(es). As discussed/specified herein in the present disclosure, when a 1-bit indicator is set to “1” (or “0”), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., examples disclosed in the present disclosure), the 1-bit indicators provided, indicated, contained, comprised, configured or indicated in a/the higher layer parameter TCI-State or TCI-UL-State that configures or provides the indicated TCI state associated/corresponding to the RS index #1, RS index #2 and RS index #K are set to “1”s while the 1-bit indicators provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to “0”s. In this case, the RSs or RS resources corresponding/associated to the RS index #1, RS index #2 and RS index #K in the set s̅₁ corresponding/associated to the 1-bit indicators provided, indicated, contained, comprised, configured or indicated in a/the higher layer parameter TCI-State or TCI-UL-State that configures or provides the indicated TCI state that are set to “1”s could be used/applied as the RS(s) or RS resource(s) for the actual measurement for/of the one or more candidate/new beams.

As disclosed in the present disclosure, when the higher layer parameter TCI-State or TCI-UL-State that configures or provides the indicated TCI state does not provide, contain, indicate, include, comprise or configure any of the one or more indicators as specified/defined herein in the present disclosure, and/or the one or more indicators as specified/defined herein in the present disclosure is absent or not present in the higher layer parameter TCI-State or TCI-UL-State that configures or provides the indicated TCI state, the UE could assess or evaluate the radio link/beam quality(s), e.g., by measuring the L1-RSRP(s)/L1-SINR(s), of all the candidate RS(s) or RS resource(s) or RS resource index(es) configured in examples/embodiments disclosed in the present disclosure to obtain the actual corresponding measurement result(s) for/of the one or more candidate/new beams. As specified or discussed herein in the present disclosure, a/the UE could indicate or send or transmit to the network, e.g., by/in part of their capability or capability signaling, whether or not they are capable of receiving/detecting/using/applying or support to receive/detect/use/apply the one or more indicators as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; for instance, a/the UE could indicate or send or transmit to the network, e.g., by/in part of their capability or capability signaling, whether or not they are capable of receiving/detecting/using/applying or support to receive/detect/use/apply the one or more indicators provided, contained, indicated, included, comprised or configured in the higher layer parameter TCI-State or TCI-UL-State that configures or provides the indicated TCI state as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.

Optionally, when a/the total number of the candidate RS(s) or RS resource(s) or RS resource index(es) configured in examples disclosed in the present disclosure to obtain the actual corresponding measurement result(s) for/of the one or more candidate/new beams is greater than or equal to a first threshold/number/value, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, (ii) follow examples disclosed in the present disclosure, follow other subset based candidate RS(s)/RS resource(s)/RS resource index(es) indication/identification/determination method(s) as disclosed in the present disclosure, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when a/the total number of the candidate RS(s) or RS resource(s) or RS resource index(es) configured following those specified/described in the present disclosure, e.g., examples disclosed in the present disclosure to obtain the actual corresponding measurement result(s) for/of the one or more candidate/new beams is less than or equal to the first threshold/number/value, the UE could assess or evaluate the radio link/beam quality(s), e.g., by measuring the L1-RSRP(s)/L1-SINR(s), of all the candidate RS(s) or RS resource(s) or RS resource index(es) configured following examples disclosed in the present disclosure to obtain the actual corresponding measurement result(s) for/of the one or more candidate/new beams.

In this case, the UE could determine or identify the first threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Alternatively, when a/the total number of the one or more TCI states activated by/in the TCI state(s) activation/deactivation MAC CE command (or a/the total number of the corresponding RS(s)/RS resource(s)/RS resource index(es) associated to/with the one or more TCI states as disclosed in the present disclosure) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as disclosed in the present disclosure—is less than or equal to a second threshold/value/number, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, and/or (ii) follow examples disclosed in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when a/the total number of the one or more TCI states activated by/in the TCI state(s) activation/deactivation MAC CE command (or a/the total number of the corresponding RS(s)/RS resource(s)/RS resource index(es) associated to/with the one or more TCI states as disclosed in the present disclosure) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as disclosed in the present disclosure—is greater than or equal to the second threshold/value/number, the UE could assess or evaluate the radio link/beam quality(s), e.g., by measuring the L1-RSRP(s)/L1-SINR(s), of all the candidate RS(s) or RS resource(s) or RS resource index(es) determined following examples disclosed in the present disclosure to obtain the actual corresponding measurement result(s) for/of the one or more candidate/new beams.

In this case, the UE could determine or identify the second threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Furthermore, the UE could first determine or identify, e.g., based on or according to (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), one or more first candidate TCI states, wherein the first candidate TCI state(s) could be from a list of TCI state(s) higher layer configured or provided by the network, e.g., a list of joint/DL TCI state(s) provided by DLorJointTCI-State, and/or a set of TCI state(s) activated in/by a TCI state(s) activation/deactivation MAC CE command, and the (QCL source) RS(s) or RS resource(s) or RS resource index(es) provided in each of the first candidate TCI state(s) could correspond to a candidate candidate/new beam RS or RS resource or RS resource index as specified/defined herein in the present disclosure.

Additionally, the UE could also determine or identify one or more of or a subset of the first candidate TCI state(s) as one or more second candidate TCI state(s) following or according to those specified or defined herein in the present disclosure for determining or identifying the actual candidate/new beam RS(s)/RS resource(s)/RS resource index(es) from the candidate candidate/new beam RS(s)/RS resource(s)/RS resource index(es)—including the indication(s)/configuration(s)/usage(s)/application(s) of the one or more indicators such as bitmap(s)/1-bit indicator(s)/etc. as specified/defined herein in the present disclosure, wherein the (QCL source) RS(s) or RS resource(s) or RS resource index(es) provided in each of the second candidate TCI state(s) could correspond to an actual candidate/new beam RS or RS resource or RS resource index as defined/specified herein in the present disclosure.

As disclosed in the present disclosure, a RS or RS resource or RS resource index of/for a current serving beam—denoted by a current serving beam RS/RS resource/RS resource index—could be corresponding/associated/mapped to one or more of (or a subset of) candidate RSs or RS resources or RS resource indexes—denoted by candidate candidate/new beam RS(s)/RS resource(s)/RS resource index(es)—used/applied as the RS(s) or RS resource(s) or RS resource index(es) for actual measurement(s) of/for one or more candidate/new beams—denoted by actual candidate/new beam RS(s)/RS resource(s)/RS resource index(es), wherein the current serving beam RS/RS resource/RS resource index and/or the candidate or actual candidate/new beam RS(s)/RS resource(s)/RS resource index(es) could be configured and/or determined according to those specified herein in the present disclosure.

In one example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.

In one instance, as described in the present disclosure, the current serving beam RS/RS resource/RS resource index (or equivalently, the QCL source RS/RS resource/RS resource index) in the indicated TCI state provided by TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure—provided, indicated, configured, comprised, included or contained in the same higher layer parameter(s) TCI-State or TCI-UL-State that provides or configures the indicated TCI state.

In one instance, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure. For this example, the current serving beam RS/RS resource/RS resource index could be associated/mapped/corresponding to the one or more actual candidate/new beam RSs/RS resources/RS resource indexes.

In one instance, a/the higher layer RRC signaling(s)/parameter(s) and/or MAC CE command(s) and/or dynamic DCI based L1 signaling(s) that provides or configures or indicates one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure—could include, contain, provide, indicate, comprise or configure a current serving beam RS/RS resource/RS resource index. For this example, the current serving beam RS/RS resource/RS resource index could be associated/mapped/corresponding to the one or more actual candidate/new beam RSs/RS resources/RS resource indexes.

In one instance, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure. For this example, the current serving beam RS/RS resource/RS resource index could be associated/mapped/corresponding to the one or more actual candidate/new beam RSs/RS resources/RS resource indexes—via/by their associations to the one or more indicators as specified/defined herein in the present disclosure.

In one instance, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a single/same set/list of RSs or RS resources or RS resource indexes that comprise, contain, include, provide, configure or indicate both a current serving beam RS/RS resource/RS resource index (e.g., the first entry in the set/list or the entry with the lowest/highest RS index or RS resource index in the set/list) and one or more actual candidate/new beam RSs/RS resources/RS resource indexes (e.g., the remaining or rest of the entries in the set/list other than the first entry or the entry with the lowest/highest RS index or RS resource index). Optionally, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to examples disclosed in the present disclosure, which one of the RSs or RS resources or RS resource indexes in the set/list could correspond to the current serving beam RS or RS resource or RS resource index and/or which one or more of the RSs or RS resources or RS resource indexes in the set/list could correspond to the actual candidate/new beam RS(s) or RS resource(s) or RS resource index(es). Alternatively, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS/RS resource/RS resource index in the set/list, and/or identify or determine, according to or based on the second list/set, the actual candidate/new beam RS(s)/RS resource(s)/RS resource index(es) in the set/list. For this example, the current serving beam RS/RS resource/RS resource index could be associated/mapped/corresponding to the one or more actual candidate/new beam RSs/RS resources/RS resource indexes as defined/specified herein.

In one instance, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, an overall set/list of RSs or RS resources or RS resource indexes that comprise, contain, include, provide, configure or indicate both one or more current serving beam RSs/RS resources/RS resource indexes and one or more actual candidate/new beam RSs/RS resources/RS resource indexes. For this example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to examples disclosed in the present disclosure, which one or more of the RSs or RS resources or RS resource indexes in the overall set/list could correspond to the current serving beam RS(s) or RS resource(s) or RS resource index(es) and/or which one or more of the RSs or RS resources or RS resource indexes in the overall set/list could correspond to the actual candidate/new beam RS(s) or RS resource(s) or RS resource index(es). For instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS(s)/RS resource(s)/RS resource index(es) in the overall set/list, and/or identify or determine, according to or based on the second list/set, the actual candidate/new beam RS(s)/RS resource(s)/RS resource index(es) in the overall set/list. Additionally, for a current serving beam RS/RS resource/RS resource index in the overall set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between the current serving beam RS/RS resource/RS resource index and one or more indicators; similar to those specified/defined herein in the present disclosure, the one or more indicators could point/correspond to or represent or indicate one or more actual candidate/new beam RSs/RS resources/RS resource indexes (i.e., from/among/out of all the actual candidate/new beam RSs/RS resources/RS resource indexes in the overall set/list); in this case, the current serving beam RS/RS resource/RS resource index could be associated/mapped/corresponding to the one or more actual candidate/new beam RSs/RS resources/RS resource indexes—via/by their associations to the one or more indicators as specified/defined herein in the present disclosure.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the candidate/actual candidate/new beam RS(s) or RS resource(s) or RS resource index(es) in the second set/list could be associated/mapped/corresponding to the current serving beam RS/RS resource/RS resource index.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more candidate/actual candidate/new beam RSs or RS resources or RS resource indexes each comprising one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists (and therefore, the corresponding candidate/actual candidate/new beam RS(s)/RS resource(s)/RS resource index(es) comprised or provided therein) could be associated/mapped/corresponding to the current serving beam RS/RS resource/RS resource index.

In another example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.

In one instance, as described in the present disclosure, the current serving beam RS/RS resource/RS resource index (or equivalently, the QCL source RS/RS resource/RS resource index) in the indicated TCI state provided by TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure—provided, indicated, configured, comprised, included or contained in one or more second candidate TCI states whose ID(s), index(es) or related information—such as the one or more indicators used to determine or identify or indicate the one or more second candidate TCI states from or out of one or more first candidate TCI states—could be provided, indicated, configured, comprised, included or contained in the same higher layer parameter(s) TCI-State or TCI-UL-State that provides or configures the indicated TCI state.

In one instance, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure. For this example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).

In one instance, a/the higher layer RRC signaling(s)/parameter(s) and/or MAC CE command(s) and/or dynamic DCI based L1 signaling(s) that provides or configures or indicates one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure—could include, contain, provide, indicate, comprise or configure a current serving beam RS/RS resource/RS resource index. For this example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).

In one instance, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more second candidate TCI states—i.e., a subset of or one or more of the first candidate TCI states following those specified herein in the present disclosure. For this example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—via/by their associations to the one or more indicators as specified/defined herein in the present disclosure.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more first/second candidate TCI states (e.g., in form of their IDs/indexes/etc.) as specified/defined herein in the present disclosure. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the first/second candidate TCI states in the second set/list—and therefore the corresponding candidate/actual candidate/new beam RS(s) or RS resource(s) or RS resource index(es) provided/indicated therein (i.e., in the corresponding first/second candidate TCI state(s))—could be associated/mapped/corresponding to the current serving beam RS/RS resource/RS resource index.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more first/second candidate TCI states (e.g., in form of their IDs/indexes/etc.) as specified/defined herein in the present disclosure each comprising one or more first/second candidate TCI states (e.g., in form of their IDs/indexes/etc.). For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists of first/second TCI state(s)—and therefore the corresponding candidate/actual candidate/new beam RS(s) or RS resource(s) or RS resource index(es) provided/indicated therein (i.e., in the corresponding first/second candidate TCI state(s))—could be associated/mapped/corresponding to the current serving beam RS/RS resource/RS resource index.

In another example, the UE could determine or identify, based on or according to, e.g., fixed rule(s) in system specification(s) and/or per RRC (re)configuration, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when its corresponding RS index or RS resource index or RS resource configuration index has the same value as the set ID/index of a set/list of one or more candidate/actual candidate/new beam RS(s)/RS resource(s)/RS resource index(es), the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of candidate/actual candidate/new beam RSs/RS resources with the lowest (or highest) set ID/index, the current serving beam RS/RS resource with the second lowest (or second highest) RS index or RS resource index or RS resource configuration index could be associated/mapped/corresponding to the set/list of candidate/actual candidate/new beam RSs/RS resources with the second lowest (or second highest) set ID/index, and so on, and the current serving beam RS/RS resource with the highest (or lowest) RS index or RS resource index or RS resource configuration index could be associated/mapped/corresponding to the set/list of candidate/actual candidate/new beam RSs/RS resources with the highest (or lowest) set ID/index.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when its corresponding RS index or RS resource index or RS resource configuration index and the set ID/index of a set/list of one or more candidate/actual candidate/new beam RS(s)/RS resource(s)/RS resource index(es) are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when its corresponding RS index or RS resource index or RS resource configuration index (e.g., the first or #1, second or #2, etc.) has the same value as the ordering/position (e.g., the first, second, etc.) of a group of candidate/actual candidate/new beam RS(s)/RS resource(s)/RS resource index(es) among all the groups in the set/list, the current serving beam RS/RS resource/RS resource index could be associated/mapped/corresponding to the one or more candidate/actual candidate/new beam RSs/RS resources/RS resource indexes in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of candidate/actual candidate/new beam RSs/RS resources with the lowest (or highest) ordering/position among all the groups in the set/list, the current serving beam RS/RS resource with the second lowest (or second highest) RS index or RS resource index or RS resource configuration index could be associated/mapped/corresponding to the group of candidate/actual candidate/new beam RSs/RS resources with the second lowest (or second highest) ordering/position among all the groups in the set/list, and so on, and the current serving beam RS/RS resource with the highest (or lowest) RS index or RS resource index or RS resource configuration index could be associated/mapped/corresponding to the group of candidate/actual candidate/new beam RSs/RS resources with the highest (or lowest) ordering/position among all the groups in the set/list.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when its corresponding RS index or RS resource index or RS resource configuration index (e.g., the first or #1, second or #2, etc.) and the ordering/position (e.g., the first, second, etc.) of a group of candidate/actual candidate/new beam RS(s)/RS resource(s)/RS resource index(es) among all the groups in the set/list are correlated or related, the current serving beam RS/RS resource/RS resource index could be associated/mapped/corresponding to the one or more candidate/actual candidate/new beam RSs/RS resources/RS resource indexes in the group. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when its corresponding RS index or RS resource index or RS resource configuration index has the same value as the RS index(es) or RS resource index(es) or RS resource configuration index(es) of one or more candidate/actual candidate/new beam RSs or RS resources, the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the candidate/actual candidate/new beam RSs/RS resources with the lowest (or highest) RS index(es) or RS resource index(es) or RS resource configuration index(es), the current serving beam RS/RS resource with the second lowest (or second highest) RS index or RS resource index or RS resource configuration index could be associated/mapped/corresponding to the candidate/actual candidate/new beam RSs/RS resources with the second lowest (or second highest) RS index(es) or RS resource index(es) or RS resource configuration index(es), and so on, and the current serving beam RS/RS resource with the highest (or lowest) RS index or RS resource index or RS resource configuration index could be associated/mapped/corresponding to the candidate/actual candidate/new beam RSs/RS resources with the highest (or lowest) RS index(es) or RS resource index(es) or RS resource configuration index(es).

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when its corresponding RS index or RS resource index or RS resource configuration index and the RS index(es) or RS resource index(es) or RS resource configuration index(es) of one or more candidate/actual candidate/new beam RSs or RS resources are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. The UE could first determine or identify the one or more current serving beam RSs/RS resources/RS resource indexes in the set/list, and/or the one or more candidate/actual candidate/new beam RSs/RS resources/RS resource indexes in the set/list according to examples in the present disclosure. The UE could then determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to examples in the present disclosure.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this example, the entry(s)/position(s)/ordering(s)—e.g., the first, second, etc.—in the set/list that could carry, convey, contain, include, provide or indicate the one or more current serving beam RSs/RS resources/RS resource indexes could be fixed; alternatively, the RS index(es)/RS resource index(es)/RS resource configuration index(es) in the set/list that could correspond or refer to the one or more current serving beam RSs/RS resources/RS resource indexes could be fixed. In this case, the P≥1 entry(s)/position(s)/ordering(s) in the set/list that follow the entry(s)/position(s)/ordering(s) in the set/list that carries, conveys, contains, includes, provides or indicates the current serving beam RS(s)/RS resource(s)/RS resource index(es) could carry, convey, contain, include, provide or indicate the one or more candidate/actual candidate/new beam RSs/RS resources/RS resource indexes that are corresponding/associated/mapped to the current serving beam RS(s)/RS resource(s)/RS resource index(es). Alternatively, the P≥1 entry(s)/position(s)/ordering(s) in the set/list that follow the RS index(es) or RS resource index(es) or RS resource configuration index(es) in the set/list that corresponds or refers to the current serving beam RS(s)/RS resource(s)/RS resource index(es) could carry, convey, contain, include, provide or indicate the one or more candidate/actual candidate/new beam RSs/RS resources/RS resource indexes that are corresponding/associated/mapped to the current serving beam RS(s)/RS resource(s)/RS resource index(es). The value of P could be determined or identified according to: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this example, the first Q≥1 entry(s)/position(s)/ordering(s) in the set/list could carry, convey, contain, include, provide or indicate the one or more current serving beam RSs/RS resources/RS resource indexes; alternatively, the Q≥1 lowest/highest RS index(es)/RS resource index(es)/RS resource configuration index(es) in the set/list could correspond or refer to the one or more current serving beam RSs/RS resources. In this case, the rest of or remaining entry(s)/position(s)/ordering(s) in the set/list could carry, convey, contain, include, provide or indicate the one or more candidate/actual candidate/new beam RSs/RS resources/RS resource indexes, and/or the rest of or remaining RS index(es)/RS resource index(es)/RS resource configuration index(es) in the set/list could correspond or refer to the one or more candidate/actual candidate/new beam RSs or RS resources. The value of Q could be determined or identified according to: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Furthermore, the UE could determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to examples in the present disclosure.

In another example, the UE could determine or identify, based on or according to, e.g., fixed rule(s) in system specification(s) and/or per RRC (re)configuration, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of first/second candidate TCI state(s)—e.g., in form of TCI state ID(s)/index(es)/etc.—as defined/specified herein in the present disclosure, wherein each set/list could be associated with a set ID/index and could comprise one or more first/second candidate TCI states as defined/specified herein in the present disclosure. For a current serving beam RS or RS resource, when its corresponding RS index or RS resource index or RS resource configuration index has the same value as the set ID/index of a set/list of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the lowest (or highest) set ID/index, the current serving beam RS/RS resource with the second lowest (or second highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated—with the second lowest (or second highest) set ID/index, and so on, and the current serving beam RS/RS resource with the highest (or lowest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the highest (or lowest) set ID/index.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of first/second candidate TCI state(s)—e.g., in form of TCI state ID(s)/index(es)/etc.—as defined/specified herein in the present disclosure, wherein each set/list could be associated with a set ID/index and could comprise one or more first/second candidate TCI states as defined/specified herein in the present disclosure. For a current serving beam RS or RS resource, when its corresponding RS index or RS resource index or RS resource configuration index and the set ID/index of a set/list of one or more first/second candidate TCI state(s) are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states—e.g., in form of TCI state ID(s)/index(es)/etc.—as defined/specified herein in the present disclosure. The set/list of first/second candidate TCI state(s) as defined/specified herein in the present disclosure could be further divided or separated into one or more groups each comprising one or more (e.g., a fixed number) first/second candidate TCI states. For a current serving beam RS or RS resource, when its corresponding RS index or RS resource index or RS resource configuration index (e.g., the first or #1, second or #2, etc.) has the same value as the ordering/position (e.g., the first, second, etc.) of a group of first/second candidate TCI state(s) among all the groups in the set/list, the current serving beam RS/RS resource/RS resource index could be associated/mapped/corresponding to the candidate/actual candidate/new beam RS(s)/RS resource(s)/RS resource index(es) provided or indicated in/by the first/second candidate TCI state(s) in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the lowest (or highest) ordering/position among all the groups in the set/list, the current serving beam RS/RS resource with the second lowest (or second highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the second lowest (or second highest) ordering/position among all the groups in the set/list, and so on, and the current serving beam RS/RS resource with the highest (or lowest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the highest (or lowest) ordering/position among all the groups in the set/list.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. The set/list of first/second candidate TCI states as defined/specified herein in the present disclosure could be further divided or separated into one or more groups each comprising one or more (e.g., a fixed number) first/second candidate TCI states. For a current serving beam RS or RS resource, when its corresponding RS index or RS resource index or RS resource configuration index (e.g., the first or #1, second or #2, etc.) and the ordering/position (e.g., the first, second, etc.) of a group of first/second candidate TCI states among all the groups in the set/list are correlated or related, the current serving beam RS/RS resource/RS resource index could be associated/mapped/corresponding to the candidate/actual candidate/new beam RS(s)/RS resource(s)/RS resource index(es) provided or indicated in/by the first/second candidate TCI states in the group. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when its corresponding RS index or RS resource index or RS resource configuration index has the same value as the TCI state ID(s)/index(es) of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the first/second candidate TCI state(s) with the lowest (or highest) TCI state ID(s)/index(es)—and therefore the corresponding candidate/actual candidate/new beam RS(s)/RS resource(s)/RS resource index(es) provided or indicated therein, the current serving beam RS/RS resource with the second lowest (or second highest) RS index or RS resource index or RS resource configuration index could be associated/mapped/corresponding to the first/second candidate TCI state(s) with the second lowest (or second highest) TCI state ID(s)/index(es)—and therefore the corresponding candidate/actual candidate/new beam RS(s)/RS resource(s)/RS resource index(es) provided or indicated therein, and so on, and the current serving beam RS/RS resource with the highest (or lowest) RS index or RS resource index or RS resource configuration index could be associated/mapped/corresponding to the first/second candidate TCI state(s) with the highest (or lowest) TCI state ID(s)/index(es)—and therefore the corresponding candidate/actual candidate/new beam RS(s)/RS resource(s)/RS resource index(es) provided or indicated therein.

In one instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when its corresponding RS index or RS resource index or RS resource configuration index and the TCI state ID(s)/index(es) of one or more first/second candidate TCI states are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In the present disclosure, a UE could first identify or determine a current serving beam RS/RS resource/RS resource index according to examples in the present disclosure, and perform the corresponding measurement(s)—e.g., by assessing or evaluating the radio link/beam quality(s) including measuring the L1-RSRP(s)/L1-SINR(s)—of the identified or determined current serving beam RS or RS resource or RS resource configuration. The UE could then identify or determine one or more actual candidate/new beam RSs/RS resources/RS resource indexes that are associated/mapped/corresponding to the determined or identified current serving beam RS/RS resource/RS resource index according to examples in the present disclosure, and perform the corresponding measurement(s)—e.g., by assessing or evaluating the radio link/beam quality(s) including measuring the L1-RSRP(s)/L1-SINR(s)—of the identified or determined actual candidate/new beam RS(s) or RS resource(s) or RS resource configuration(s).

Furthermore, the UE could determine or identify one or more candidate or actual candidate/new beam RSs or RS resources or RS resource indexes according to examples in the present disclosure. The UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure as shown in following examples.

In one example, according to or that have the same value(s) of RS index(es) or RS resource index(es) or RS resource configuration index(es) as that of the RS(s) or RS resource(s) or RS resource index(es) or RS resource configuration index(es) provided in/by all the TCI state(s) and/or all the joint/DL TCI state(s) activated or provided or indicated or contained or included or comprised by/in a (unified) TCI state(s) activation/deactivation MAC CE command.

In another example, according to or that have the same value(s) of RS index(es) or RS resource index(es) or RS resource configuration index(es) as that of the RS(s) or RS resource(s) or RS resource index(es) or RS resource configuration index(es) provided in/by one or more of (or a subset of) the TCI state(s) and/or one or more of (or a subset of) the joint/DL TCI state(s) activated or provided or indicated or contained or included or comprised by/in a (unified) TCI state(s) activation/deactivation MAC CE command. The one or more of (or the subset of) the TCI state(s) and/or the one or more of (or the subset of) the joint/DL TCI state(s) activated or provided or indicated or contained or included or comprised by/in a (unified) TCI state(s) activation/deactivation MAC CE command—e.g., among or out of all the TCI state(s) and/or all the joint/DL TCI state(s) activated or provided or indicated or contained or included or comprised by/in the (unified) TCI state(s) activation/deactivation MAC CE command—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In yet another example, according to or that have the same value(s) of RS index(es) or RS resource index(es) or RS resource configuration index(es) as that of the RS(s) or RS resource(s) or RS resource index(es) or RS resource configuration index(es) provided in/by all the TCI state(s) in a list of TCI state(s) higher layer configured or provided to the UE, e.g., the joint/DL TCI state(s) provided or configured in/by DLorJointTCI-State.

In yet another example, according to or that have the same value(s) of RS index(es) or RS resource index(es) or RS resource configuration index(es) as that of the RS(s) or RS resource(s) or RS resource index(es) or RS resource configuration index(es) provided in/by one or more of (or a subset of) all the TCI state(s) in a list of TCI state(s) higher layer configured or provided to the UE, e.g., the joint/DL TCI state(s) provided or configured in/by DLorJointTCI-State. The one or more of (or the subset of) all the TCI state(s) in the list of TCI state(s), e.g., DLorJointTCI-State, higher layer configured or provided to the UE—e.g., among or out of all the TCI state(s) in the list of TCI state(s) higher layer configured or provided to the UE, e.g., the joint/DL TCI state(s) provided or configured in/by DLorJointTCI-State—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

The UE could first assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according following examples.

In one example, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to following examples.

In one example, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following examples.

In one example, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following examples.

In one example, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of all the determined or identified one or more candidate/actual new beam RSs or RS resources or RS resource configurations as specified/defined herein in the present disclosure.

In the present disclosure, a UE could (implicitly) determine one or more candidate/actual new beam RSs or RS resources or RS resource configurations a shown in following examples.

In one example, as the RS(s) or RS resource(s) or RS resource index(es) or RS resource configuration index(es) provided in/by all the TCI state(s) and/or all the joint/DL TCI state(s) activated or provided or indicated or contained or included or comprised by/in a (unified) TCI state(s) activation/deactivation MAC CE command.

In another example, as the RS(s) or RS resource(s) or RS resource index(es) or RS resource configuration index(es) provided in/by one or more of (or a subset of) the TCI state(s) and/or one or more of (or a subset of) the joint/DL TCI state(s) activated or provided or indicated or contained or included or comprised by/in a (unified) TCI state(s) activation/deactivation MAC CE command. The one or more of (or the subset of) the TCI state(s) and/or the one or more of (or the subset of) the joint/DL TCI state(s) activated or provided or indicated or contained or included or comprised by/in a (unified) TCI state(s) activation/deactivation MAC CE command—e.g., among or out of all the TCI state(s) and/or all the joint/DL TCI state(s) activated or provided or indicated or contained or included or comprised by/in the (unified) TCI state(s) activation/deactivation MAC CE command—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In yet another example, as the RS(s) or RS resource(s) or RS resource index(es) or RS resource configuration index(es) provided in/by all the TCI state(s) in a list of TCI state(s) higher layer configured or provided to the UE, e.g., the joint/DL TCI state(s) provided or configured in/by DLorJointTCI-State.

In yet another example, as the RS(s) or RS resource(s) or RS resource index(es) or RS resource configuration index(es) provided in/by one or more of (or a subset of) all the TCI state(s) in a list of TCI state(s) higher layer configured or provided to the UE, e.g., the joint/DL TCI state(s) provided or configured in/by DLorJointTCI-State. The one or more of (or the subset of) all the TCI state(s) in the list of TCI state(s), e.g., DLorJointTCI-State, higher layer configured or provided to the UE—e.g., among or out of all the TCI state(s) in the list of TCI state(s) higher layer configured or provided to the UE, e.g., the joint/DL TCI state(s) provided or configured in/by DLorJointTCI-State—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In this case, the UE could first (implicitly) determine one or more candidate/actual new beam RSs or RS resources or RS resource configurations according to or following examples/embodiments as disclosed in the present disclosure such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations.

If the UE could identify or determine a L_min≥1 number of candidate/actual new beam RS(s) or RS resource(s) or RS resource index(es)—out of all the candidate/actual candidate/new beam RS(s)/RS resource(s)/RS resource index(es) determined or identified according to or following those described or specified in examples—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according to or following examples disclosure in the present disclosure such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations.

If the UE could identify or determine a L_min≥1 number of candidate/actual new beam RS(s) or RS resource(s) or RS resource index(es)—out of all the candidate/actual candidate/new beam RS(s)/RS resource(s)/RS resource index(es) determined or identified according to or following examples in the present disclosure—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according to or following examples in the present disclosure such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations.

If the UE could identify or determine a L_min≥1 number of candidate/actual new beam RS(s) or RS resource(s) or RS resource index(es)—out of all the candidate/actual candidate/new beam RS(s)/RS resource(s)/RS resource index(es) determined or identified according to examples as disclosed in the present disclosure—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according examples as disclosed in the present disclosure such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations.

If the UE could identify or determine a L_min≥1 number of candidate/actual new beam RS(s) or RS resource(s) or RS resource index(es)—out of all the candidate/actual candidate/new beam RS(s)/RS resource(s)/RS resource index(es) determined or identified according to examples as disclosed in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE may not declare detection of or trigger the corresponding event(s).

In the present disclosure, the current serving beam RS(s)/RS resource(s)/RS resource index(es) and the candidate (or actual) candidate/new beam RS(s)/RS resource(s)/RS resource index(es) as specified/defined herein in the present disclosure could be in a/same set/list of RS(s) or RS resource(s) or RS resource index(es), e.g., provided or indicated or configured by the network via/by higher layer RRC signaling(s)/parameter(s) and/or MAC CE command(s) and/or dynamic DCI based L1 signaling(s) based on or according to a corresponding UE's capability or capability signaling. Optionally, the current serving beam RS(s)/RS resource(s)/RS resource index(es) and the candidate (or actual) candidate/new beam RS(s)/RS resource(s)/RS resource index(es) as specified/defined herein in the present disclosure could be in separate lists/sets of RSs or RS resources or RS resource indexes, e.g., provided or indicated or configured by the network via/by higher layer RRC signaling(s)/parameter(s) and/or MAC CE command(s) and/or dynamic DCI based L1 signaling(s) based on or according to a corresponding UE's capability or capability signaling.

The candidate or actual candidate/new beam RS(s) or RS resource(s) or RS resource (configuration) index(es) configured, determined or identified according to examples as disclosed in the present disclosure could comprise one or more CSI-RS resources, CSI-RS resource configurations and/or CSI-RS resource configuration indexes that could be QCL'ed (e.g., with QCL-TypeD) with a same SSB/SSB index or different/separate SSBs with different/separate SSB indexes. When the candidate or actual candidate/new beam RSs or RS resources or RS resource (configuration) indexes or RS indexes—comprising one or more CSI-RS resources, CSI-RS resource configurations and/or CSI-RS resource configuration indexes—are QCL'ed (e.g., with QCL-TypeD) with different SSBs having different SSB indexes.

In one example (configuration A), the bitwidth of a CSI-RS resource (configuration) index could be determined or provided or configured according to a/the total number of the candidate/actual candidate/new beam RSs/RS resources/RS resource indexes—and therefore the total number of the corresponding one or more CSI-RS resources/CSI-RS resource configurations/CSI-RS resource configuration indexes; denote by the total number as N_{csirs}, the bitwidth could be determined or provided or configured as ┌log₂N_{csirs}┘ bit(s). For this example, for a CSI-RS, CSI-RS resource, CSI-RS resource configuration or CSI-RS resource configuration index as a candidate/actual candidate/new beam RS/RS resource/RS resource index, the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, information related to an SSB that could be QCL'ed (e.g., of QCL-TypeD) with the CSI-RS, CSI-RS resource, CSI-RS resource configuration or CSI-RS resource configuration index. For instance, the higher layer RRC signaling(s)/parameter(s) could correspond to or could be the higher layer RRC parameter(s) that configures or provides the corresponding CSI-RS, CSI-RS resource, CSI-RS resource configuration, CSI-RS resource configuration index, TCI state and/or etc. The higher layer RRC signaling(s)/parameter(s) could additionally be or could additionally correspond to CSI-ReportConfig, CSI-ResourceConfig, UEI-ReportConfig and/or UEI-ResourceConfig that provides or configures the corresponding UEI (beam) reporting. Furthermore, the information related to an SSB could be or could correspond to or comprise the SSB index provided by SSB-Index or index of the SSB among all the configured/provided/determined/identified SSBs that could be QCL'ed (e.g., of QCL-TypeD) with all the candidate/actual candidate/new beam RSs/RS resources/RS resource indexes as specified/defined herein in the present disclosure. The UE could be additionally indicated or provided or configured by the network, e.g., via/by RRC signaling(s)/parameter(s) and/or MAC CE command(s) and/or dynamic DCI based L1 signaling(s) based on or according to a corresponding UE's capability or capability signaling, a/the total number of candidate/actual candidate/new beam RSs/RS resources/RS resource indexes—and therefore the total number of the corresponding one or more CSI-RS resources/CSI-RS resource configurations/CSI-RS resource configuration indexes—that are QCL'ed (e.g., of QCL-TypeD) with each of the SSBs that could be QCL'ed (e.g., of QCL-TypeD) with all the candidate/actual candidate/new beam RSs/RS resources/RS resource indexes as specified/defined herein in the present disclosure; note that the total number here could be identical or common for all the SSBs or for each of the SSBs.

In another example (configuration-B), for a CSI-RS resource or CSI-RS resource configuration or CSI-RS QCL'ed (e.g., of QCL-TypeD) with an SSB, the bitwidth of the CSI-RS resource (configuration) index could be determined or provided or configured according to a/the total number of the candidate/actual candidate/new beam RSs/RS resources/RS resource indexes—and therefore the total number of the corresponding one or more CSI-RS resources/CSI-RS resource configurations/CSI-RS resource configuration indexes—that could be QCL'ed (e.g., of QCL-TypeD) with the same SSB; for an SSB with (SSB) index #k or the k-th SSB among all the configured/provided/determined/identified SSBs that could be QCL'ed (e.g., of QCL-TypeD) with all the candidate/actual candidate/new beam RSs/RS resources/RS resource indexes as specified/defined herein in the present disclosure, denote by the corresponding total number as N_{csirs,k}, the bitwidth could be determined or provided or configured as ┌log₂N_{csirs,k}┐ bit(s). For this example, for a CSI-RS, CSI-RS resource, CSI-RS resource configuration or CSI-RS resource configuration index as a candidate/actual candidate/new beam RS/RS resource/RS resource index, the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, information related to an SSB that could be QCL'ed (e.g., of QCL-TypeD) with the CSI-RS, CSI-RS resource, CSI-RS resource configuration or CSI-RS resource configuration index. For instance, the higher layer RRC signaling(s)/parameter(s) could correspond to or could be the higher layer RRC parameter(s) that configures or provides the corresponding CSI-RS, CSI-RS resource, CSI-RS resource configuration, CSI-RS resource configuration index, TCI state and/or etc. The higher layer RRC signaling(s)/parameter(s) could additionally be or could additionally correspond to CSI-ReportConfig, CSI-ResourceConfig, UEI-ReportConfig and/or UEI-ResourceConfig that provides or configures the corresponding UEI (beam) reporting. Furthermore, the information related to an SSB could be or could correspond to or comprise the SSB index provided by SSB-Index or index of the SSB among all the configured/provided/determined/identified SSBs that could be QCL'ed (e.g., of QCL-TypeD) with all the candidate/actual candidate/new beam RSs/RS resources/RS resource indexes as specified/defined herein in the present disclosure.

For configuration-A as described in the present disclosure, a/the UEI (beam) report could comprise one or more CRIs each corresponding to a candidate/actual candidate/new beam RS or RS resource or RS resource index—hence the corresponding CSI-RS or CSI-RS resource or CSI-RS resource (configuration) index; in this case, the bitwidth of each of the reported CRIs in the UEI beam report could be ┌log₂N_{csirs}┘ bit(s). For configuration-B as described in the present disclosure, a/the UEI (beam) report could comprise one or more CRIs each corresponding to a candidate/actual candidate/new beam RS or RS resource or RS resource index—hence the corresponding CSI-RS or CSI-RS resource or CSI-RS resource (configuration) index; in this case, the bitwidth of a reported CRI in the UEI beam report could be ┌log₂N_{csirs,k}┐ bit(s) when the reported CRI corresponds to a candidate/actual candidate/new beam RS or RS resource or RS resource index—hence the corresponding CSI-RS or CSI-RS resource or CSI-RS resource (configuration) index—that is QCL'ed (e.g., of QCL-TypeD) with the SSB with (SSB) index #k or the k-th SSB among all the configured/provided/determined/identified SSBs that could be QCL'ed (e.g., of QCL-TypeD) with all the candidate/actual candidate/new beam RSs/RS resources/RS resource indexes as specified/defined herein in the present disclosure; in this case, the (same) UEI (beam) report could also comprise an SSBRI (e.g., SSBRI k)—associated to the reported CRI—corresponding to the SSB with (SSB) index #k or the k-th SSB among all the configured/provided/determined/identified SSBs that could be QCL'ed (e.g., of QCL-TypeD) with all the candidate/actual candidate/new beam RSs/RS resources/RS resource indexes as specified/defined herein in the present disclosure.

Optionally, a/the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, one or more Type-A indicators to indicate whether the candidate or actual candidate/new beam RS(s) or RS resource(s) or RS resource (configuration) index(es) configured, determined or identified according examples in the present disclosure comprising one or more CSI-RS resources, CSI-RS resource configurations and/or CSI-RS resource configuration indexes is QCL'ed (e.g., with QCL-TypeD) with a same SSB/SSB index or different/separate SSBs with different/separate SSB indexes. For example, the higher layer RRC signaling(s)/parameter(s) could be or could correspond to the higher layer RRC parameter(s) that provides or configures the candidate or actual candidate/new beam RS(s) or RS resource(s) or RS resource (configuration) index(es)—i.e., the corresponding CSI-RS, CSI-RS resource, CSI-RS resource configuration or CSI-RS resource (configuration) index in this case—TCI state(s) and/or etc. For another example, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. Furthermore, the one or more Type-A indicators could be or could correspond to a one-bit indicator. In this case, when the Type-A indicator(s), e.g., the one-bit indicator, is present/configured/enabled and/or set to “1” (or “0”) or “enabled” or “on” or “differentSSBs,” the UE could determine or identify that the candidate or actual candidate/new beam RS(s) or RS resource(s) or RS resource (configuration) index(es) configured, determined or identified according to examples in the present disclosure comprising one or more CSI-RS resources, CSI-RS resource configurations and/or CSI-RS resource configuration indexes could be QCL'ed (e.g., with QCL-TypeD) with different/separate SSBs with different/separate SSB indexes; otherwise, i.e., when the Type-A indicator(s), e.g., the one-bit indicator, is absent/not present or configured or enabled, and/or is present/configured/enabled and set to “0” (or “1”) or “disabled” or “off” or “sameSSB,” the UE could determine or identify that the candidate or actual candidate/new beam RS(s) or RS resource(s) or RS resource (configuration) index(es) configured, determined or identified according to examples in the present disclosure comprising one or more CSI-RS resources, CSI-RS resource configurations and/or CSI-RS resource configuration indexes could be QCL'ed (e.g., with QCL-TypeD) with a same SSB/SSB index.

In the present disclosure, a current serving beam RS/RS index/RS resource/RS resource index could be determined according to or as the RS(s), RS resource(s) or RS resource index(es)—e.g., CSI-RS(s), CSI-RS resource(s) or CSI-RS resource configuration index(es) including TRS(s)—provided in an indicated TCI state (e.g., according to or following examples disclosed in the present disclosure), and/or determined according to or as the SSB(s) or SSB index(es) that could be QCL'ed (e.g., of QCL-TypeD) with the RS(s), RS resource(s) or RS resource index(es)—e.g., CSI-RS(s), CSI-RS resource(s) or CSI-RS resource configuration index(es) including TRS(s)—provided in an indicated TCI state (e.g., examples disclosed in the present disclosure), and/or according to or as the CSI-RS(s), CSI-RS resource(s) or CSI-RS resource configuration index(es) including TRS(s) provided/configured in the set s̅₀ (e.g., examples disclosed in the present disclosure), and/or according to or as the SSB(s) or SSB index(es) provided/configured in the set s̅₀ (e.g., examples disclosed in the present disclosure). The UE could be configured or indicated or provided by the network, e.g., via higher layer RRC signalling(s)/parameter(s) and/or MAC CE command(s) and/or dynamic DCI based L1 signaling(s) based on or according to a corresponding UE's capability or capability signalling, one or more Type-B indicators to indicate whether a/the UE could determine or identify a current serving beam RS/RS index/RS resource/RS resource index according to or as (1) a CSI-RS, CSI-RS resource or CSI-RS resource configuration index including TRS, e.g., examples disclosed in the present disclosure, and/or (2) an SSB or SSB index, e.g., examples disclosed in the present disclosure.

Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-B indicators could be or could correspond to a one-bit indicator or a multi-bit (e.g., 2-bit) indicator.

In one example, a/the UE could (always) determine or identify a first current serving beam RS/RS index/RS resource/RS resource index according to or as a CSI-RS, CSI-RS resource or CSI-RS resource configuration index including TRS, e.g., examples disclosed in the present disclosure, as a/the baseline or default setting. For this example, the UE could be configured or indicated or provided or instructed or informed by the network, e.g., via higher layer RRC signalling(s)/parameter(s) and/or MAC CE command(s) and/or dynamic DCI based L1 signaling(s) based on or according to a corresponding UE's capability or capability signalling, one or more Type-C indicators to indicate to the UE whether the UE may determine or identify an additional current serving beam RS/RS index/RS resource/RS resource index—denoted by a second current serving beam RS/RS index/RS resource/RS resource index—according to or as an SSB or SSB index, e.g., examples disclosed in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-C indicators could be or could correspond to a one-bit indicator or a multi-bit (e.g., 2-bit) indicator as shown in following examples.

In one example, regardless of whether the Type-C indicator(s) is present (or absent) or configured (or not configured) or provided (or not provided) or enabled (or disabled or not enabled) or set (or not set) to valid (or invalid) value(s) including “0” or “1” or “00” or “01” or “10” or “11” or “on” or “off” or “enabled” or “disabled” or “default” in the corresponding higher layer RRC signaling(s)/parameter(s) and/or MAC CE command(s) and/or dynamic DCI based L1 signaling(s), and/or when the Type-C indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-C indicator(s), a/the UE could (always) determine or identify a/the first current serving beam RS/RS index/RS resource/RS resource index according to or as a CSI-RS, CSI-RS resource or CSI-RS resource configuration index including TRS, e.g., examples disclosed in the present disclosure.

In another example, when the Type-C indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “1” (or “0”) or “01” (or “00” or “10” or “11”) or “on” (or “off”) or “enabled” (or “disabled”) in the corresponding higher layer RRC signaling(s)/parameter(s) and/or MAC CE command(s) and/or dynamic DCI based L1 signaling(s), and/or when the UE determines or identifies that the candidate/actual candidate/new beam RS(s)/RS resource(s)/RS resource index(es) as defined/specified herein in the present disclosure is according to or as SSB(s) or SSB index(es), e.g., examples disclosed in the present disclosure (specifically, for examples disclosed in the present disclosure, the set s̅₁ of SSBs/SSB indexes as defined/specified herein in the present disclosure is provided or configured or indicated by the network), the UE is expected to or the UE could determine or identify a/the additional second current serving beam RS/RS index/RS resource/RS resource index according to or as an SSB or SSB index, e.g., examples disclosed in the present disclosure.

In yet another example, when the Type-C indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “1” (or “0”) or “01” (or “00” or “10” or “11”) or “on” (or “off”) or “enabled” (or “disabled”) in the corresponding higher layer RRC signaling(s)/parameter(s) and/or MAC CE command(s) and/or dynamic DCI based L1 signaling(s), and/or when a/the second threshold Th_ssb as defined/specified herein in the present disclosure is provided or configured or indicated by the network. e.g., examples disclosed in the present disclosure, the UE is expected to or the UE could determine or identify a/the additional second current serving beam RS/RS index/RS resource/RS resource index according to or as an SSB or SSB index, e.g., examples disclosed in the present disclosure.

In yet another example, when the Type-C indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “1” (or “0”) or “01” (or “00” or “10” or “11”) or “on” (or “off”) or “enabled” (or “disabled”) in the corresponding higher layer RRC signaling(s)/parameter(s) and/or MAC CE command(s) and/or dynamic DCI based L1 signaling(s), and/or when the one or more RSs/RS resources/RS resource indexes provided in/by the indicated TCI state (e.g., of QCL-TypeD)—e.g., examples disclosed in the present disclosure—correspond to CSI-RS(s) for tracking or tracking reference signal(s)—e.g., CSI-RS(s) configured with trs-Info, the UE is expected to or the UE could determine or identify a/the additional second current serving beam RS/RS index/RS resource/RS resource index according to or as an SSB or SSB index, e.g., examples disclosed in the present disclosure.

In yet another example, when the Type-C indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s), the UE is not expected to or the UE would not determine or identify a/the additional second current serving beam RS/RS index/RS resource/RS resource index according to or as an SSB or SSB index, e.g., examples disclosed in the present disclosure.

In yet another example, when the Type-C indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s), the UE is expected to or the UE could determine or identify a/the additional second current serving beam RS/RS index/RS resource/RS resource index according to or as an SSB or SSB index, e.g., examples disclosed in the present disclosure.

That is, a/the UE could (always) determine or identify a/the first current serving beam RS/RS index/RS resource/RS resource index according to or as a CSI-RS, CSI-RS resource or CSI-RS resource configuration index including TRS, e.g., examples disclosed in the present disclosure, and whether or not a/the UE could determine or identify a/the second current serving beam RS/RS index/RS resource/RS resource index—in addition to the first current serving beam RS/RS index/RS resource/RS resource index as specified/defined herein in the present disclosure—according to or as an SSB or SSB index, e.g., examples disclosed in the present disclosure could be based on network's configuration(s)/indication(s) according to a corresponding UE's capability or capability signaling. In this case, following examples may be provided.

In one example, when the Type-C indicator(s) as specified/defined herein in the present disclosure is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only CRI(s) and the associated/corresponding beam metric(s) including L1-RSRP(s)/L1-SINR(s).

In another example, otherwise, i.e., when the Type-C indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising: (i) Format-A: only CRI(s) and the corresponding beam metric(s) including L1-RSRP(s)/L1-SINR(s); (ii) Format-B: only SSBRI(s) and the corresponding beam metric(s) including L1-RSRP(s)/L1-SINR(s); and (iii) Format-C: a mixture of both CRI(s) and SSBRI(s) and their corresponding beam metric(s) including L1-RSRP(s)/L1-SINR(s).

Optionally, the UE could indicate to the network, e.g., via one or more indicators provided by/in part of the UEI beam report, which one or more of the Format-A, Format-B and Format-C as disclosed in the present disclosure the UE has applied or used to construct the corresponding UEI beam report(s). For example, the one or more indicators could be or could correspond to a one-bit indicator: when the one-bit indicator is set to “0” (or “1”), it could indicate that the Format-A (or the Format-C) is used by the UE, and when the one-bit indicator is set to “0” (or “1”), it could indicate that the Format-B (or the Format-C) is used by the UE. For another example, the one or more indicators could be or could correspond to a 2-bit indicator: when the 2-bit indicator is set to “00” (or “01” or “10” or “11”), it could indicate that the Format-A is used by the UE, when the 2-bit indicator is set to “01” (or “00” or “10” or “11”), it could indicate that the Format-B is used, and when the 2-bit indicator is set to “10” or “11” (or “00” or “01”), it could indicate that the Format-C is used.

In another example, a/the UE could (always) determine or identify a first current serving beam RS/RS index/RS resource/RS resource index according to or as according to or as an SSB or SSB index, e.g., examples disclosed in the present disclosure, as a/the baseline or default setting. For this example, the UE could be configured or indicated or provided or instructed or informed by the network, e.g., via higher layer RRC signalling(s)/parameter(s) and/or MAC CE command(s) and/or dynamic DCI based L1 signaling(s) based on or according to a corresponding UE's capability or capability signalling, one or more Type-D indicators to indicate to the UE whether the UE may determine or identify an additional current serving beam RS/RS index/RS resource/RS resource index—denoted by a second current serving beam RS/RS index/RS resource/RS resource index—according to or as a CSI-RS, CSI-RS resource or CSI-RS resource configuration index including TRS, e.g., examples disclosed in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-D indicators could be or could correspond to a one-bit indicator or a multi-bit (e.g., 2-bit) indicator. In such embodiments, following examples may be provided.

In one example, regardless of whether the Type-D indicator(s) is present (or absent) or configured (or not configured) or provided (or not provided) or enabled (or disabled or not enabled) or set (or not set) to valid (or invalid) value(s) including “0” or “1” or “00” or “01” or “10” or “11” or “on” or “off” or “enabled” or “disabled” or “default” in the corresponding higher layer RRC signaling(s)/parameter(s) and/or MAC CE command(s) and/or dynamic DCI based L1 signaling(s), and/or when the Type-D indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-D indicator(s), a/the UE could (always) determine or identify a/the first current serving beam RS/RS index/RS resource/RS resource index according to or as according to or as an SSB or SSB index, e.g., examples disclosed in the present disclosure.

In another example, when the Type-D indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “1” (or “0”) or “01” (or “00” or “10” or “11”) or “on” (or “off”) or “enabled” (or “disabled”) in the corresponding higher layer RRC signaling(s)/parameter(s) and/or MAC CE command(s) and/or dynamic DCI based L1 signaling(s), and/or when the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., examples disclosed in the present disclosure (specifically, for examples disclosed in the present disclosure, the set s̅₁ of (periodic) CSI-RS resource configuration indexes as defined/specified herein in the present disclosure is provided or configured or indicated by the networker), the UE is expected to or the UE could determine or identify a/the additional second current serving beam RS/RS index/RS resource/RS resource index according to or as a CSI-RS, CSI-RS resource or CSI-RS resource configuration index including TRS, e.g., examples disclosed in the present disclosure.

In yet another example, when the Type-D indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “1” (or “0”) or “01” (or “00” or “10” or “11”) or “on” (or “off”) or “enabled” (or “disabled”) in the corresponding higher layer RRC signaling(s)/parameter(s) and/or MAC CE command(s) and/or dynamic DCI based L1 signaling(s), and/or when a/the first threshold Th_csirs as defined/specified herein in the present disclosure is provided or configured or indicated by the network e.g., examples disclosed in the present disclosure, the UE is expected to or the UE could determine or identify a/the additional second current serving beam RS/RS index/RS resource/RS resource index according to or as a CSI-RS, CSI-RS resource or CSI-RS resource configuration index including TRS, e.g., examples disclosed in the present disclosure.

In yet another example, when the Type-D indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “1” (or “0”) or “01” (or “00” or “10” or “11”) or “on” (or “off”) or “enabled” (or “disabled”) in the corresponding higher layer RRC signaling(s)/parameter(s) and/or MAC CE command(s) and/or dynamic DCI based L1 signaling(s), and/or when the one or more RSs/RS resources/RS resource indexes provided in/by the indicated TCI state (e.g., of QCL-TypeD)—e.g., examples disclosed in the present disclosure—correspond to CSI-RS(s) for beam management—e.g., CSI-RS(s) configured with repetition or with repetition set to “on,” the UE is expected to or the UE could determine or identify a/the additional second current serving beam RS/RS index/RS resource/RS resource index according to or as a CSI-RS, CSI-RS resource or CSI-RS resource configuration index including TRS, e.g., examples disclosed in the present disclosure.

In yet another example, when the Type-D indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s), the UE is not expected to or the UE would not determine or identify a/the additional second current serving beam RS/RS index/RS resource/RS resource index according to or as a CSI-RS, CSI-RS resource or CSI-RS resource configuration index including TRS, e.g., examples disclosed in the present disclosure.

In yet another example, when the Type-D indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s), the UE is expected to or the UE could determine or identify a/the additional second current serving beam RS/RS index/RS resource/RS resource index according to or as a CSI-RS, CSI-RS resource or CSI-RS resource configuration index including TRS, e.g., examples disclosed in the present disclosure.

That is, a/the UE could (always) determine or identify a/the first current serving beam RS/RS index/RS resource/RS resource index according to or as an SSB or SSB index, e.g., examples disclosed in the present disclosure, and whether or not a/the UE could determine or identify a/the second current serving beam RS/RS index/RS resource/RS resource index—in addition to the first current serving beam RS/RS index/RS resource/RS resource index as specified/defined herein in the present disclosure—according to or as a CSI-RS, CSI-RS resource or CSI-RS resource configuration index including TRS, e.g., examples disclosed in the present disclosure could be based on network's configuration(s)/indication(s) according to a corresponding UE's capability or capability signaling. In such cases, following examples may be provided.

In one example, when the Type-D indicator(s) as specified/defined herein in the present disclosure is not present or absent or not configured or not provided or not enabled or disabled or set to invalid value(s) or not set to valid value(s) including “0” or “1” or “00” or “01” or “10” or “11” or “on” or “off” or “enabled” or “disabled” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only SSBRI(s) and the associated/corresponding beam metric(s) including L1-RSRP(s)/L1-SINR(s).

In another example, otherwise, i.e., when the Type-D indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising: (i) Format-A: only CRI(s) and the corresponding beam metric(s) including L1-RSRP(s)/L1-SINR(s); (ii) Format-B: only SSBRI(s) and the corresponding beam metric(s) including L1-RSRP(s)/L1-SINR(s); and (iii) Format-C: a mixture of both CRI(s) and SSBRI(s) and their corresponding beam metric(s) including L1-RSRP(s)/L1-SINR(s).

Optionally, the UE could indicate to the network, e.g., via one or more indicators provided by/in part of the UEI beam report, which one or more of the Format-A, Format-B and Format-C as disclosed in the present disclosure the UE has applied or used to construct the corresponding UEI beam report(s). For example, the one or more indicators could be or could correspond to a one-bit indicator: when the one-bit indicator is set to “0” (or “1”), it could indicate that the Format-A (or the Format-C) is used by the UE, and when the one-bit indicator is set to “0” (or “1”), it could indicate that the Format-B (or the Format-C) is used by the UE. For another example, the one or more indicators could be or could correspond to a 2-bit indicator: when the 2-bit indicator is set to “00” (or “01” or “10” or “11”), it could indicate that the Format-A is used by the UE, when the 2-bit indicator is set to “01” (or “00” or “10” or “11”), it could indicate that the Format-B is used, and when the 2-bit indicator is set to “10” or “11” (or “00” or “01”), it could indicate that the Format-C is used.

In another example, a/the UE could (always) determine or identify a first current serving beam RS/RS index/RS resource/RS resource index according to or as a CSI-RS, CSI-RS resource or CSI-RS resource configuration index including TRS, e.g., examples disclosed in the present disclosure, and a second current serving beam RS/RS index/RS resource/RS resource index according to or as according to or as an SSB or SSB index, e.g., examples disclosed in the present disclosure, as a/the baseline or default setting.

For this example, the UE could be configured or indicated or provided or instructed or informed by the network, e.g., via higher layer RRC signalling(s)/parameter(s) and/or MAC CE command(s) and/or dynamic DCI based L1 signaling(s) based on or according to a corresponding UE's capability or capability signalling, one or more Type-E indicators to indicate to the UE whether the UE may determine or identify the current serving beam RS/RS index/RS resource/RS resource index according to or as (i) the first current serving beam RS/RS index/RS resource/RS resource index—according to or as a CSI-RS, CSI-RS resource or CSI-RS resource configuration index including TRS, e.g., examples disclosed in the present disclosure, or (ii) the second current serving beam RS/RS index/RS resource/RS resource index—according to or as according to or as an SSB or SSB index, e.g., examples disclosed in the present disclosure; i.e., the Type-E indicator(s) here could indicate to the UE not to determine or identify one of or to determine or identify the current serving beam RS/RS index/RS resource/RS resource index not according to or as one of (i) the first current serving beam RS/RS index/RS resource/RS resource index—according to or as a CSI-RS, CSI-RS resource or CSI-RS resource configuration index including TRS, e.g., examples disclosed in the present disclosure and (ii) the second current serving beam RS/RS index/RS resource/RS resource index—according to or as according to or as an SSB or SSB index, e.g., examples disclosed in the present disclosure.

Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-E indicators could be or could correspond to a one-bit indicator or a multi-bit (e.g., 2-bit) indicator. For such cases, following examples may be provided.

In one example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s), the UE would determine or identify two current serving beam RSs/RS indexes/RS resources/RS resource indexes respectively corresponding to the first current serving beam RS/RS index/RS resource/RS resource index according to or as a CSI-RS, CSI-RS resource or CSI-RS resource configuration index including TRS, e.g., examples disclosed in the present disclosure, and the second current serving beam RS/RS index/RS resource/RS resource index according to or as according to or as an SSB or SSB index, e.g., examples disclosed in the present disclosure.

In another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “1” (or “0”) or “01” (or “00” or “10” or “11”) or “on” (or “off”) or “enabled” (or “disabled”) or “csirsAsCurrentBeam” in the corresponding higher layer RRC signaling(s)/parameter(s) and/or MAC CE command(s) and/or dynamic DCI based L1 signaling(s), and/or when the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., examples disclosed in the present disclosure (specifically, for examples disclosed in the present disclosure, the set s̅₁ of (periodic) CSI-RS resource configuration indexes as defined/specified herein in the present disclosure is provided or configured or indicated by the networker), the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., examples disclosed in the present disclosure; i.e., the UE would not determine or identify any SSB(s) or SSB index(es), e.g., examples disclosed in the present disclosure, as a current serving beam RS/RS index/RS resource/RS resource index.

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” (or “on”) or “disabled” (or “enabled”) or “ssbAsCurrentBeam” in the corresponding higher layer RRC signaling(s)/parameter(s) and/or MAC CE command(s) and/or dynamic DCI based L1 signaling(s), when the UE determines or identifies that the candidate/actual candidate/new beam RS(s)/RS resource(s)/RS resource index(es) as defined/specified herein in the present disclosure is according to or as SSB(s) or SSB index(es), e.g., examples disclosed in the present disclosure (specifically, for examples disclosed in the present disclosure, the set s̅₁ of SSBs/SSB indexes as defined/specified herein in the present disclosure is provided or configured or indicated by the network), the UE is expected to or the UE could (only) determine or identify the current serving beam RS/RS index/RS resource/RS resource index as a/the second current serving beam RS/RS index/RS resource/RS resource index according to or as an SSB or SSB index, e.g., examples disclosed in the present disclosure; i.e., UE would not determine or identify any CSI-RS(s), CSI-RS resource(s) or CSI-RS resource configuration index(es) including TRS(s), e.g., examples disclosed in the present disclosure, as a current serving beam RS/RS index/RS resource/RS resource index.

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “1” (or “0”) or “01” (or “00” or “10” or “11”) or “on” (or “off”) or “enabled” (or “disabled”) or “csirsAsCurrentBeam” in the corresponding higher layer RRC signaling(s)/parameter(s) and/or MAC CE command(s) and/or dynamic DCI based L1 signaling(s), and/or when a/the second threshold Th_ssb as defined/specified herein in the present disclosure is provided or configured or indicated by the network, e.g., examples disclosed in the present disclosure, the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., examples disclosed in the present disclosure, the UE would not determine or identify any SSB(s) or SSB index(es), e.g., examples disclosed in the present disclosure, as a current serving beam RS/RS index/RS resource/RS resource index.

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” (or “on”) or “disabled” (or “enabled”) or “ssbAsCurrentBeam” in the corresponding higher layer RRC signaling(s)/parameter(s) and/or MAC CE command(s) and/or dynamic DCI based L1 signaling(s), when the second threshold Th_ssb as defined/specified herein in the present disclosure is provided or configured or indicated by the network according to examples disclosed in the present disclosure, the UE is expected to or the UE could (only) determine or identify the current serving beam RS/RS index/RS resource/RS resource index as a/the second current serving beam RS/RS index/RS resource/RS resource index according to or as an SSB or SSB index, e.g., examples disclosed in the present disclosure; i.e., UE would not determine or identify any CSI-RS(s), CSI-RS resource(s) or CSI-RS resource configuration index(es) including TRS(s), e.g., examples disclosed in the present disclosure, as a current serving beam RS/RS index/RS resource/RS resource index.

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “1” (or “0”) or “01” (or “00” or “10” or “11”) or “on” (or “off”) or “enabled” (or “disabled”) or “csirsAsCurrentBeam” in the corresponding higher layer RRC signaling(s)/parameter(s) and/or MAC CE command(s) and/or dynamic DCI based L1 signaling(s), and/or when the one or more RSs/RS resources/RS resource indexes provided in/by the indicated TCI state (e.g., of QCL-TypeD)—e.g., as examples disclosed in the present disclosure—correspond to CSI-RS(s) for beam management—e.g., CSI-RS(s) configured with repetition or with repetition set to “on,” the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., examples disclosed in the present disclosure; i.e., the UE would not determine or identify any SSB(s) or SSB index(es), e.g., examples disclosed in the present disclosure, as a current serving beam RS/RS index/RS resource/RS resource index.

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” (or “on”) or “disabled” (or “enabled”) or “ssbAsCurrentBeam” in the corresponding higher layer RRC signaling(s)/parameter(s) and/or MAC CE command(s) and/or dynamic DCI based L1 signaling(s), and/or when the one or more RSs/RS resources/RS resource indexes provided in/by the indicated TCI state (e.g., of QCL-TypeD)—e.g., examples disclosed in the present disclosure—correspond to CSI-RS(s) for tracking or tracking reference signal(s)—e.g., CSI-RS(s) configured with trs-Info, the UE is expected to or the UE could (only) determine or identify the current serving beam RS/RS index/RS resource/RS resource index as a/the second current serving beam RS/RS index/RS resource/RS resource index according to or as an SSB or SSB index, e.g., examples disclosed in the present disclosure; i.e., UE would not determine or identify any CSI-RS(s), CSI-RS resource(s) or CSI-RS resource configuration index(es) including TRS(s), e.g., examples disclosed in the present disclosure, as a current serving beam RS/RS index/RS resource/RS resource index.

In yet another example, when the Type-E indicator(s) is present or configured or provided or enabled or set to valid value(s) including “1” (or “0”) or “01” (or “00” or “10” or “11”) or “on” (or “off”) or “enabled” (or “disabled”) or “csirsAsCurrentBeam” in the corresponding higher layer RRC signaling(s)/parameter(s) and/or MAC CE command(s) and/or dynamic DCI based L1 signaling(s), the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., examples disclosed in the present disclosure; i.e., the UE would not determine or identify any SSB(s) or SSB index(es), e.g., examples disclosed in the present disclosure, as a current serving beam RS/RS index/RS resource/RS resource index.

In yet another example, when the Type-E indicator(s) is present or configured or provided or enabled or set to valid value(s) including “0” (or “1”) or “00” (or “01” or “10” or “11”) or “off” (or “on”) or “disabled” (or “enabled”) or “ssbAsCurrentBeam” in the corresponding higher layer RRC signaling(s)/parameter(s) and/or MAC CE command(s) and/or dynamic DCI based L1 signaling(s), the UE is expected to or the UE could (only) determine or identify the current serving beam RS/RS index/RS resource/RS resource index as a/the second current serving beam RS/RS index/RS resource/RS resource index according to or as an SSB or SSB index, e.g., examples disclosed in the present disclosure; i.e., UE would not determine or identify any CSI-RS(s), CSI-RS resource(s) or CSI-RS resource configuration index(es) including TRS(s), e.g., examples disclosed in the present disclosure, as a current serving beam RS/RS index/RS resource/RS resource index.

That is, by default, a/the UE could (always) determine or identify a first current serving beam RS/RS index/RS resource/RS resource index according to or as a CSI-RS, CSI-RS resource or CSI-RS resource configuration index including TRS, e.g., examples disclosed in the present disclosure, and a second current serving beam RS/RS index/RS resource/RS resource index according to or as according to or as an SSB or SSB index, e.g., examples disclosed in the present disclosure, and whether or not a/the UE could (only) determine or identify the current serving beam RS/RS index/RS resource/RS resource index as (i) a/the first current serving beam RS/RS index/RS resource/RS resource index according to or as a CSI-RS, CSI-RS resource or CSI-RS resource configuration index including TRS, e.g., examples disclosed in the present disclosure, or (ii) a/the second current serving beam RS/RS index/RS resource/RS resource index according to or as an SSB or SSB index, e.g., examples disclosed in the present disclosure could be based on network's configuration(s)/indication(s) according to a corresponding UE's capability or capability signaling. In this case, following examples may be provided.

In one example, when the Type-E indicator(s) as specified/defined herein in the present disclosure is present or configured or provided or enabled or set to valid value(s) including “1” (or “0”) or “01” (or “00” or “10” or “11”) or “on” (or “off”) or “enabled” (or “disabled”) or “csirsAsCurrentBeam” in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only CRI(s) and the associated/corresponding beam metric(s) including L1-RSRP(s)/L1-SINR(s).

In another example, when the Type-E indicator(s) as specified/defined herein in the present disclosure is present or configured or provided or enabled or set to valid value(s) including “0” (or “1”) or “00” (or “01” or “10” or “11”) or “off” (or “on”) or “disabled” (or “enabled”) or “ssbAsCurrentBeam” in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only SSBRI(s) and the associated/corresponding beam metric(s) including L1-RSRP(s)/L1-SINR(s).

In yet another example, otherwise, i.e., when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising: (i) Format-A: only CRI(s) and the corresponding beam metric(s) including L1-RSRP(s)/L1-SINR(s); (ii) Format-B: only SSBRI(s) and the corresponding beam metric(s) including L1-RSRP(s)/L1-SINR(s); and (iii) Format-C: a mixture of both CRI(s) and SSBRI(s) and their corresponding beam metric(s) including L1-RSRP(s)/L1-SINR(s).

Optionally, the UE could indicate to the network, e.g., via one or more indicators provided by/in part of the UEI beam report, which one or more of the Format-A, Format-B and Format-C as disclosed in the present disclosure the UE has applied or used to construct the corresponding UEI beam report(s). For example, the one or more indicators could be or could correspond to a one-bit indicator: when the one-bit indicator is set to “0” (or “1”), it could indicate that the Format-A (or the Format-C) is used by the UE, and when the one-bit indicator is set to “0” (or “1”), it could indicate that the Format-B (or the Format-C) is used by the UE. For another example, the one or more indicators could be or could correspond to a 2-bit indicator: when the 2-bit indicator is set to “00” (or “01” or “10” or “11”), it could indicate that the Format-A is used by the UE, when the 2-bit indicator is set to “01” (or “00” or “10” or “11”), it could indicate that the Format-B is used, and when the 2-bit indicator is set to “10” or “11” (or “00” or “01”), it could indicate that the Format-C is used.

For the report Format-C as disclosed in the present disclosure in the present disclosure, the UE could also indicate or transmit or send to the network, e.g., by/in part of the (same) UEI beam report, one or more indicators (e.g., a bitmap, one or more 1-bit (flag) indicators, etc.) to indicate which one or more of the CSI field(s) or entries in the UEI beam report is used to carry or convey the SSBRI(s)—and therefore the corresponding beam metric(s) including L1-RSRP(s)/L1-SINR(s), or the CRI(s)—and therefore the corresponding beam metric(s) including L1-RSRP(s)/L1-SINR(s). Optionally, which one or more of the CSI field(s) or entries in the UEI beam report is used to carry or convey the SSBRI(s)—and therefore the corresponding beam metric(s) including L1-RSRP(s)/L1-SINR(s), or the CRI(s)—and therefore the corresponding beam metric(s) including L1-RSRP(s)/L1-SINR(s) could be determined according to fixed rule(s)/ordering(s) provided in the system specification(s) or per RRC (re)configuration.

In one example, a/the UE could determine or identify a current serving beam RS/RS index/RS resource/RS resource index according to or as a (periodic) CSI-RS, CSI-RS resource or CSI-RS resource configuration index including TRS, e.g., examples disclosed in the present disclosure, and/or the UE could determine or identify that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., examples disclosed in the present disclosure, when one or more of the following conditions are achieved or satisfied. In the present disclosure, following examples may be provided.

In one example, the Type-A indicator(s), e.g., the one-bit indicator, as specified/defined herein in the present disclosure is present/configured/enabled and/or set to “1” (or “0”) or “enabled” or “on” or “differentSSBs.”

In another example, the Type-B indicator(s), e.g., a one-bit, two-bit or multi-bit indicator, as specified/defined herein in the present disclosure is present/configured/enabled and/or set to “1” (or “0”) or “00” (or “01,” “10” or “11”) or “enabled” (or “disabled”) or “on” (or “off”) or “csirsAsCurrentBeam.”

In yet another example, the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., examples disclosed in the present disclosure; specifically, for examples disclosed in the present disclosure, the set s̅₁ of (periodic) CSI-RS resource configuration indexes as defined/specified herein in the present disclosure is provided or configured or indicated by the network. In such case, following examples may be provided.

In one example, the set s̅₀ of (periodic) CSI-RS resource configuration indexes as defined/specified herein in the present disclosure is provided or configured or indicated by the network.

In another example, regardless of whether the Type-C indicator(s) is present (or absent) or configured (or not configured) or provided (or not provided) or enabled (or disabled or not enabled) or set (or not set) to valid (or invalid) value(s) including “0” or “1” or “00” or “01” or “10” or “11” or “on” or “off” or “enabled” or “disabled” or “default” in the corresponding higher layer RRC signaling(s)/parameter(s) and/or MAC CE command(s) and/or dynamic DCI based L1 signaling(s), and/or when the Type-C indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-C indicator(s).

In yet another example, when the Type-D indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s), the UE could send or transmit to the network.

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s).

In yet another example, when the Type-E indicator(s) is present or configured or provided or enabled or set to valid value(s) including “1” (or “0”) or “01” (or “00” or “10” or “11”) or “on” (or “off”) or “enabled” (or “disabled”) or “csirsAsCurrentBeam” in the corresponding higher layer RRC signaling(s)/parameter(s) and/or MAC CE command(s) and/or dynamic DCI based L1 signaling(s).

In yet another example, when the one or more RSs/RS resources/RS resource indexes provided in/by the indicated TCI state (e.g., of QCL-TypeD)—e.g., examples disclosed in the present disclosure—correspond to CSI-RS(s) for beam management—e.g., CSI-RS(s) configured with repetition or with repetition set to “on.”

In one example, the UE could send or transmit to the network a/the UEI beam report, in a reporting instance, comprising one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a current serving beam RS/RS resource/RS resource index or a candidate/actual new beam RS/RS resource/RS resource index in this example that satisfies the event(s) condition(s) as defined/specified herein in the present disclosure).

In one example, a/the UE could determine or identify a current serving beam RS/RS index/RS resource/RS resource index according to or as an SSB or SSB index, e.g., examples disclosed in the present disclosure, and/or the UE could determine or identify that the candidate/actual candidate/new beam RS(s)/RS resource(s)/RS resource index(es) as defined/specified herein in the present disclosure is according to or as SSB(s) or SSB index(es), e.g., examples disclosed in the present disclosure, when one or more of the following conditions are achieved or satisfied.

In yet another example, the Type-A indicator(s), e.g., the one-bit indicator, as specified/defined herein in the present disclosure is absent/not present or configured or enabled, and/or is present/configured/enabled and set to “0” (or “1”) or “disabled” or “off” or “sameSSB.”

In yet another example, the Type-B indicator(s), e.g., a one-bit, two-bit or multi-bit indicator, as specified/defined herein in the present disclosure is present/configured/enabled and/or set to “0” (or “1”) or “01” (or “00,” “10” or “11”) or “disabled” (or “enabled”) or “off” (or “on”) or “ssbAsCurrentBeam.”

In yet another example, the UE determines or identifies that the candidate/actual candidate/new beam RS(s)/RS resource(s)/RS resource index(es) as defined/specified herein in the present disclosure is according to or as SSB(s) or SSB index(es), e.g., examples disclosed in the present disclosure; specifically, for examples disclosed in the present disclosure, the set s̅₁ of SSBs/SSB indexes as defined/specified herein in the present disclosure is provided or configured or indicated by the network.

In yet another example, the set s̅₀ of SSBs/SSB indexes as defined/specified herein in the present disclosure is provided or configured or indicated by the network.

In yet another example, when the Type-C indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s).

In yet another example, regardless of whether the Type-D indicator(s) is present (or absent) or configured (or not configured) or provided (or not provided) or enabled (or disabled or not enabled) or set (or not set) to valid (or invalid) value(s) including “0” or “1” or “00” or “01” or “10” or “11” or “on” or “off” or “enabled” or “disabled” or “default” in the corresponding higher layer RRC signaling(s)/parameter(s) and/or MAC CE command(s) and/or dynamic DCI based L1 signaling(s).

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s).

In yet another example, when the Type-E indicator(s) is present or configured or provided or enabled or set to valid value(s) including “0” (or “1”) or “00” (or “01” or “10” or “11”) or “off” (or “on”) or “disabled” (or “enabled”) or “ssbAsCurrentBeam” in the corresponding higher layer RRC signaling(s)/parameter(s) and/or MAC CE command(s) and/or dynamic DCI based L1 signaling(s).

In yet another example, when the one or more RSs/RS resources/RS resource indexes provided in/by the indicated TCI state (e.g., of QCL-TypeD)—e.g., examples disclosed in the present disclosure—correspond to CSI-RS(s) for tracking or tracking reference signal(s)—e.g., CSI-RS(s) configured with trs-Info.

For this example, the UE could send or transmit to the network a/the UEI beam report, in a reporting instance, comprising one or more SSBRIs—and therefore, the corresponding beam metric(s) including L1-RSRP(s)/L1-SINR(s)—each corresponding to an SSB/SSB index (as a current serving beam RS/RS resource/RS resource index or a candidate/actual new beam RS/RS resource/RS resource index in this example that satisfies the event(s) condition(s) as defined/specified herein in the present disclosure).

In one example, a/the UE could determine or identify a first current serving beam RS/RS index/RS resource/RS resource index according to or as an SSB or SSB index, e.g., examples disclosed in the present disclosure, and/or a second current serving beam RS/RS index/RS resource/RS resource index according to or as a (periodic) CSI-RS, CSI-RS resource or CSI-RS resource configuration index including TRS, e.g., examples disclosed in the present disclosure, and/or the UE could determine or identify that one or more of the candidate/actual candidate/new beam RS(s)/RS resource(s)/RS resource index(es) as defined/specified herein in the present disclosure is according to or as SSB(s) or SSB index(es), e.g., examples disclosed in the present disclosure, and/or the UE could determine or identify that one or more of the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., examples disclosed in the present disclosure, when one or more of the following conditions are achieved or satisfied.

In one example, the Type-A indicator(s), e.g., the one-bit indicator, as specified/defined herein in the present disclosure is absent/not present or configured or enabled, and/or is present/configured/enabled and set to “0” (or “1”) or “disabled” or “off” or “sameSSB.”

In another example, the Type-A indicator(s), e.g., the one-bit indicator, as specified/defined herein in the present disclosure is present/configured/enabled and/or set to “1” (or “0”) or “enabled” or “on” or “differentSSBs.”

In yet another example, the Type-B indicator(s), e.g., a one-bit, two-bit or multi-bit indicator, as specified/defined herein in the present disclosure is present/configured/enabled and/or set to “0” (or “1”) or “01” (or “00,” “10” or “11”) or “disabled” (or “enabled”) or “off” (or “on”) or “ssbAsCurrentBeam.”

In yet another example, the Type-B indicator(s), e.g., a one-bit, two-bit or multi-bit indicator, as specified/defined herein in the present disclosure is present/configured/enabled and/or set to “1” (or “0”) or “00” (or “01,” “10” or “11”) or “enabled” (or “disabled”) or “on” (or “off”) or “csirsAsCurrentBeam.”

In yet another example, the Type-B indicator(s), e.g., a one-bit, two-bit or multi-bit indicator, as specified/defined herein in the present disclosure is absent/not present or configured or enabled, and/or is present/configured/enabled and/or set to “10” or “11” (or “00” or “01”) or “bothSSBAndCsirsAsCurrentBeam.”

In yet another example, the UE determines or identifies that one or more of the candidate/actual candidate/new beam RS(s)/RS resource(s)/RS resource index(es) as defined/specified herein in the present disclosure is according to or as SSB(s) or SSB index(es), e.g., examples disclosed in the present disclosure; specifically, for examples disclosed in the present disclosure, the set s̅₁ of SSBs/SSB indexes as defined/specified herein in the present disclosure is provided or configured or indicated by the network.

In yet another example, the UE determines or identifies that one or more of the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., examples disclosed in the present disclosure; specifically, for examples disclosed in the present disclosure, the set s̅₁ of (periodic) CSI-RS resource configuration indexes as defined/specified herein in the present disclosure is provided or configured or indicated by the network.

In yet another example, a set s̅₀ of SSBs/SSB indexes as defined/specified herein in the present disclosure is provided or configured or indicated by the network.

In yet another example, a set s̅₀ of (periodic) CSI-RS resource configuration indexes as defined/specified herein in the present disclosure is provided or configured or indicated by the network.

In yet another example, when the Type-C indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s).

In yet another example, when the Type-D indicator(s) is present or configured or provided or enabled or set to valid value(s) including “1” (or “0”) or “01” (or “00” or “10” or “11”) or “on” or “enabled” in the corresponding higher layer RRC signaling(s)/parameter(s) and/or MAC CE command(s) and/or dynamic DCI based L1 signaling(s), the UE could send or transmit to the network.

In yet another example, when the Type-E indicator(s) is not present or absent or not configured or not provided or not enabled or disabled or set to invalid value(s) or not set to valid value(s) including “0” or “1” or “00” or “01” or “10” or “11” or “on” or “off” or “enabled” or “disabled” or “csirsAsCurrentBeam” or “ssbAsCurrentBeam” or “default” or set to valid value(s) including “0” (or “1”) or “00” (or “01” or “10” or “11”) or “off” or “disabled” or “default” in the corresponding higher layer RRC signaling(s)/parameter(s) and/or MAC CE command(s) and/or dynamic DCI based L1 signaling(s).

In yet another example, when the one or more RSs/RS resources/RS resource indexes provided in/by the indicated TCI state (e.g., of QCL-TypeD)—e.g., examples disclosed in the present disclosure—correspond to CSI-RS(s) for beam management—e.g., CSI-RS(s) configured with repetition or with repetition set to “on.”

In yet another example, when the one or more RSs/RS resources/RS resource indexes provided in/by the indicated TCI state (e.g., of QCL-TypeD)—e.g., examples disclosed in the present disclosure—correspond to CSI-RS(s) for tracking or tracking reference signal(s)—e.g., CSI-RS(s) configured with trs-Info.

In one example, the UE could send or transmit to the network, in a reporting instance, a/the UEI beam report that could comprise: (i) one or more SSBRIs—and therefore, the corresponding beam metric(s) including L1-RSRP(s)/L1-SINR(s)—each corresponding to an SSB/SSB index (as a first current serving beam RS/RS resource/RS resource index or a candidate/actual new beam RS/RS resource/RS resource index in this example that satisfies the event(s) condition(s) as defined/specified herein in the present disclosure), and/or (ii) one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a second current serving beam RS/RS resource/RS resource index or a candidate/actual new beam RS/RS resource/RS resource index in this example that satisfies the event(s) condition(s) as defined/specified herein in the present disclosure), according to or based on (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). Optionally, for this example, the UE could send or transmit to the network, in a first reporting instance, a/the first UEI beam report comprising one or more SSBRIs—and therefore, the corresponding beam metric(s) including L1-RSRP(s)/L1-SINR(s)—each corresponding to an SSB/SSB index (as a first current serving beam RS/RS resource/RS resource index or a candidate/actual new beam RS/RS resource/RS resource index in this example that satisfies the event(s) condition(s) as defined/specified herein in the present disclosure).

Furthermore, the UE could send or transmit to the network, in a second reporting instance, a/the second UEI beam report comprising one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a second current serving beam RS/RS resource/RS resource index or a candidate/actual new beam RS/RS resource/RS resource index in this example that satisfies the event(s) condition(s) as defined/specified herein in the present disclosure). In this example, whether the UE could transmit or send to the network a single UEI beam report (in a single reporting instance) that could comprise resource indicator(s) corresponding to CRI(s) and/or SSBRI(s) or separate UEI beam reports (in separate reporting instances) that could separately comprise resource indicators corresponding to CRI(s) and SSBRI(s) could be based on or according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In the present disclosure, a CSI-RS or a CSI-RS resource or a CSI-RS resource configuration could correspond to or could be referred to as a CSI-RS for beam management (e.g., a CSI-RS configured with repetition or with repetition set to “on”), a CSI-RS for tracking or tracking reference signal (TRS)—e.g., a CSI-RS configured with trs-Info, a CSI-RS configured without repetition or with repetition set to “off,” and etc.

In the present disclosure (e.g., the fourth event), a/the UE could be respectively configured or provided or indicated by the network, e.g., via higher layer RRC signaling(s)/parameter(s) and/or MAC CE command(s) and/or dynamic DCI based L1 signaling(s) based on or according to a corresponding UE's capability or capability signaling, different (or separate) thresholds or different (or separate) values of a threshold (e.g., threshold-C as defined/specified in the fourth event) for different (or separate) cases of (1) when a current serving beam RS/RS resource/RS resource index is (determined, identified or configured as) a CSI-RS/CSI-RS resource/CSI-RS resource (configuration) index and/or the candidate/actual candidate/new beam RS(s)/RS resource(s)/RS resource index(es) is (determined, identified or configured as) CSI-RS(s)/CSI-RS resource(s)/CSI-RS resource (configuration) index(es) according to examples in the present disclosure, and (2) when a current serving beam RS/RS resource/RS resource index is (determined, identified or configured as) an SSB or SSB index and/or the candidate/actual candidate/new beam RS(s)/RS resource(s)/RS resource index(es) is (determined, identified or configured as) SSB(s) or SSB index(es) according to examples in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting.

For the fourth event as specified/defined herein in the present disclosure, following examples may be provided.

In one example, when a (second) current serving beam RS/RS resource/RS resource index is (determined, identified or configured as) a CSI-RS/CSI-RS resource/CSI-RS resource (configuration) index and/or the candidate/actual candidate/new beam RS(s)/RS resource(s)/RS resource index(es) is (determined, identified or configured as) CSI-RS(s)/CSI-RS resource(s)/CSI-RS resource (configuration) index(es) according to examples in the present disclosure, the UE could be configured by the network a first threshold provided by Th_csirs; in this case, the UE could use or apply Th_csirs as the threshold-C as defined/specified herein in the present disclosure for comparing the radio link/beam qualities between current serving beam RS(s)/RS resource(s)/RS resource index(es) and candidate/actual candidate/new beam RS(s)/RS resource(s)/RS resource(s) when they both correspond to CSI-RSs/CSI-RS resources/CSI-RS resource configuration indexes as defined/specified herein in the present disclosure; more specifically, the UE could assess or evaluate whether the radio link or beam quality(s)—e.g., by measuring the L1-RSRP(s)/L1-SINR(s)—of one or more (or at least one) CSI-RSs/CSI-RS resources/CSI-RS resource configurations (as the candidate/actual candidate/new beam RS(s)/RS resource(s) in this example) is beyond or greater than the radio link or beam quality(s)—e.g., by measuring the L1-RSRP(s)/L1-SINR(s)—of one or more CSI-RSs/CSI-RS resources/CSI-RS resource configurations (as the current serving beam RS(s)/RS resource(s) in this example) by Th_csirs.

In another example, when a (first) current serving beam RS/RS resource/RS resource index is (determined, identified or configured as) an SSB/SSB index and/or the candidate/actual candidate/new beam RS(s)/RS resource(s)/RS resource index(es) is (determined, identified or configured as) SSB(s)/SSB index(es) according to examples in the present disclosure, the UE could be configured by the network a second threshold provided by Th_ssb; in this case, the UE could use or apply Th_ssb as the threshold-C as defined/specified herein in the present disclosure for comparing the radio link/beam qualities between current serving beam RS(s)/RS resource(s)/RS resource index(es) and candidate/actual candidate/new beam RS(s)/RS resource(s)/RS resource(s) when they both correspond to SSBs/SSB indexes as defined/specified herein in the present disclosure; more specifically, the UE could assess or evaluate whether the radio link or beam quality(s)—e.g., by measuring the L1-RSRP(s)/L1-SINR(s)—of one or more (or at least one) SSBs (as the candidate/actual candidate/new beam RS(s)/RS resource(s) in this example) is beyond or greater than the radio link or beam quality(s)—e.g., by measuring the L1-RSRP(s)/L1-SINR(s)—of one or more SSBs (as the current serving beam RS(s)/RS resource(s) in this example) by Th_ssb.

Here, the values of Th_csirs and Th_ssb could be (or could be configured to be) the same. Alternatively, or optionally, the values of Th_csirs and Th_ssb could be (or could be configured to be) different. In addition, the Th_csirs and Th_ssb could be configured or provided to the UE at the same time or simultaneously (e.g., in a/the same higher layer RRC signaling/parameter), or separately (e.g., in separate higher layer RRC signalings/parameters).

In one example, the threshold Th_csirs could be present and the threshold Th_ssb could be absent; for this case, the UE could assume or expect that Th_ssb=Th_csirs.

In another example, the threshold Th_csirs could be present and the threshold Th_ssb could be absent; for this case, the UE could be further configured or provided by the network, e.g., via the corresponding higher layer RRC signaling(s)/parameter(s) and/or MAC CE command(s) and/or dynamic DCI based L1 signaling(s), an offset value of Th_offset. For this example, the UE could assume or expect that Th_ssb=Th_csirs+Th_offset.

In another example, the threshold Th_csirs could be absent and the threshold Th_ssb could be present; for this case, the UE could assume or expect that Th_csirs=Th_ssb.

In another example, the threshold Th_csirs could be absent and the threshold Th_ssb could be present; for this case, the UE could be further configured or provided by the network, e.g., via the corresponding higher layer RRC signaling(s)/parameter(s) and/or MAC CE command(s) and/or dynamic DCI based L1 signaling(s), an offset value of Th_offset. For this example, the UE could assume or expect that Th_csirs=Th_ssh±Th_offset.

In another example, both the thresholds Th_csirs and Th_ssb are present.

In another example, both the thresholds Th_csirs and Th_ssb are present. For this case, the UE could still be further configured or provided by the network, e.g., via the corresponding higher layer RRC signaling(s)/parameter(s) and/or MAC CE command(s) and/or dynamic DCI based L1 signaling(s), an offset value of Th_offset. For this example, the UE could assume or expect that Th_csirs=Th_ssb+Th_offset and/or Th_ssh=Th_csirs±Th_offset.

In another example, neither of the thresholds Th_csirs and Th_ssb is present.

In the present disclosure, a parameter being present is equivalent to being configured, provided or enabled in the corresponding higher layer RRC signaling(s)/parameter(s) and/or MAC CE command(s) and/or dynamic DCI based L1 signaling(s), and/or a parameter being absent (or not present) is equivalent to not being configured, provided or enabled or being disabled in the corresponding higher layer RRC signaling(s)/parameter(s) and/or MAC CE command(s) and/or dynamic DCI based L1 signaling(s).

A UE could indicate or send or transmit to the network, e.g., as/by/in part of their capability signaling, whether or not they can support (1) a CSI-RS, CSI-RS resource or CSI-RS resource configuration index including TRS as a current serving beam RS/RS resource/RS resource index, e.g., examples disclosed in the present disclosure, and/or (2) an SSB or an SSB index as a current serving beam RS/RS resource/RS resource index, e.g., examples disclosed in the present disclosure. For instance, a/the UE could indicate or send or transmit to the network a capability or capability signaling indicating the type of the RS that they can support as a current serving beam RS/RS resource, wherein the capability or capability signaling could comprise one or more of the following components: (i) {CSI-RS}; (ii) {SSB}; (iii) {Both CSI-RS and SSB}; and/or (iv) {CSI-RS, SSB}.

A UE could indicate or send or transmit to the network, e.g., as/by/in part of their capability signaling, whether or not they can support (1) a CSI-RS, CSI-RS resource or CSI-RS resource configuration index including TRS as a candidate/new beam RS/RS resource/RS resource index, e.g., examples disclosed in the present disclosure, and/or (2) an SSB or an SSB index as a candidate/new beam RS/RS resource/RS resource index, e.g., examples disclosed in the present disclosure. For instance, a/the UE could indicate or send or transmit to the network a capability or capability signaling indicating the type of the RS that they can support as a candidate/new beam RS/RS resource, wherein the capability or capability signaling could comprise one or more of the following components: (i) {CSI-RS}; (ii) {SSB}; (iii) {Both CSI-RS and SSB}; and/or (iv) {CSI-RS, SSB}.

In the present disclosure, the current serving beam RS(s)/RS resource(s)/RS resource index(es) can be extended or equally applied to the candidate/actual candidate/new beam RS(s)/RS resource(s)/RS resource index(es) according to examples in the present disclosure.

In one embodiment, a report format(s) for UEI reporting is provided.

In one embodiment, the UE could be configured or provided or indicated by the network, e.g., via higher layer RRC signaling(s)/parameter(s) and/or MAC CE command(s) and/or dynamic DCI based L1 signaling(s) based on or according to a corresponding first UE's capability or capability signaling, a minimum number/value (denoted by N_min) of beam(s) and/or a minimum number/value (denoted by N_min) of report content(s)/quantity(s) for one or more beams as specified/defined herein in the present disclosure which may be reported in a UEI beam report or a reporting instance for a UEI beam report and/or a value M_min (as defined below). For instance, the higher layer RRC signaling(s)/parameter(s) could comprise a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure. Furthermore, the first UE's capability or capability signaling could indicate or comprise their support of a minimum number/value (denoted by N_min) of beam(s) and/or a minimum number/value (denoted by N_min) of report content(s)/quantity(s) for one or more beams as specified/defined herein in the present disclosure that may be reported in a UEI beam report or a reporting instance for a UEI beam report and/or a value M_min.

Furthermore, the UE could also be configured or provided or indicated by the network, e.g., via higher layer RRC signaling(s)/parameter(s) and/or MAC CE command(s) and/or dynamic DCI based L1 signaling(s) based on or according to a corresponding second UE's capability or capability signaling, a maximum number/value (denoted by N_max) of beam(s) and/or a maximum number/value (denoted by N_max) of report content(s)/quantity(s) for one or more beams as specified/defined herein in the present disclosure that may be reported in a UEI beam report or a reporting instance for a UEI beam report. For instance, the higher layer RRC signaling(s)/parameter(s) could comprise a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure.

Furthermore, the second UE's capability or capability signaling could indicate or comprise their support of a maximum number/value (denoted by N_max) of beam(s) and/or a maximum number/value (denoted by N_max) of report content(s)/quantity(s) for one or more beams as specified/defined herein in the present disclosure which may be reported in a UEI beam report or a reporting instance for a UEI beam report. Additionally, the UE could also be configured or provided or indicated by the network, e.g., via higher layer RRC signaling(s)/parameter(s) and/or MAC CE command(s) and/or dynamic DCI based L1 signaling(s) based on or according to a corresponding third UE's capability or capability signaling, a number/value (denoted by N_config) of beam(s) and/or a number/value (denoted by N_config) of report content(s)/quantity(s) for one or more beams as specified/defined herein in the present disclosure which may be reported in a UEI beam report or a reporting instance for a UEI beam report.

For instance, the higher layer RRC signaling(s)/parameter(s) could comprise a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure. Furthermore, the third UE's capability or capability signaling could indicate or comprise their support of a number/value (denoted by N_config) of beam(s) and/or a number/value (denoted by N_config) of report content(s)/quantity(s) for one or more beams as specified/defined herein in the present disclosure which may be reported in a UEI beam report or a reporting instance for a UEI beam report. Optionally, the UE could indicate to the network, e.g., via the PN message/trigger or in part of/by the CSI/beam report and/or in part of/by the UEI beam report and/or a fourth UE's capability signaling, a number/value (denoted by N_ue) of beam(s) and/or a number/value (denoted by N_ue) of report content(s)/quantity(s) for one or more beams as specified/defined herein in the present disclosure which may be reported in a UEI beam report or a reporting instance for a UEI beam report. The first, second, third and/or fourth UE's capabilities or capability signalings could correspond or belong to a common UE's capability or capability signaling and/or different components of a common UE's capability or capability signaling; optionally, the first, second, third and/or fourth UE's capabilities or capability signalings could correspond or belong to separate UE's capabilities or capability signalings.

Example value(s) of N_min, M_min (as defined below), N_max, N_config and/or N_ue could be one or more of {1, 2, 3, 4, 5, 6, 7, 8, 9, 10, 11, 12, 13, 14, 15, 16}, and supporting each of the values {1, 2, 3, 4, 5, 6, 7, 8, 9, 10, 11, 12, 13, 14, 15, 16} could be or could correspond to a (same/separate) UE's capability or capability signaling. One or more of the value(s) of N_min, M_min (defined below), N_max, N_config and/or N_ue could be or could correspond to fixed value(s) in system specifications.

In one example (case A), for one or more given events or one or more given events detection, when the number of the determined or identified first beam(s)—denoted by N_beam—that satisfy the event(s) condition(s) and/or the number of report content(s)/quantity(s) of the determined or identified first beam(s)—denoted by N_beam—that satisfy the event(s) condition(s) as specified/defined herein in the present disclosure is less than or equal to N_min (i.e., N_beam≤N_min), the UE could send or transmit to the network a UEI report that comprises the N_beam determined or identified first beam(s) and/or the N_beam report content(s)/quantity(s) as specified/define herein in the present disclosure of the determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam+M_beam=N_min, i.e., the UE could transmit or send to the network a UEI beam report comprising a number N_min of beam(s) or a number N_min report content(s)/quantity(s) including SSBRI(s)/CRI(s) and/or L1-RSRP(s)/L1-SINR(s) of one or more beams as specified/defined herein in the present disclosure. In addition, N_min could be greater than or equal to M_min.

In another example (case B), for one or more given events or one or more given events detection, when the number of the determined or identified first beam(s)—denoted by N_beam—that satisfy the event(s) condition(s) and/or the number of report content(s)/quantity(s) of the determined or identified first beam(s)—denoted by N_beam—that satisfy the event(s) condition(s) as specified/defined herein in the present disclosure is less than or equal to N_min (i.e., N_beam≤N_min), the UE could send or transmit to the network a UEI report that comprises the N_beam determined or identified first beam(s) and/or the N_beam report content(s)/quantity(s) as specified/defined herein in the present disclosure of the determined or identified first beam(s). In addition, N_min could be greater than or equal to M_min.

In another example (case C), for one or more given events or one or more given events detection, when the number of the determined or identified first beam(s)—denoted by N_beam—that satisfy the event(s) condition(s) and/or the number of report content(s)/quantity(s) of the determined or identified first beam(s)—denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises the N_beam determined or identified first beam(s) and/or the N_beam report content(s)/quantity(s) of the determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam+M_beam could be less than or equal to N_max, N_config and/or N_ue, i.e., the UE could transmit or send to the network a UEI report comprising a number (N_beam+M_beam) or N_max or N_config or N_ue of beam(s) or a number (N_beam+M_beam) or N_max or N_config or N_ue report content(s)/quantity(s) including SSBRI(s)/CRI(s) and/or L1-RSRP(s)/L1-SINR(s) of one or more beams as specified/defined herein in the present disclosure.

In addition, N_min could be greater than or equal to M_min. For example, for one or more given events or one or more given events detection, when the number of the determined or identified first beam(s)—denoted by N_beam—that satisfy the event(s) condition(s) and/or the number of report content(s)/quantity(s) of the determined or identified first beam(s)—denoted by N_beam—that satisfy the event(s) condition(s) as specified/defined herein in the present disclosure is less than or equal to N_config (i.e., N_beam≤N_config), the UE could send or transmit to the network a UEI report that comprises the N_beam determined or identified first beam(s) and/or the N_beam report content(s)/quantity(s) of the determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam+M_beam could be equal to N_config (N_config=N_beam+M_beam), i.e., the UE could transmit or send to the network a UEI report comprising a number (N_beam+M_beam) or N_config of beam(s) or a number (N_beam+M_beam) or N_config report content(s)/quantity(s) including SSBRI(s)/CRI(s) and/or L1-RSRP(s)/L1-SINR(s) of one or more beams as specified/defined herein in the present disclosure.

For this example, the candidate value(s) of N_config could be {N_config_min, N_config_min+1, . . . , N_config_max}, wherein the value(s) of N_config_min and/or N_config_max could be determined according to or based on: (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, N_config_min could be greater than 1, i.e., N_config_min>1; furthermore, the value of N_config_max could be 4 or 8. As discussed, described or specified herein in the present disclosure, the UE could send or transmit to the network a capability or capability signaling to indicate whether the UE is capable of supporting N_config_min and/or N_config_max; for instance, the capability or capability signaling could comprise one or more of the following components: (i) {N_config_min}; (ii) {N_config_max}; and/or (iii) {N_config_min, N_config_max}.

In addition, when a UE sends or transmits to the network the capability or capability signaling indicating that the UE is capable of supporting N_config_min, the UE could also indicate to the network, e.g., by/in part of the capability or capability signaling, their supported candidate value(s)/component(s) of N_config_min, e.g., N_config_min∈{1, 2, . . . } or N_config_min∈{1, 2, . . . , N_config_max} or N_config_min∈{2, . . . } or N_config_min∈{2, . . . , N_config_max}. When a UE sends or transmits to the network the capability or capability signaling indicating that the UE is capable of supporting N_config_max, the UE could also indicate to the network, e.g., by/in part of the capability or capability signaling, their supported candidate value(s)/component(s) of N_config_max, e.g., N_config_max∈{1, 2, 3, 4} or N_config_max∈{2, 3, 4} or N_config_max∈{4, 5, 6, 7, 8} or N_config_max∈{1, 2, 3, 4, 5, 6, 7, 8} or N_config_max∈{2, 3, 4, 5, 6, 7, 8}. In this case, when a/the UE is not configured/provided by the network any (valid) value(s) of N_config, and/or N_config is absent or not present or disabled or not enabled/configured/provided or set to invalid value(s), e.g., 0, in the corresponding higher layer RRC signaling(s)/parameter(s) including CSI-ReportConfig, CSI-ResourceConfig, UEI-ReportConfig and/or UEI-ResourceConfig that provides or configures information related to the corresponding UEI beam reporting, the UE could assume N_config=N_default (e.g., N_default=1 or N_default=N_config_min or N_default=N_config_max or N_default=N_config_min−1) to identify or determine the number of beam(s) and/or the corresponding report content(s)/quantity(s)—and therefore, the corresponding report format(s) as discussed/specified herein in this case—to report or transmit or send in/by the UEI beam report; in this case, the UE could send or transmit to the network a/the UEI beam report comprising N_default first and/or second beam(s) and/or the report content(s)/quantity(s) of N_default first and/or second beam(s) as defined/specified herein in the present disclosure: one special case—the UE could send or transmit to the network a/the UEI beam report comprising a single N_config=1 (or N_default=1 or N_beam=1) first beam and/or the report content(s)/quantity(s) of a single N_config=1 (or N_default=1 or N_beam=1) first beam that satisfies the event(s) condition(s); the value(s) of N_default could be determined according to or based on: (i) fixed value(s)/rule(s) in system specification(s)—e.g., N_default=1 or N_default=N_config_min or N_default=N_config_max or N_default=N_config_min−1, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

In another example (case D), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises the N_beam determined or identified first beam(s) and/or the N_beam report content(s)/quantity(s) as specified/defined herein in the present disclosure of the determined or identified first beam(s). In addition, N_min could be greater than or equal to M_min.

In another example (case E), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is less than or equal to N_min (i.e., N_beam≤N_min), the UE could send or transmit to the network a UEI report that comprises one or more of the N_beam determined or identified first beam(s)—denoted by N_beam′, e.g., with the highest beam metric(s) including L1-RSRP(s)/L1-SINR(s) among all the N_beam determined or identified first beam(s), and/or one or more of the N_beam report content(s)/quantity(s) as specified/define herein in the present disclosure of the determined or identified first beam(s)—denoted by N_beam′, e.g., with the highest beam metric(s) including L1-RSRP(s)/L1-SINR(s) among all the N_beam determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam′+M_beam=N_min, i.e., the UE could transmit or send to the network a UEI beam report comprising a number N_min of beam(s) or a number N_min report content(s)/quantity(s) including SSBRI(s)/CRI(s) and/or L1-RSRP(s)/L1-SINR(s) of one or more beams as specified/defined herein in the present disclosure. In addition, N_min could be greater than or equal to M_min.

In another example (case F), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises one or more of the N_beam determined or identified first beam(s)-denoted by N_beam′, e.g., with the highest beam metric(s) including L1-RSRP(s)/L1-SINR(s) among all the N_beam determined or identified first beam(s), and/or one or more of the N_beam report content(s)/quantity(s) as specified/define herein in the present disclosure of the determined or identified first beam(s)—denoted by N_beam′, e.g., with the highest beam metric(s) including L1-RSRP(s)/L1-SINR(s) among all the N_beam determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam′+M_beam could be less than or equal to N_max, N_config and/or N_ue, i.e., the UE could transmit or send to the network a UEI report comprising a number (N_beam′+M_beam) or N_max of beam(s) or a number (N_beam′+M_beam) or N_max report content(s)/quantity(s) including SSBRI(s)/CRI(s) and/or L1-RSRP(s)/L1-SINR(s) of one or more beams as specified/defined herein in the present disclosure. In addition, N_min could be greater than or equal to M_min.

In another example (case G), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is greater than or equal to N_max, N_config and/or N_ue (i.e., N_beam≥N_max and/or N_beam≥N_config and/or N_beam≥N_ue), where N_max, N_config and/or N_ue are defined/specified herein in the present disclosure, the UE could send or transmit to the network a UEI (beam) report comprising K_beam≥1 determined or identified first beam(s), and/or report content(s)/quantity(s) corresponding/associated/specific to K_beam≥1 determined or identified first beam(s), and/or K_beam≥1 report content(s)/quantity(s) as specified/defined herein in the present disclosure corresponding/associated/specific to one or more of the determined or identified first beam(s), wherein K_beam could be or could correspond to N_max and/or N_config and/or N_ue. For example, the reported K_beam determined or identified first beam(s)—or the corresponding/associated report content(s)/quantity(s)—could be associated with or could have, include, provide, comprise or contain the K_beam highest beam metric(s) including L1-RSRP(s)/L1-SINR(s) among all the N_beam determined or identified first beam(s)—or the corresponding/associated report content(s)/quantity(s), wherein K_beam≤N_beam, and K_beam=N_max and/or K_beam=N_config and/or K_beam=N_ue according to those specified herein in the present disclosure. For another example, the reported K_beam report content(s)/quantity(s) corresponding/associated/specific to one or more of the determined or identified first beam(s) could be associated with or could have, include, provide, comprise or contain the K_beam highest beam metric(s) including L1-RSRP(s)/L1-SINR(s) among all the N_beam report content(s)/quantity(s) corresponding/associated/specific to the determined or identified first beam(s) as defined/specified herein in the present disclosure, wherein K_beam≤N_beam, and K_beam=N_max and/or K_beam=N_config and/or K_beam=N_ue according to those specified herein in the present disclosure. For another example, which K_beam determined or identified first beam(s), and therefore, the corresponding/associated report content(s)/quantity(s), out of all the N_beam determined or identified first beam(s), and therefore, the corresponding/associated report content(s)/quantity(s)—i.e., K_beam≤N_beam, and K_beam=N_max and/or K_beam=N_config and/or K_beam=N_ue according to those specified herein in the present disclosure, and/or which K_beam report content(s)/quantity(s) corresponding/associated/specific to one or more of the determined or identified first beam(s) out of all the N_beam report content(s)/quantity(s) corresponding/associated/specific to the determined or identified first beam(s) as defined/specified herein in the present disclosure—i.e., K_beam≤N_beam, and K_beam=N_max and/or K_beam=N_config and/or K_beam=N_ue according to those specified herein in the present disclosure, could be determined according to (i) fixed value(s)/rule(s) in system specification(s) and/or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination or decision, which could be further sent to the network via various UL channels/signals including PUCCH(s), PUSCH(s), MAC CE(s), PRACH(s), CSI/beam report(s) and/or UE's capability signaling(s).

In another example (case H), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises the N_beam determined or identified first beam(s) and/or the N_beam report content(s)/quantity(s) as specified/defined herein in the present disclosure of the determined or identified first beam(s). Furthermore, a/the UEI beam report could have a fixed payload size, e.g., a fixed total number of CSI fields. In this case, the UE could first identify or determine one or more first CSI fields to convey, contain, provide, comprise, include or carry the N_beam determined or identified first beam(s) and/or the N_beam report content(s)/quantity(s) as specified/defined herein in the present disclosure of the determined or identified first beam(s). As N_beam≤N_max, and/or N_beam≤N_config and/or N_beam≤N_ue, the remaining or rest of the CSI field(s) other than the first CSI field(s) in the UEI beam report could be padded/filled with zero(s), or set to reserved (“R”) or special (“S”) value(s), or convey, contain, provide, comprise, include or carry one or more of the N_beam determined or identified first beam(s) and/or one or more of the N_beam report content(s)/quantity(s) as specified/defined herein in the present disclosure of the determined or identified first beam(s) as (or in form of) repetition(s), according to or following those specified/discussed herein in the present disclosure.

In another example (case I), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises one or more of or a subset of the N_beam determined or identified first beam(s) and/or one or more of or a subset of the N_beam report content(s)/quantity(s) as specified/defined herein in the present disclosure of the determined or identified first beam(s). In this case, the subset could contain, provide, indicate, comprise, include or comprise N_min first beam(s) and/or N_min report content(s)/quantity(s) as specified/defined herein in the present disclosure of one or more of the determined or identified first beam(s)—e.g., out of all the N_beam determined or identified first beam(s) and/or N_beam report content(s)/quantity(s) as specified/defined herein in the present disclosure of the determined or identified first beam(s). The subset selection could be based on or according to those specified/described herein in the present disclosure. Furthermore, a/the UEI beam report could have a fixed payload size, e.g., a fixed total number of CSI fields. In this case, the UE could first identify or determine one or more first CSI fields to convey, contain, provide, comprise, include or carry the N_min first beam(s) and/or the N_min report content(s)/quantity(s) as specified/defined herein in the present disclosure of one or more of the determined or identified first beam(s). As N_min≤N_max, and/or N_min≤N_config and/or N_min≤N_ue, the remaining or rest of the CSI field(s) other than the first CSI field(s) in the UEI beam report could be padded/filled with zero(s), or set to reserved (“R”) or special (“S”) value(s), or convey, contain, provide, comprise, include or carry one or more of the N_min first beam(s) and/or one or more of the N_min report content(s)/quantity(s) as specified/defined herein in the present disclosure of one or more of the determined or identified first beam(s) as (or in form of) repetition(s), according to or following those specified/discussed herein in the present disclosure.

In another example (case J), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is greater than or equal to N_max, N_config and/or N_ue (i.e., N_beam≥N_max and/or N_beam≥N_config and/or N≥_beam N_ue), where N_max, N_config and/or N_ue are defined/specified herein in the present disclosure, the UE could send or transmit to the network a UEI report that comprises one or more of or a subset of the N_beam determined or identified first beam(s) and/or one or more of or a subset of the N_beam report content(s)/quantity(s) as specified/defined herein in the present disclosure of the determined or identified first beam(s). In this case, the subset could contain, provide, indicate, comprise, include or comprise N_max or N_config or N_ue first beam(s) and/or N_max or N_config or N_ue report content(s)/quantity(s) as specified/defined herein in the present disclosure of one or more of the determined or identified first beam(s)—e.g., out of all the N_beam determined or identified first beam(s) and/or N_beam report content(s)/quantity(s) as specified/defined herein in the present disclosure of the determined or identified first beam(s). The subset selection could be based on or according to those specified/described herein in the present disclosure.

In another example (case K), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is less than or equal to N_min (i.e., N_beam≤N_min), the UE could send or transmit to the network a UEI report that comprises the N_beam determined or identified first beam(s) and/or the N_beam report content(s)/quantity(s) as specified/defined herein in the present disclosure of the determined or identified first beam(s) and a number (N_min−N_beam) second beam(s) that may not satisfy the event(s) condition(s) as defined/specified herein in the present disclosure and/or a number (N_min−N_beam) report content(s)/quantity(s) as specified/defined herein in the present disclosure of one or more second beams that may not satisfy the event(s) condition(s) as defined/specified herein in the present disclosure. That is, a/the UEI report in this case could comprise a total of N_min first/second beam(s) and/or a total of N_min report content(s)/quantity(s) as specified/defined herein in the present disclosure of the first/second beam(s). Furthermore, a/the UEI beam report could have a fixed payload size, e.g., a fixed total number of CSI fields. In this case, the UE could first identify or determine one or more first CSI fields to convey, contain, provide, comprise, include or carry the N_beam determined or identified first beam(s) and/or the N_beam report content(s)/quantity(s) as specified/defined herein in the present disclosure of the determined or identified first beam(s) and the (N_min−N_beam) second beam(s) that may not satisfy the event(s) condition(s) as defined/specified herein in the present disclosure and/or the (N_min−N_beam) report content(s)/quantity(s) as specified/defined herein in the present disclosure of one or more second beams that may not satisfy the event(s) condition(s) as defined/specified herein in the present disclosure. As N_min≤N_max, and/or N_min≤N_config and/or N_min≤N_ue, the remaining or rest of the CSI field(s) other than the first CSI field(s) in the UEI beam report could be padded/filled with zero(s), or set to reserved (“R”) or special (“S”) value(s), or convey, contain, provide, comprise, include or carry one or more of the N_min first/second beam(s) and/or one or more of the N_min report content(s)/quantity(s) as specified/defined herein in the present disclosure of the first/second beam(s) as (or in form of) repetition(s), according to or following those specified/discussed herein in the present disclosure.

In another example (case L), for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is less than or equal to N_min (i.e., N_beam≤N_min), the UE could send or transmit to the network a UEI report that comprises the N_beam determined or identified first beam(s) and/or the N_beam report content(s)/quantity(s) as specified/defined herein in the present disclosure of the determined or identified first beam(s) and a number M_min second beam(s) that may not satisfy the event(s) condition(s) as defined/specified herein in the present disclosure and/or a number M_min report content(s)/quantity(s) as specified/defined herein in the present disclosure of one or more second beams that may not satisfy the event(s) condition(s) as defined/specified herein in the present disclosure. That is, a/the UEI report in this case could comprises a total of (N_beam+M_min) first/second beam(s) and/or a total of (N_beam+M_min) report content(s)/quantity(s) as specified/defined herein in the present disclosure of the first/second beam(s), wherein (N_beam+M_min) could be greater than or equal to N_min. Furthermore, a/the UEI beam report could have a fixed payload size, e.g., a fixed total number of CSI fields. In this case, the UE could first identify or determine one or more first CSI fields to convey, contain, provide, comprise, include or carry the N_beam determined or identified first beam(s) and/or the N_beam report content(s)/quantity(s) as specified/defined herein in the present disclosure of the determined or identified first beam(s) and the M_min second beam(s) that may not satisfy the event(s) condition(s) as defined/specified herein in the present disclosure and/or the M_min report content(s)/quantity(s) as specified/defined herein in the present disclosure of one or more second beams that may not satisfy the event(s) condition(s) as defined/specified herein in the present disclosure. As (N_beam+M_min) N_max, and/or (N_beam+M_min) N_config and/or (N_beam+M_min) N_ue, the remaining or rest of the CSI field(s) other than the first CSI field(s) in the UEI beam report could be padded/filled with zero(s), or set to reserved (“R”) or special (“S”) value(s), or convey, contain, provide, comprise, include or carry one or more of the (N_beam+M_min) first/second beam(s) and/or one or more of the (N_beam+M_min) report content(s)/quantity(s) as specified/defined herein in the present disclosure of the first/second beam(s) as (or in form of) repetition(s), according to or following those specified/discussed herein in the present disclosure.

A UE could be indicated or provided or configured or enabled by the network, e.g., via higher layer RRC signaling(s)/parameter(s) and/or MAC CE command(s) and/or dynamic DCI based L1 signaling(s) according to or based on a corresponding UE's capability or capability signaling, one or more of case A, case B, case C, case D, case E, case F, case G, case H, case I, case J, case K and case L such that the UE could transmit or send a UEI report comprising report content(s)/quantity(s) following those specified in case A, case B, case C, case D, case E, case F, case G, case H, case I, case J, case K and case L. For instance, a UE could be indicated or provided or configured or enabled by the network, e.g., via/in the higher layer RRC signaling(s)/parameter(s), e.g., of a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure, a higher layer parameter denoted by “ueiReportMode” set to value(s) related to or corresponding to or associated to one or more of “case A,” “case B,” “case C,” “case D,” “case E,” “case F,” “case G,” “case H,” “case I,” “case J,” “case K” and/or “case L.” In one example, when the higher layer parameter “ueiReportMode” is set to value(s) related to or corresponding to or associated to “case A,” the UE could transmit or send a UEI report comprising report content(s)/quantity(s) determined according to those specified in case A.

For another example, when the higher layer parameter “ueiReportMode” is set to value(s) related to or corresponding to or associated to “case A” and “case C,” the UE could transmit or send a UEI report comprising report content(s)/quantity(s) determined according to those specified in case A and case C. The number(s)/value(s) of N_beam (for the first beam(s) that satisfy the corresponding event(s) condition(s) as specified/defined herein in the present disclosure), M_beam (for the second beam(s) that may not satisfy the corresponding event(s) condition(s)), N_beam′ (for a subset of the first beam(s) that satisfy the corresponding event(s) condition(s) as specified/defined herein in the present disclosure), N_beam_min, N_beam_max, M_beam_min and/or M_beam_max could be determined according to: (i) fixed value(s) in system specification(s), (ii) network's configuration(s)/indication(s) via higher layer RRC signaling(s)/parameter(s)—e.g., via/in CSI-ReportConfig and/or CSI-ResourceConfig and/or resource/report setting(s) that provides or configures the corresponding UEI beam report(s)—and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, wherein N_beam_min and N_beam_max could respectively represent the minimum and maximum numbers of first beam(s) that satisfy the corresponding event(s) condition(s) as defined/specified herein in the present disclosure—and therefore the corresponding report content(s)/quantity(s) including SSBRI(s)/CRI(s) and/or L1-RSRP(s)/L1-SINR(s)—that may be allowed to be reported in a/same UEI (beam) report, and M_beam_min and M_beam_max could respectively represent the minimum and maximum numbers of second beam(s) that may not satisfy the corresponding event(s) condition(s) as defined/specified herein in the present disclosure—and therefore the corresponding report content(s)/quantity(s) including SSBRI(s)/CRI(s) and/or L1-RSRP(s)/L1-SINR(s)—that may be allowed to be reported in a/same UEI (beam) report.

In addition, as specified/defined herein in the present disclosure, for one or more given events or one or more given events detection, the UE could first identify or determine N_beam first beam(s) that could satisfy the corresponding event(s) condition(s), and indicate or provide or include or send or transmit a subset of the N_beam first beam(s)—denoted by N_beam′ (N_beam′≤N_beam) first beam(s)—and therefore the corresponding report content(s)/quantity(s) including SSBRI(s)/CRI(s) and/or L1-RSRP(s)/L1-SINR(s) in a/the UEI beam report. In this case, the UE could send or transmit or indicate to the network, e.g., via/in part of a/the (same) UEI report, the value(s) of N_beam′; optionally, the value(s) of N_beam′ could be determined according to: (i) fixed value(s) in system specification(s) and/or per RRC (re)configuration and/or (ii) network's configuration(s)/indication(s) via higher layer RRC signaling(s)/parameter(s)—e.g., via/in CSI-ReportConfig and/or CSI-ResourceConfig and/or resource/report setting(s) that provides or configures the corresponding UEI beam report(s)—and/or MAC CE command(s) and/or dynamic DCI based L1 signaling(s) according to or based on a corresponding UE's capability or capability signaling. The UE could also send or transmit or indicate to the network, e.g., via/in part of the same UEI beam report, which one or more of the N_beam first beams—i.e., the subset of N_beam′ first beam(s) as defined/specified herein in the present disclosure, and therefore the associated/corresponding report content(s)/quantity(s) including SSBRI(s)/CRI(s) and/or L1-RSRP(s)/L1-SINR(s), and/or which one or more of the N_beam report content(s)/quantity(s) including SSBRI(s)/CRI(s) and/or L1-RSRP(s)/L1-SINR(s) corresponding/associated/specific to the first beams according to those specified herein in the present disclosure—i.e., the subset of N_beam′ report content(s)/quantity(s) including SSBRI(s)/CRI(s) and/or L1-RSRP(s)/L1-SINR(s) corresponding/associated/specific to one or more of the first beams according to those specified herein in the present disclosure could be conveyed or provided or indicated or contained or included or comprised or carried by the UEI beam report.

In one example, the UEI beam report could provide, indicate, contain, comprise or include a bitmap with each entry/bit position of the bitmap corresponding/associated to one of the N_beam first beams—and therefore the associated/corresponding report content(s)/quantity(s) including SSBRI(s)/CRI(s) and/or L1-RSRP(s)/L1-SINR(s), and/or one of the N_beam report content(s)/quantity(s) including SSBRI(s)/CRI(s) and/or L1-RSRP(s)/L1-SINR(s) corresponding/associated/specific to the first beams according to those specified herein in the present disclosure. For this example, when a bit position/entry of the bitmap is set to “1” (or “0”), the first beam—out of all the N_beam first beams, and therefore the associated/corresponding report content(s)/quantity(s) including SSBRI(s)/CRI(s) and/or L1-RSRP(s)/L1-SINR(s)—associated/corresponding to the bit position/entry could be conveyed or provided or indicated or contained or included or comprised or carried by/in the UEI beam report, and/or the report content(s)/quantity(s) including SSBRI(s)/CRI(s) and/or L1-RSRP(s)/L1-SINR(s)—out of all the N_beam report content(s)/quantity(s) including SSBRI(s)/CRI(s) and/or L1-RSRP(s)/L1-SINR(s) corresponding/associated/specific to the first beams according to those specified herein in the present disclosure—associated/corresponding to the bit position/entry could be conveyed or provided or indicated or contained or included or comprised or carried by/in the UEI beam report.

In another example, the UEI beam report could provide, indicate, contain, comprise or include one or more (e.g., N_beam) indicators with each indicator corresponding/associated to one of the N_beam first beams—and therefore the associated/corresponding report content(s)/quantity(s) including SSBRI(s)/CRI(s) and/or L1-RSRP(s)/L1-SINR(s), and/or one of the N_beam report content(s)/quantity(s) including SSBRI(s)/CRI(s) and/or L1-RSRP(s)/L1-SINR(s) corresponding/associated/specific to the first beams according to those specified herein in the present disclosure. For this example, when an indicator is set to “1” (or “0”), the first beam—out of all the N_beam first beams, and therefore the associated/corresponding report content(s)/quantity(s) including SSBRI(s)/CRI(s) and/or L1-RSRP(s)/L1-SINR(s)—associated/corresponding to the indicator could be conveyed or provided or indicated or contained or included or comprised or carried by/in the UEI beam report, and/or the report content(s)/quantity(s) including SSBRI(s)/CRI(s) and/or L1-RSRP(s)/L1-SINR(s)—out of all the N_beam report content(s)/quantity(s) including SSBRI(s)/CRI(s) and/or L1-RSRP(s)/L1-SINR(s) corresponding/associated/specific to the first beams according to those specified herein in the present disclosure—associated/corresponding to the indicator could be conveyed or provided or indicated or contained or included or comprised or carried by/in the UEI beam report.

In another example, the UEI beam report could provide, indicate, contain, comprise or include a set of one or more beam indexes, wherein each beam index could correspond/point to or represent one of the N_beam first beams—and therefore the associated/corresponding report content(s)/quantity(s) including SSBRI(s)/CRI(s) and/or L1-RSRP(s)/L1-SINR(s). For this example, the first beam(s)—out of all the N_beam first beams, and therefore the associated/corresponding report content(s)/quantity(s) including SSBRI(s)/CRI(s) and/or L1-RSRP(s)/L1-SINR(s)—that correspond to or that is represented or pointed by the beam index(es) in the set could be conveyed or provided or indicated or contained or included or comprised or carried by/in the UEI beam report.

In another example, the UEI beam report could provide, indicate, contain, comprise or include a set of one or more indexes, wherein each index could correspond to or represent one of the N_beam report content(s)/quantity(s) including SSBRI(s)/CRI(s) and/or L1-RSRP(s)/L1-SINR(s) corresponding/associated/specific to the first beams according to those specified herein in the present disclosure. For this example, the report content(s)/quantity(s) including SSBRI(s)/CRI(s) and/or L1-RSRP(s)/L1-SINR(s)—out of all the N_beam report content(s)/quantity(s) including SSBRI(s)/CRI(s) and/or L1-RSRP(s)/L1-SINR(s) corresponding/associated/specific to the first beams according to those specified herein in the present disclosure—that correspond to or that is presented or pointed by the index(es) in the set could be conveyed or provided or indicated or contained or included or comprised or carried by/in the UEI beam report.

In the present disclosure, the determined or identified first beam(s) could correspond to or could be one or more current serving beams and/or one or more candidate beams as specified/defined herein in the present disclosure. Furthermore, when a UEI beam report comprises one or more first beams (or one or more report contents/quantities for the first beam(s)) and one or more second beams (or one or more report contents/quantities for the second beam(s)) as specified/defined herein in the present disclosure, the UE could indicate to the network, e.g., via/in part of the same UEI beam report, which one or more of the reported beam(s) and/or report quantity(s)/content(s) in/of the UEI beam report could correspond to or could be associated to or for the beam(s)—i.e., the first beam(s)—that satisfies the event(s) condition(s) as specified/defined herein in the present disclosure, and which one or more of the reported beam(s) and/or report quantity(s)/content(s) in/of the UEI beam report could correspond to or could be associated to or for the beam(s)—i.e., the second beam(s)—that does not satisfy the event(s) condition(s) as specified/defined herein in the present disclosure.

In one example, a UEI beam report could indicate, provide or comprise a bitmap with each entry/bit position of the bitmap associated/corresponding to one or more report contents/quantities in the UEI beam report; when an entry/bit position of the bitmap is set to “1” (or “0”), the report content(s)/quantity(s) associated/corresponding to the entry/bit position of the bitmap could correspond to or could be associated to or for the beam(s)—i.e., the first beam(s)—that satisfies the event(s) condition(s) as specified/defined herein in the present disclosure, and when an entry/bit position of the bitmap is set to “0” (or “1”), the report content(s)/quantity(s) associated/corresponding to the entry/bit position of the bitmap could correspond to or could be associated to or for the beam(s)—i.e., the second beam(s)—that do not satisfy the event(s) condition(s) as specified/defined herein in the present disclosure.

In another example, a UEI beam report could indicate, provide or comprise one or more indicators with each indicator associated/corresponding to one or more report contents/quantities in the UEI beam report; when an indicator is set to “1” (or “0”), the report content(s)/quantity(s) associated/corresponding to the indicator could correspond to or could be associated to or for the beam(s)—i.e., the first beam(s)—that satisfies the event(s) condition(s) as specified/defined herein in the present disclosure, and when an indicator is set to “0” (or “1”), the report content(s)/quantity(s) associated/corresponding to the indicator could correspond to or could be associated to or for the beam(s)—i.e., the second beam(s)—that do not satisfy the event(s) condition(s) as specified/defined herein in the present disclosure.

In another example, a UEI beam report could indicate, provide or comprise a/the number of the report content(s)/quantity(s), e.g., value of N_beam, for the first beam(s) that satisfies the event(s) condition(s) as specified/defined herein in the present disclosure, and/or a/the number of the report content(s)/quantity(s), e.g., value of M_beam, for the second beam(s) that does not satisfy the event(s) condition(s) as specified/defined herein in the present disclosure. In this case, the first (or last) N_beam report content(s)/quantity(s) and/or the first (or last) N_beam CSI report numbers/fields/indexes in the UEI report could correspond to the first beam(s) that satisfies the event(s) condition(s) as specified/defined herein in the present disclosure, and/or the first (or last) M_beam report content(s)/quantity(s) and/or the first (or last) M_beam CSI report numbers/fields/indexes in the UEI report could correspond to the second beam(s) that does not satisfy the event(s) condition(s) as specified/defined herein in the present disclosure.

In another example, when the UEI report does not provide, indicate, comprise or contain information related to which one or more of the reported beam(s) and/or report quantity(s)/content(s) in/of the UEI beam report could correspond to or could be associated to or for the beam(s)—i.e., the first beam(s)—that satisfies the event(s) condition(s) as specified/defined herein in the present disclosure, and/or information related to which one or more of the reported beam(s) and/or report quantity(s)/content(s) in/of the UEI beam report could correspond to or could be associated to or for the beam(s)—i.e., the second beam(s)—that does not satisfy the event(s) condition(s) as specified/defined herein in the present disclosure, the UEI report could only comprise or contain or include or provide the report content(s)/quantity(s) corresponding to or associated to or for the beam(s)—i.e., the first beam(s)—that satisfies the event(s) condition(s) as specified/defined herein in the present disclosure.

In another example, when the UEI report does not provide, indicate, comprise or contain information related to which one or more of the reported beam(s) and/or report quantity(s)/content(s) in/of the UEI beam report could correspond to or could be associated to or for the beam(s)—i.e., the first beam(s)—that satisfies the event(s) condition(s) as specified/defined herein in the present disclosure, and/or information related to which one or more of the reported beam(s) and/or report quantity(s)/content(s) in/of the UEI beam report could correspond to or could be associated to or for the beam(s)—i.e., the second beam(s)—that does not satisfy the event(s) condition(s) as specified/defined herein in the present disclosure, the UEI report could only comprise or contain or include or provide the report content(s)/quantity(s) corresponding to or associated to or for the beam(s)—i.e., the second beam(s)—that does not satisfy the event(s) condition(s) as specified/defined herein in the present disclosure.

In another example, when the UEI (beam) report comprises one or more first beams (or one or more report contents/quantities for the first beam(s)) and one or more second beams (or one or more report contents/quantities for the second beam(s)) as specified/defined herein in the present disclosure), the UE could be expected to or could send or transmit to the network, in the (same) UEI beam report, the one or more current serving beams (or report quantity(s)/content(s) including L1-RSRP(s) for the one or more current serving beams) as specified/defined herein in the present disclosure. In this case, one or more beams or one or more report contents/quantities of one or more beams reported in the UEI (beam) report that satisfy the event(s) condition(s)—with respect to or regarding the current serving beam(s) or report quantity(s)/content(s) corresponding/associated/specific to the current serving beam(s) as specified/defined herein in the present disclosure, e.g., for the fourth event, the report quantity(s)/content(s) including L1-RSRP(s) corresponding/associated/specific to the one or more beams is beyond or greater than the report quantity(s)/content(s) including L1-RSRP(s) corresponding/associated/specific to the one or more current serving beams by a threshold-C according to examples in the present disclosure—could be identified or determined as the first beam(s) or the report quantity(s)/content(s) for the first beam(s), and one or more beams (e.g., other than the identified or determined first beam(s)) or one or more report contents/quantities of one or more beams (e.g., other than the identified or determined first beam(s)) reported in the UEI (beam) report that do not satisfy the event(s) condition(s)—with respect to or regarding the current serving beam(s) or report quantity(s)/content(s) corresponding/associated/specific to the current serving beam(s) as specified/defined herein in the present disclosure, e.g., for the fourth event, the report quantity(s)/content(s) including L1-RSRP(s) corresponding/associated/specific to the one or more beams is not beyond or greater than the report quantity(s)/content(s) including L1-RSRP(s) corresponding/associated/specific to the one or more current serving beams by a threshold-C according to examples in the present disclosure—could be identified or determined as the second beam(s) or the report quantity(s)/content(s) for the second beam(s). In addition, (1) it could be expected that the UE could always report or transmit to the network, in a/the UEI (beam) report, a/the number Nserv≥1 of the current serving beam(s) or report content(s)/quantity(s) of the current serving beam(s) and/or (2) the UE could be configured/indicated by the network, e.g., via higher layer RRC signaling(s)/parameter(s) and/or MAC CE command(s) and/or dynamic DCI based L1 signaling(s), to transmit or report to the network, in a/the UEI (beam) report, a/the number Nserv≥1 of the current serving beam(s) or report content(s)/quantity(s) of the current serving beam(s) according to examples in the present disclosure. For (1) and/or (2): (a) the position(s), ordering(s), CSI field(s), CSI field index(es), CSI field number(s) and/or etc. in the UEI (beam) report that could comprise, carry, provide, contain or include the current serving beam(s) or the report quantity(s)/content(s) associated/corresponding/specific to the current serving beam(s) as specified/defined herein in the present disclosure could be fixed; for instance, the first Nserv≥1 (or the 1-st when Nserv=1) position(s), ordering(s), CSI field(s), CSI field index(es), CSI field number(s) and/or etc. in the UEI (beam) report could comprise, carry, provide, contain or include the Nserv current serving beam(s) or the Nserv report quantity(s)/content(s) associated/corresponding/specific to the current serving beam(s) as specified/defined herein in the present disclosure, wherein the value of Nserv could be determined according to: (i) a fixed value, e.g., Nserv=1, in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous decision or selection, which could be further sent to the network via various UL channels/signals including PUCCH(s), PUSCH(s), MAC CE(s), PRACH(s), CSI/beam report(s) and/or UE's capability signaling(s), (b) the UE could indicate or provide or send to the network, in the (same) UEI beam report, the value/number Nserv and/or position(s), ordering(s), CSI field(s), CSI field index(es), CSI field number(s) and/or etc. in the UEI (beam) report that could comprise, carry, provide, contain or include the Nserv current serving beam(s) or the Nserv report quantity(s)/content(s) associated/corresponding/specific to the current serving beam(s) as specified/defined herein in the present disclosure,

For example, the UEI beam report could indicate, provide or comprise a bitmap with each entry/bit position of the bitmap associated/corresponding to one or more report contents/quantities in the UEI beam report; when an entry/bit position of the bitmap is set to “1” (or “0”), the report content(s)/quantity(s) associated/corresponding to the entry/bit position of the bitmap could correspond to or could be associated to or for a current serving beam as defined/specified herein in the present disclosure.

For another example, the UEI beam report could indicate, provide or comprise one or more indicators with each indicator associated/corresponding to one or more report contents/quantities in the UEI beam report; when an indicator is set to “1” (or “0”), the report content(s)/quantity(s) associated/corresponding to the indicator could correspond to or could be associated to or for a current serving beam as defined/specified herein in the present disclosure.

For another example, the UEI beam report could indicate, provide or comprise a/the number of the report content(s)/quantity(s), e.g., the number/value of Nserv, for the current serving beam(s).

The value/number Nserv and/or position(s), ordering(s), CSI field(s), CSI field index(es), CSI field number(s) and/or etc. in the UEI (beam) report that could comprise, carry, provide, contain or include the Nserv current serving beam(s) or the Nserv report quantity(s)/content(s) associated/corresponding/specific to the current serving beam(s) as specified/defined herein in the present disclosure could be indicated, configured or provided by the network, e.g., via higher layer RRC signaling(s)/parameter(s) and/or MAC CE command(s) and/or dynamic DCI based L1 signaling(s)—e.g., via bitmap(s), indicator(s) and/or etc. similar to examples disclosed in the present disclosure—according to or based on a corresponding UE's capability or capability signaling.

The UE could be indicated or configured or provided or enabled by the network, e.g., via higher layer RRC signaling(s)/parameter(s) and/or MAC CE command(s) and/or dynamic DCI based L1 signaling(s) based on or according to a corresponding UE's capability or capability signaling, which one or more of the examples/embodiments disclosed in the present disclosure to use for determining the order(s) the UEI report content(s)/quantity(s) for the first and second beams as defined/specified herein in the present disclosure. For instance, a UE could be indicated or provided or configured or enabled by the network, e.g., via/in the higher layer RRC signaling(s)/parameter(s), e.g., of a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure, a higher layer parameter denoted by “ueiReportOrderMode” set to value(s) related to or corresponding to or associated to one or more of examples/embodiment as disclosed in the present disclosure.

In one example, when the higher layer parameter “ueiReportOrderMode” is set to value(s) related to or corresponding to or associated to examples/embodiments as disclosed in the present disclosure. the UE could use examples/embodiments as disclosed in the present disclosure for determining the order(s) the UEI report content(s)/quantity(s) for the first and second beams as defined/specified herein in the present disclosure. For another example, when the higher layer parameter “ueiReportOrderMode” is set to value(s) related to or corresponding to or associated to examples/embodiments as disclosed in the present disclosure, the UE could use examples/embodiments as disclosed in the present disclosure for determining the order(s) the UEI report content(s)/quantity(s) for the first and second beams as defined/specified herein in the present disclosure. Tables 15, 17, and 17 shows CSI fields for CSI report number.

TABLE 15
CSI fields

| CSI report | |
|---|---|
| number | CSI fields |
| UEI (beam) | Beam # I (associated/corresponding report content(s)/quantity(s) such as |
| report #n | SSBRl(s)/CRl(s) and/or LI-RSRP(s)/L 1-SINR(s)) |
| | . . . |
| | Beam #L_beam (associated/corresponding report content(s)/quantity(s) such as |
| | SSBRl(s)/CRl(s) and/or L1-RSRP(s)/L 1-SINR(s)) |
| | Beam # I (associated/corresponding report content(s)/quantity(s) such as |
| | SSBRl(s)/CRl(s) and/or LI-RSRP(s)/L 1-SINR(s)) |
| | . . . |
| | Beam #L_beam (associated/corresponding report content(s)/quantity(s) such as |
| | SSBRl(s)/CRl(s) and/or L1-RSRP(s)/L 1-SINR(s)) |

TABLE 16
CSI fields

| CSI report | |
|---|---|
| number | CSI fields |
| UEI (beam) | Beam # I (associated/corresponding report content(s)/quantity(s) such as |
| report #n | SSBRl(s)/CRl(s) and/or LI-RSRP(s)/LI-SINR(s) |
| | . . . |
| | Beam #L_beam (associated/corresponding report content(s)/quantity(s) such as |
| | SSBRl(s)/CRl(s) and/or L1-RSRP(s)/L 1-SINR(s)) |
| | Beam #I (associated/corresponding report content(s)/quantity(s) such as |
| | SSBRl(s)/CRl(s) and/or LI-RSRP(s)/LI-SINR(s)) |
| | . . . |
| | Beam #K_beam (associated/corresponding report contents(s)/quantity(s) such |
| | as SSBRl(s)/CRl(s) and/or LI-RSRP(s)/LI-SINR(s)) with K_beam = Ntot − |
| | L_beam |

TABLE 17
CSI fields

| CSI report | |
|---|---|
| number | CSI fields |
| UEI (beam) | Beam #I (associated/corresponding report content(s)/quantity(s) such as |
| report #n | SSBRl(s)/CRl(s) and/or L1-RSRP(s)/L1-SINR(s)) |
| | . . . |
| | Beam #L_beam (associated/corresponding report content(s)/quantity(s) such as |
| | SSBRl(s)/CRl(s) and/or L1-RSRP(s)/LI-SINR(s)) |
| | Beam #I (associated/corresponding report content(s)/quantity(s) such as |
| | SSBRl(s)/CRl(s) and/or LI-RSRP(s)/L1-SINR(s)) |
| | . . . |
| | Beam #L_beam (associated/corresponding report content(s)/quantity(s) such as |
| | SSBRl(s)/CRl(s) and/or L1-RSRP(s)/L1-SINR(s)) |
| | Beam #I (associated/corresponding report content(s)/quantity(s) such as |
| | SSBRl(s)/CRl(s) and/or LI-RSRP(s)/L1-SINR(s)) |
| | . . . |
| | Beam #M_beam (associated/corresponding report content(s)/quantity(s) such |
| | as SSBRl(s)/CRl(s) and/or LI-RSRP(s)/L1-SINR(s)) with M_beam = Ntot − |
| | L_beam − L_beam |

In the present disclosure, a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as an SSBRI or a CRI reported in a UEI (beam) report or a CSI report or a beam report in general, and/or a beam metric such as a L1-RSRP or a L1-SINR reported in a UEI (beam) report or a CSI report or a beam report in general.

In the present disclosure, a UEI (beam) report could comprise one or more (denoted by L_beam≥1, e.g., L_beam=1, 2, 3, 4, . . . ) beams—and therefore their associated/corresponding report content(s)/quantity(s) including SSBRI(s)/CRI(s) and/or L1-RSRP(s)/L1-SINR(s), and/or one or more (denoted by L_beam≥1, e.g., L_beam=1, 2, 3, 4, . . . ) report content(s)/quantity(s) including SSBRI(s)/CRI(s) and/or L1-RSRP(s)/L1-SINR(s) corresponding/associated/specific to one or more beams according to those specified herein in the present disclosure, wherein the one or more beams in the UEI (beam) report—and therefore their corresponding/associated report content(s)/quantity(s)—could comprise or correspond to one or more of following examples.

In one example, one or more first beams as specified/defined herein in the present disclosure that satisfy the corresponding event(s) condition(s)—and therefore their corresponding/associated report content(s)/quantity(s).

In another example, one or more second beams as specified/defined herein in the present disclosure that may not satisfy the corresponding event(s) condition(s)—and therefore their corresponding/associated report content(s)/quantity(s).

In yet another example, one or more first beams that satisfy the corresponding event(s) condition(s) according to/following those specified herein in the present disclosure and one or more second beams that may not satisfy the corresponding event(s) condition(s)—and therefore their corresponding/associated report content(s)/quantity(s).

In yet another example, one or more current serving beams as defined/specified herein in the present disclosure—and therefore their corresponding/associated report content(s)/quantity(s).

In yet another example, one or more candidate/new beams as defined/specified herein in the present disclosure—and therefore their corresponding/associated report content(s)/quantity(s).

In yet another example, one or more current serving beams as defined/specified herein in the present disclosure and one or more candidate/new beams as defined/specified herein in the present disclosure—and therefore their corresponding/associated report content(s)/quantity(s).

In this case, the value of L_beam could be or could correspond to a fixed value per RRC (re)configuration—e.g., L_beam=1. Alternatively, the value of L_beam could be fixed in system specification(s)—e.g., L_beam=1. In addition, the value of L_beam could be provided or indicated or configured by the network, e.g., via higher layer RRC signaling(s)/parameter(s)—e.g., in CSI-ReportConfig or reporting setting(s)/configuration(s) that provides or configures the corresponding UEI beam report(s)—and/or MAC CE command(s) and/or dynamic DCI based L1 signaling(s) according to or based on a corresponding UE's capability or capability signaling—in this case, the value of L_beam could still be or could still correspond to a fixed value per RRC (re)configuration especially when the value of L_beam is provided or indicated or configured by the network via higher layer RRC signaling(s)/parameter(s); i.e., the value of L_beam would not change across different reporting instances/CSI reports/beam reports/UEI beam reports/CSI-Reports. Optionally, the value of L_beam could change or vary across different reporting instances/CSI reports/beam reports/UEI beam reports/CSI-Reports depending on, e.g., the number of first beam(s) as specified/defined herein in the present disclosure that satisfy the corresponding event(s) condition(s) in the UEI report; i.e., the value of L_beam is a variable for a given RRC (re)configuration.

For instance, the value of L_beam for a first reporting instance or UEI (beam) report or CSI report (e.g., L_beam=2) could be different from that for a second reporting instance or UEI (beam) report or CSI report (e.g., L_beam=4). In this case, the value of L_beam or information related to the value of L_beam could be indicated or provided or transmitted or sent by the UE to the network, e.g., via/in part of the (same) UEI beam report. Furthermore, as discussed or specified herein in the present disclosure, for one or more given events or one or more given events detection, when the number of the reported beam(s) in the UEI beam report—i.e., L_beam as specified herein in the present disclosure—is less than or equal to N_max, N_config and/or N_ue (i.e., L_beam≤N_max and/or L_beam≤N_config and/or L_beam≤N_ue), wherein N_max, N_config and/or N_ue could be defined or specified according to examples in the present disclosure.

In one example, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. For this example, the first L_beam CSI field(s) or the L_beam CSI field(s) with the lowest field index(es) in the UEI (beam) report could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure. The remaining (Ntot−L_beam) CSI field(s) in the UEI beam report could be padded with zeros.

In another example, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. For this example, the first L_beam CSI field(s) or the L_beam CSI field(s) with the lowest field index(es) in the UEI (beam) report could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure. The remaining (Ntot−L_beam) CSI field(s) in the UEI beam report could be reserved or could correspond to reserved (“R”) field(s) or special (“S”) field(s) that could comprise, provide, include, comprise, contain, carry or convey special value(s) or indicator(s) or codepoint(s).

In another example, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. For this example, the first L_beam CSI field(s) or the L_beam CSI field(s) with the lowest field index(es) in the UEI (beam) report could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure. The remaining (Ntot−L_beam) CSI field(s) in the UEI beam report could be used to convey or provide or indicate or contain or include or comprise or carry one or more of the L_beam beams, and therefore their associated/corresponding report content(s)/quantity(s) including SSBRI(s)/CRI(s) and/or L1-RSRP(s)/L1-SINR(s), and/or one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this example, the first CSI field or the CSI field with the lowest field index—out of or among the remaining (Ntot−L_beam) CSI field(s) in the UEI report—could be used to convey or provide or indicate or contain or include or comprise or carry the first beam or the beam with the lowest/highest beam metric such as L1-RSRP/L1-SINR or the beam with the lowest/highest resource indicator such as SSBRI/CRI—out of or among the L_beam beams—and therefore the associated/corresponding report content(s)/quantity(s) including SSBRI(s)/CRI(s) and/or L1-RSRP(s)/L1-SINR(s), and/or the first of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the lowest/highest resource indicator such as SSBRI/CRI and/or the lowest/highest beam metric such as L1-RSRP/L1-SINR, the second CSI field or the CSI field with the second lowest field index—out of or among the remaining (Ntot−L_beam) CSI field(s) in the UEI report—could be used to convey or provide or indicate or contain or include or comprise or carry the second beam or the beam with the second lowest/highest beam metric such as L1-RSRP/L1-SINR or the beam with the second lowest/highest resource indicator such as SSBRI/CRI—out of or among the L_beam beams—and therefore the associated/corresponding report content(s)/quantity(s) including SSBRI(s)/CRI(s) and/or L1-RSRP(s)/L1-SINR(s), and/or the second of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the second lowest/highest resource indicator such as SSBRI/CRI and/or the second lowest/highest beam metric such as L1-RSRP/L1-SINR, and so on.

For example, when (Ntot−L_beam) is equal to L_beam, the remaining (Ntot−L_beam) CSI field(s) in the UEI beam report could be used to convey or provide or indicate or contain or include or comprise or carry all the L_beam beams, and therefore their associated/corresponding report content(s)/quantity(s) including SSBRI(s)/CRI(s) and/or L1-RSRP(s)/L1-SINR(s), and/or all the L_beam report content(s)/quantity(s) including SSBRI(s)/CRI(s) and/or L1-RSRP(s)/L1-SINR(s) corresponding/associated/specific to one or more beams according to those specified herein in the present disclosure, following those specified, described or discussed herein in the present disclosure. One conceptual example is provided in Table 15.

For another example, when (Ntot−L_beam) is less than L_beam, the remaining (Ntot−L_beam) CSI field(s) in the UEI report could be used to convey or provide or indicate or contain or include or comprise or carry the first (Ntot−L_beam) beams or the (Ntot−L_beam) beams with the lowest/highest beam metrics such as L1-RSRPs/L1-SINRs or the (Ntot−L_beam) beams with the lowest/highest resource indicators such as SSBRIs/CRIs—out of or among the L_beam beams—and therefore the associated/corresponding report content(s)/quantity(s) including SSBRI(s)/CRI(s) and/or L1-RSRP(s)/L1-SINR(s), and/or the first (Ntot−L_beam) of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or (Ntot−L_beam) of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the lowest/highest resource indicators such as SSBRIs/CRIs and/or the lowest/highest beam metrics such as L1-RSRPs/L1-SINRs, following those specified herein in the present disclosure. One conceptual example is provided in Table 16 with K_beam=Ntot−L_beam.

For another example, when (Ntot−L_beam) is greater than L_beam, the first L_beam CSI field(s) or the L_beam CSI field(s) with the lowest field index(es)—out of or among the remaining (Ntot−L_beam) CSI field(s) in the UEI beam report—could be used to convey or provide or indicate or contain or include or comprise or carry all the L_beam beams, and therefore their associated/corresponding report content(s)/quantity(s) including SSBRI(s)/CRI(s) and/or L1-RSRP(s)/L1-SINR(s), and/or all the L_beam report content(s)/quantity(s) including SSBRI(s)/CRI(s) and/or L1-RSRP(s)/L1-SINR(s) corresponding/associated/specific to one or more beams according to those specified herein in the present disclosure, following those specified, described or discussed herein in the present disclosure. In this case, the remaining (Ntot−L_beam−L_beam) CSI field(s) in the UEI beam report could be used to convey or provide or indicate or contain or include or comprise or carry one or more of the L_beam beams, and therefore their associated/corresponding report content(s)/quantity(s) including SSBRI(s)/CRI(s) and/or L1-RSRP(s)/L1-SINR(s), and/or one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure, following those specified herein in the present disclosure. One conceptual example is provided in Table 17 with M_beam=Ntot−L_beam−L_beam.

In one example, the UE could send or transmit or indicate to the network, e.g., via/in part of the same UEI beam report, the value(s) of L_beam and/or (Ntot−L_beam). Optionally, the UE could also send or transmit or indicate to the network, e.g., via/in part of the same UEI beam report, which one or more of the L_beam beams, and therefore their associated/corresponding report content(s)/quantity(s) including SSBRI(s)/CRI(s) and/or L1-RSRP(s)/L1-SINR(s), and/or which one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure could be conveyed or provided or indicated or contained or included or comprised or carried by the remaining (Ntot−L_beam) CSI field(s) in the UEI beam report.

For example, the UEI beam report could provide, indicate, contain, comprise or include a bitmap with each entry/bit position of the bitmap corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this example, when a bit position/entry of the bitmap is set to “1” (or “0”), the beam—out of all the L_beam beams, and therefore the associated/corresponding report content(s)/quantity(s) including SSBRI(s)/CRI(s) and/or L1-RSRP(s)/L1-SINR(s)—associated/corresponding to the bit position/entry could be conveyed or provided or indicated or contained or included or comprised or carried by one or more of the remaining (Ntot−L_beam) CSI field(s) in the UEI beam report, and/or the report content(s)/quantity(s) including SSBRI(s)/CRI(s) and/or L1-RSRP(s)/L1-SINR(s)—out of all the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the bit position/entry could be conveyed or provided or indicated or contained or included or comprised or carried by one or more of the remaining (Ntot−L_beam) CSI field(s) in the UEI beam report.

For another example, the UEI beam report could provide, indicate, contain, comprise or include one or more (e.g., L_beam) indicators with each indicator corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this example, when an indicator is set to “1” (or “0”), the beam-out of all the L_beam beams, and therefore the associated/corresponding report content(s)/quantity(s) including SSBRI(s)/CRI(s) and/or L1-RSRP(s)/L1-SINR(s)—associated/corresponding to the indicator could be conveyed or provided or indicated or contained or included or comprised or carried by one or more of the remaining (Ntot−L_beam) CSI field(s) in the UEI beam report, and/or the report content(s)/quantity(s) including SSBRI(s)/CRI(s) and/or L1-RSRP(s)/L1-SINR(s)—out of all the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the indicator could be conveyed or provided or indicated or contained or included or comprised or carried by one or more of the remaining (Ntot−L_beam) CSI field(s) in the UEI beam report.

For another example, the UEI beam report could provide, indicate, contain, comprise or include a set of one or more beam indexes, wherein each beam index could correspond/point to or represent one of the L_beam beams—and therefore the associated/corresponding report content(s)/quantity(s) including SSBRI(s)/CRI(s) and/or L1-RSRP(s)/L1-SINR(s). For this example, the beam(s)—out of all the L_beam beams, and therefore the associated/corresponding report content(s)/quantity(s) including SSBRI(s)/CRI(s) and/or L1-RSRP(s)/L1-SINR(s)—that correspond to or that is represented or pointed by the beam index(es) in the set could be conveyed or provided or indicated or contained or included or comprised or carried by one or more of the remaining (Ntot−L_beam) CSI field(s) in the UEI beam report.

For another example, the UEI beam report could provide, indicate, contain, comprise or include a set of one or more indexes, wherein each index could correspond to or represent one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this example, the report content(s)/quantity(s) including SSBRI(s)/CRI(s) and/or L1-RSRP(s)/L1-SINR(s)—out of all the L_beam report content(s)/quantity(s) including SSBRI(s)/CRI(s) and/or L1-RSRP(s)/L1-SINR(s) corresponding/associated/specific to one or more beams according to those specified herein in the present disclosure—that correspond to or that is presented or pointed by the index(es) in the set could be conveyed or provided or indicated or contained or included or comprised or carried by one or more of the remaining (Ntot−L_beam) CSI field(s) in the UEI beam report.

Additionally, as discussed or specified herein in the present disclosure, for one or more given events or one or more given events detection, when the number of the reported beam(s) in the UEI beam report—i.e., L_beam as specified herein in the present disclosure—is greater than or equal to N_max, N_config and/or N_ue (i.e., L_beam≥N_max and/or L_beam≥N_config and/or L_beam≥N_ue), wherein N_max, N_config and/or N_ue could be defined or specified according to examples in the present disclosure, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. In this case, the remaining Ntot CSI field(s) in the UEI report could be used to convey or provide or indicate or contain or include or comprise or carry the first Ntot beams or the Ntot beams with the lowest/highest beam metrics such as L1-RSRPs/L1-SINRs or the Ntot beams with the lowest/highest resource indicators such as SSBRIs/CRIs—out of or among the L_beam beams—and therefore the associated/corresponding report content(s)/quantity(s) including SSBRI(s)/CRI(s) and/or L1-RSRP(s)/L1-SINR(s), and/or the first Ntot of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or Ntot of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the lowest/highest resource indicators such as SSBRIs/CRIs and/or the lowest/highest beam metrics such as L1-RSRPs/L1-SINRs, following those specified herein in the present disclosure.

Furthermore, the UE could send or transmit or indicate to the network, e.g., via/in part of the same UEI beam report, which one or more of the L_beam beams, and therefore their associated/corresponding report content(s)/quantity(s) including SSBRI(s)/CRI(s) and/or L1-RSRP(s)/L1-SINR(s), and/or which one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure could be conveyed or provided or indicated or contained or included or comprised or carried by the Ntot CSI field(s) in the UEI beam report.

In one example, the UEI beam report could provide, indicate, contain, comprise or include a bitmap with each entry/bit position of the bitmap corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this example, when a bit position/entry of the bitmap is set to “1” (or “0”), the beam—out of all the L_beam beams, and therefore the associated/corresponding report content(s)/quantity(s) including SSBRI(s)/CRI(s) and/or L1-RSRP(s)/L1-SINR(s)—associated/corresponding to the bit position/entry could be conveyed or provided or indicated or contained or included or comprised or carried by one or more of the Ntot CSI field(s) in the UEI beam report, and/or the report content(s)/quantity(s) including SSBRI(s)/CRI(s) and/or L1-RSRP(s)/L1-SINR(s)—out of all the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the bit position/entry could be conveyed or provided or indicated or contained or included or comprised or carried by one or more of the Ntot CSI field(s) in the UEI beam report.

In another example, the UEI beam report could provide, indicate, contain, comprise or include one or more (e.g., L_beam) indicators with each indicator corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this example, when an indicator is set to “1” (or “0”), the beam—out of all the L_beam beams, and therefore the associated/corresponding report content(s)/quantity(s) including SSBRI(s)/CRI(s) and/or L1-RSRP(s)/L1-SINR(s)—associated/corresponding to the indicator could be conveyed or provided or indicated or contained or included or comprised or carried by one or more of the Ntot CSI field(s) in the UEI beam report, and/or the report content(s)/quantity(s) including SSBRI(s)/CRI(s) and/or L1-RSRP(s)/L1-SINR(s)—out of all the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the indicator could be conveyed or provided or indicated or contained or included or comprised or carried by one or more of the Ntot CSI field(s) in the UEI beam report.

In another example, the UEI beam report could provide, indicate, contain, comprise or include a set of one or more beam indexes, wherein each beam index could correspond/point to or represent one of the L_beam beams—and therefore the associated/corresponding report content(s)/quantity(s) including SSBRI(s)/CRI(s) and/or L1-RSRP(s)/L1-SINR(s). For this example, the beam(s)—out of all the L_beam beams, and therefore the associated/corresponding report content(s)/quantity(s) including SSBRI(s)/CRI(s) and/or L1-RSRP(s)/L1-SINR(s)—that correspond to or that is represented or pointed by the beam index(es) in the set could be conveyed or provided or indicated or contained or included or comprised or carried by one or more of the Ntot CSI field(s) in the UEI beam report.

In another example, the UEI beam report could provide, indicate, contain, comprise or include a set of one or more indexes, wherein each index could correspond to or represent one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this example, the report content(s)/quantity(s) including SSBRI(s)/CRI(s) and/or L1-RSRP(s)/L1-SINR(s)—out of all the L_beam report content(s)/quantity(s) including SSBRI(s)/CRI(s) and/or L1-RSRP(s)/L1-SINR(s) corresponding/associated/specific to one or more beams according to those specified herein in the present disclosure—that correspond to or that is presented or pointed by the index(es) in the set could be conveyed or provided or indicated or contained or included or comprised or carried by one or more of the Ntot CSI field(s) in the UEI beam report.

In one embodiment, when a UEI (beam) report comprises or includes or contains or provides report content(s)/quantity(s) for the current serving beam(s) following those specified herein in the present disclosure, the report content(s)/quantity(s) for the current serving beam(s) (1) could only contain, include, provide or comprise beam metric(s) including L1-RSRP(s) and/or L1-SINR(s), and/or (2) may not contain, include, provide or comprise any resource indicator(s) including SSBRI(s) or CRI(s).

In one example, the first CSI field or the CSI field with the lowest field index—e.g., among all the CSI field(s) in a/the UEI beam report and/or among all the CSI field(s) in a/the UEI beam report that convey or carry or provide or indicate beam metric(s) including at least L1-RSRP(s)/L1-SINR(s)—could be used to indicate, convey, carry, provide, include, comprise or contain the report content(s)/quantity(s) for the current serving beam(s). In this case, when the first CSI field or the CSI field with the lowest field index as specified/defined herein is set to “0” (or “1”) or a special value or reserved, the UEI (beam) report may not contain, provide, include, comprise or indicate any report content(s)/quantity(s) for or specific to the current serving beam(s); otherwise, the report content(s)/quantity(s) including L1-RSRP(s)/L1-SINR(s) provided, indicated, comprised, contained or included by/in the first CSI field or the CSI field with the lowest field index as specified/defined herein could be for or specific to the current serving beam(s).

In another example, a/the UEI (beam) report as specified/defined herein in the present disclosure could provide, include, contain, indicate or comprise an indicator to indicate whether or not the report content(s)/quantity(s) for or specific to the current serving beam(s) could be present in a/the UEI (beam) report. For instance, the indicator could be a one-bit indicator with “1” (or “0”) indicating that the current serving beam(s)—and therefore the corresponding/associated report content(s)/quantity(s)—is present in the UEI beam report, and “0” (or “1”) indicating that the current serving beam(s)—and therefore the corresponding/associated report content(s)/quantity(s)—is absent or not present in the UEI (beam) report. In this case, when the one-bit indicator is set to “1” (“0”), the first CSI field or the CSI field with the lowest field index—e.g., among all the CSI field(s) excluding the CSI field that carries, conveys, provides or indicates the indicator in a/the UEI beam report and/or among all the CSI field(s) excluding the CSI field that carries, conveys, provides or indicates the indicator that convey or carry or provide or indicate beam metric(s) including at least L1-RSRP(s)/L1-SINR(s) in a/the UEI beam report—could be used to indicate, convey, carry, provide, include, comprise or contain the report content(s)/quantity(s) for or specific to the current serving beam(s).

In the present disclosure, for one or more given events or one or more given events detection, when the number of the determined or identified first beam(s)—denoted by N_beam—that satisfy the event(s) condition(s) and/or the number of report content(s)/quantity(s) of the determined or identified first beam(s)-denoted by N_beam—that satisfy the event(s) condition(s) as specified/defined herein in the present disclosure is greater than 1, i.e., N_beam>1, the UE may be expected to send or transmit to the network a UEI report that comprises multiple (i.e., more/greater than one) determined or identified first beams—and therefore, the corresponding report content(s)/quantity(s) including SSBRI(s)/CRI(s) and/or L1-RSRP(s)/L1-SINR(s)—and/or multiple (i.e., more/greater than one) report contents/quantities of the determined or identified first beam(s); i.e., in this case, the UE may not be expected to send or transmit to the network a UEI beam report that comprises a single determined or identified first beam and/or the report content(s)/quantity(s) of a single determined or identified first beam that satisfies the event(s) condition(s).

In a multiple-cell (multi-cell) or multiple-carrier (multi-carrier or MC) or multiple-component carrier (multi-CC) scenario, following examples may be provided.

In one example, a UE could determine or identify a cell-specific or carrier-specific or CC-specific UEI beam report for each of the configured or activated or indicated cells, carriers or CCs according to or following one or more of the examples/report formats as defined/specified herein in the present disclosure. For instance, for a given cell, carrier or CC, the UE could follow one or more of the examples as defined/specified herein in the present disclosure to determine or identify the number of beam(s)—and therefore, the corresponding report content(s)/quantity(s) including SSBRI(s)/CRI(s) and/or L1-RSRP(s)/L1-SINR(s)—that can be sent or transmitted in the UEI beam report specific to the given cell, carrier or CC; in addition, the UE could also follow one or more of the examples as defined/specified herein in the present disclosure to determine or identify a report format for the UEI beam report specific to the given cell, carrier or CC. For this example, the UE could send or transmit to the network, e.g., in separate CSI reports (or CSI-Reports) or reporting instances, separate cell-specific or carrier-specific or CC-specific UEI beam reports. That is, for all the configured, activated or indicated cells or carriers or CCs of interest, each CSI report or reporting instance could comprise or correspond to one or more cell-specific or carrier-specific or CC-specific UEI beam reports, and all the cell-specific or carrier-specific and CC-specific UEI beam reports could be transmitted or sent in/via multiple (i.e., more than one) CSI reports/CSI-Reports or reporting instances.

In another example, a UE could first determine or identify cell-specific or carrier-specific or CC-specific report content(s)/quantity(s) including SSBRI(s)/CRI(s) and/or L1-SINR(s)/L1-RSRP(s) for each of the configured or activated or indicated cells, carriers or CCs according to or following one or more of the examples as defined/specified herein in the present disclosure. For instance, for a given cell, carrier or CC, the UE could follow one or more of the examples as defined/specified herein in the present disclosure to determine or identify the number of beam(s)—and therefore, the corresponding report content(s)/quantity(s) including SSBRI(s)/CRI(s) and/or L1-RSRP(s)/L1-SINR(s)—specific to the given cell, carrier or CC that can be sent or transmitted in a UEI beam report. The UE could then determine or identify a report format following or according to one or more of the examples specified/defined herein in the present disclosure for a UEI beam report that could comprise the report content(s)/quantity(s) including SSBRI(s)/CRI(s) and/or L1-RSRP(s)/L1-SINR(s) for all the configured or activated or indicated cells, carriers or CCs of interest, wherein the ordering(s)/position(s)/index(es)/CSI field(s)/CSI field index(es) of the report content(s)/quantity(s) in the UEI beam report could follow the ordering(s)—e.g., from low to high or high to low—of the corresponding cell IDs/indexes, carrier IDs/indexes or CC IDs/indexes.

For instance, the first N_0≥1 CSI fields or the N_0 CSI fields with the lowest indexes in a UEI beam report could be used to convey or carry or provide or indicate or comprise the N_0 beams and/or N_0 report content(s)/quantity(s) including SSBRI(s)/CRI(s) and/or L1-RSRP(s)/L1-SINR(s) determined or identified specific to/for the cell, carrier or CC with the lowest (or highest) ID/index, the first N_1≥1 CSI fields or the N_1 CSI fields with the lowest indexes following or preceded by the first N_0≥1 CSI fields or the N_0 CSI fields with the lowest indexes in the UEI beam report could be used to convey or carry or provide or indicate or comprise the N_1 beams and/or N_1 report content(s)/quantity(s) including SSBRI(s)/CRI(s) and/or L1-RSRP(s)/L1-SINR(s) determined or identified specific to/for the cell, carrier or CC with the second lowest (or second highest) ID/index, and so on, and the last N_L≥1 CSI fields or the N_L CSI fields with the highest indexes in the UEI beam report could be used to convey or carry or provide or indicate or comprise the N_L beams and/or N_L report content(s)/quantity(s) including SSBRI(s)/CRI(s) and/or L1-RSRP(s)/L1-SINR(s) determined or identified specific to/for the cell, carrier or CC with the highest (or lowest) ID/index. For this example, the UE could transmit or send or indicate to the network, in a single/same CSI report (or CSI-Report) or reporting instance, the UEI beam report as defined/specified herein in the present disclosure that comprise report content(s)/quantity(s) as defined/specified herein in the present disclosure specific to/for all the configured, activated or indicated cells, carriers or CCs of interest.

In the present disclosure, a UEI beam report could also comprise, convey, carry, include, contain or provide ID(s)/index(es) of one or more cells, one or more carriers or one or more CCs corresponding to the report content(s)/quantity(s) including SSBRI(s)/CRI(s) and/or L1-RSRP(s)/L1-SINR(s) as defined/specified herein in the present disclosure in the UEI beam report. Furthermore, a UEI beam report as specified or defined in one or more of the examples specified or defined herein in the present disclosure could be of a two-part UCI comprising part 1 and part 2, wherein part 1 could be of fixed payload size, part 2 could be of variable payload size, and part 1 could indicate information including payload size, number of beams (and therefore the corresponding report content(s)/quantity(s)) and etc. for part 2.

In the present disclosure, for a given event (e.g., the fourth event or Event-4 as specified/defined herein in the present disclosure), a UE could be configured or provided or indicated by the network, e.g., via/in/by higher layer RRC signaling(s)/parameter(s) CSI-ReportConfig or UEI-ReportConfig configured or provided for the UE-initiated/event-driven beam reporting, to report in a CSI report/reporting instance/CSI-Report, a number K_config beam(s) comprising N_config resource indicator(s) such as SSBRI(s)/CRI(s) and/or a number M_config corresponding beam metric(s) such as L1-RSRP(s)/L1-SINR(s), wherein the K_config beam(s) includes at least one new beam—selected from candidate/new beam RS(s) or RS resource(s) as specified/defined herein in the present disclosure—that satisfies the event condition(s).

In one example, when the UE is enabled or configured by the network, e.g., via higher layer RRC signaling(s)/parameter(s)—e.g., by configuring/providing a higher layer RRC parameter “servBeamInclusion” and/or setting the “servBeamInclusion” to “enabled” or “on,” to report in the CSI report/reporting instance/CSI-Report, current serving beam(s)'s beam metric(s) such as L1-RSRP(s)/L1-SINR(s) and/or current serving beam(s)'s resource indicator(s) such as SSBRI(s)/CRI(s)—e.g., the current serving beam(s)'s beam metric(s) could be obtained by measuring or assessing or evaluating the current serving beam RS(s) or RS resource(s) as specified/defined herein in the present disclosure, and the current serving beam(s)'s resource indicator(s) could be selected from the current serving beam RS(s) or RS resource(s) as specified/defined herein in the present disclosure, the candidate values of K_config could be ≥1 including {1, 2, 3, 4}(or any subset of {1, 2, 3, 4, 5, 6, 7, 8}), the candidate values of N_config could be ≥1 including {1, 2, 3, 4}(or any subset of {1, 2, 3, 4, 5, 6, 7, 8}), the candidate values of M_config could be ≥1 including {1, 2, 3, 4}(or any subset of {1, 2, 3, 4, 5, 6, 7, 8}), and/or K_config=N_config=M_config. In such examples, following examples may be provided.

In one example, the UE could report, in the CSI report/reporting instance/CSI-Report, N_config resource indicator(s)—excluding the resource indicator SSBRI/CRI for the current serving beam, M_config beam metric(s) corresponding to the N_config resource indicator(s)—excluding the beam metric L1-RSPR/L1-SINR for the current serving beam, and the beam metric L1-RSRP/L1-SINR for the current serving beam.

In another example, the UE could report, in the CSI report/reporting instance/CSI-Report, N_config resource indicator(s)—excluding the resource indicator SSBRI/CRI for the current serving beam, M_config beam metric(s) corresponding to the N_config resource indicator(s)—excluding the beam metric L1-RSPR/L1-SINR for the current serving beam, the resource indicator SSBRI/CRI for the current serving beam, and the beam metric L1-RSRP/L1-SINR for the current serving beam.

In another example, the UE could report, in the CSI report/reporting instance/CSI-Report, N_config resource indicator(s)—excluding the resource indicator SSBRI/CRI for the current serving beam, M_config beam metric(s) corresponding to the N_config resource indicator(s)—excluding the beam metric L1-RSPR/L1-SINR for the current serving beam, the beam metric L1-RSRP/L1-SINR for the current serving beam, and a TCI state ID/index (the current serving beam RS(s) or RS resource(s) is derived from or associated with the TCI state corresponding to the TCI state ID/index).

In one example, when the UE is not enabled or is disabled by the network, e.g., via higher layer RRC signaling(s)/parameter(s)—e.g., by configuring/providing a higher layer RRC parameter “servBeamInclusion” and setting the “servBeamInclusion” to “disabled” or “off,” to report in the CSI report/reporting instance/CSI-Report, current serving beam(s)'s beam metric(s) such as L1-RSRP(s)/L1-SINR(s) and/or current serving beam(s)'s resource indicator(s) such as SSBRI(s)/CRI(s)—e.g., the current serving beam(s)'s beam metric(s) could be obtained by measuring or assessing or evaluating the current serving beam RS(s) or RS resource(s) as specified/defined herein in the present disclosure, and the current serving beam(s)'s resource indicator(s) could be selected from the current serving beam RS(s) or RS resource(s) as specified/defined herein in the present disclosure, and/or when the UE is not provided or configured by the network the corresponding higher layer RRC signaling(s)/parameter(s)—e.g., the higher layer RRC parameter “servBeamInclusion”—used to indicate to the UE to report in the CSI report/reporting instance/CSI-Report, current serving beam(s)'s beam metric(s) such as L1-RSRP(s)/L1-SINR(s) and/or current serving beam(s)'s resource indicator(s) such as SSBRI(s)/CRI(s)—e.g., the current serving beam(s)'s beam metric(s) could be obtained by measuring or assessing or evaluating the current serving beam RS(s) or RS resource(s) as specified/defined herein in the present disclosure, and the current serving beam(s)'s resource indicator(s) could be selected from the current serving beam RS(s) or RS resource(s) as specified/defined herein in the present disclosure, the candidate values of K_config could be >1 including {2, 3, 4}(or any subset of {2, 3, 4, 5, 6, 7, 8}), the candidate values of N_config could be >1 including {2, 3, 4}(or any subset of {2, 3, 4, 5, 6, 7, 8}), the candidate values of M_config could be >1 including {2, 3, 4}(or any subset of {2, 3, 4, 5, 6, 7, 8}). In such examples, following examples may be provided.

In one example, the UE could report, in the CSI report/reporting instance/CSI-Report, N_config resource indicator(s)—excluding the resource indicator SSBRI/CRI for the current serving beam, and M_config beam metric(s) corresponding to the N_config resource indicator(s)—excluding the beam metric L1-RSPR/L1-SINR for the current serving beam. For this example, K_config=N_config=M_config.

In another example, the UE could report, in the CSI report/reporting instance/CSI-Report, N_config resource indicator(s)—excluding the resource indicator SSBRI/CRI for the current serving beam, and M_config beam metric(s) including the beam metric(s) corresponding to the N_config resource indicator(s) and the beam metric L1-RSPR/L1-SINR for the current serving beam. For this example, K_config=M_config=N_config+1.

In another example, the UE could report, in the CSI report/reporting instance/CSI-Report, N_config resource indicator(s) including the resource indicator SSBRI/CRI for the current serving beam, and M_config beam metric(s) corresponding to the N_config resource indicator(s). For this example, K_config=M_config=N_config.

In another example, the UE could report, in the CSI report/reporting instance/CSI-Report, N_config resource indicator(s)—excluding the resource indicator SSBRI/CRI for the current serving beam, M_config beam metric(s) including the beam metric(s) corresponding to the N_config resource indicator(s) and the beam metric L1-RSPR/L1-SINR for the current serving beam, and a TCI state ID/index (the current serving beam RS(s) or RS resource(s) is derived from or associated with the TCI state corresponding to the TCI state ID/index). For this example, K_config=M_config=N_config+1.

In one example, when the UE is not enabled or is disabled by the network, e.g., via higher layer RRC signaling(s)/parameter(s)—e.g., by configuring/providing a higher layer RRC parameter “servBeamInclusion” and setting the “servBeamInclusion” to “disabled” or “off,” to report in the CSI report/reporting instance/CSI-Report, current serving beam(s)'s beam metric(s) such as L1-RSRP(s)/L1-SINR(s) and/or current serving beam(s)'s resource indicator(s) such as SSBRI(s)/CRI(s)—e.g., the current serving beam(s)'s beam metric(s) could be obtained by measuring or assessing or evaluating the current serving beam RS(s) or RS resource(s) as specified/defined herein in the present disclosure, and the current serving beam(s)'s resource indicator(s) could be selected from the current serving beam RS(s) or RS resource(s) as specified/defined herein in the present disclosure, and/or when the UE is not provided or configured by the network the corresponding higher layer RRC signaling(s)/parameter(s)—e.g., the higher layer RRC parameter “servBeamInclusion”—used to indicate to the UE to report in the CSI report/reporting instance/CSI-Report, current serving beam(s)'s beam metric(s) such as L1-RSRP(s)/L1-SINR(s) and/or current serving beam(s)'s resource indicator(s) such as SSBRI(s)/CRI(s)—e.g., the current serving beam(s)'s beam metric(s) could be obtained by measuring or assessing or evaluating the current serving beam RS(s) or RS resource(s) as specified/defined herein in the present disclosure, and the current serving beam(s)'s resource indicator(s) could be selected from the current serving beam RS(s) or RS resource(s) as specified/defined herein in the present disclosure, the candidate values of K_config could be ≥1 including {1, 2, 3, 4}(or any subset of {1, 2, 3, 4, 5, 6, 7, 8}), the candidate values of N_config could be ≥1 including {1, 2, 3, 4}(or any subset of {1, 2, 3, 4, 5, 6, 7, 8}), the candidate values of M_config could be ≥1 including {1, 2, 3, 4}(or any subset of {1, 2, 3, 4, 5, 6, 7, 8}), and/or K_config=N_config=M_config. In this case, when K_config=1 and/or N_config=1 and/or M_config=1.

In one example, the UE could report, in the CSI report/reporting instance/CSI-Report, the N_config=1 resource indicator different from or not corresponding to the resource indicator SSBRI/CRI for the current serving beam, and the M_config=1 beam metric corresponding to the N_config=1 resource indicator—different from or not corresponding to the beam metric L1-RSPR/L1-SINR for the current serving beam.

In another example, the UE could report, in the CSI report/reporting instance/CSI-Report, the N_config=1 resource indicator SSBRI/CRI for the current serving beam, and the M_config=1 beam metric L1-RSPR/L1-SINR for the current serving beam.

In another example, the UE could report, in the CSI report/reporting instance/CSI-Report, the M_config=1 beam metric L1-RSPR/L1-SINR for the current serving beam.

In another example, the UE could report, in the CSI report/reporting instance/CSI-Report, the M_config=1 beam metric L1-RSPR/L1-SINR for the current serving beam, and a TCI state ID/index (the current serving beam RS(s) or RS resource(s) is derived from or associated with the TCI state corresponding to the TCI state ID/index).

The UE could identify or determine whether the reported N_config=1 resource indicator could correspond to the current serving beam's resource indicator or not, and/or whether the reported M_config=1 beam metric could correspond to the current serving beam's beam metric or not according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). And when K_config>1 and/or N_config>1 and/or M_config>1, following examples may be provided.

In one example, the UE could report, in the CSI report/reporting instance/CSI-Report, N_config resource indicator(s)—excluding the resource indicator SSBRI/CRI for the current serving beam, and M_config beam metric(s) corresponding to the N_config resource indicator(s)—excluding the beam metric L1-RSPR/L1-SINR for the current serving beam. For this example, K_config=N_config=M_config.

In another example, the UE could report, in the CSI report/reporting instance/CSI-Report, N_config resource indicator(s)—excluding the resource indicator SSBRI/CRI for the current serving beam, and M_config beam metric(s) including the beam metric(s) corresponding to the N_config resource indicator(s) and the beam metric L1-RSPR/L1-SINR for the current serving beam. For this example, K_config=M_config=N_config+1.

In another example, the UE could report, in the CSI report/reporting instance/CSI-Report, N_config resource indicator(s) including the resource indicator SSBRI/CRI for the current serving beam, and M_config beam metric(s) corresponding to the N_config resource indicator(s). For this example, K_config=M_config=N_config.

In another example, the UE could report, in the CSI report/reporting instance/CSI-Report, N_config resource indicator(s)—excluding the resource indicator SSBRI/CRI for the current serving beam, M_config beam metric(s) including the beam metric(s) corresponding to the N_config resource indicator(s) and the beam metric L1-RSPR/L1-SINR for the current serving beam, and a TCI state ID/index (the current serving beam RS(s) or RS resource(s) is derived from or associated with the TCI state corresponding to the TCI state ID/index). For this example, K_config=M_config=N_config+1.

For the examples as disclosed in the present disclosure, the UE could identify or determine whether or not to include the resource indicator(s) such as SSBRI(s)/CRI(s) for the current serving beam and/or the TCI state ID/index associated/specific to the current serving beam (the current serving beam RS(s) or RS resource(s) is derived from or associated with the TCI state corresponding to the TCI state ID/index) according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In the present disclosure, for a given event (e.g., the first event or Event-1 as specified/defined herein in the present disclosure), the UE could identify or determine whether or not to include, in a CSI/beam report and/or reporting instance and/or CSI-Report, beam metric(s) such as L1-RSRP(s)/L1-SINR(s) for the current serving beam (e.g., obtained by measuring, evaluating or assessing the current serving beam RS(s) or RS resource(s) as specified/defined herein in the present disclosure) according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as an SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, in the present disclosure, a reference signal (RS) could be equivalent to a RS resource, a RS resource index, a RS resource configuration index, a RS index and/or etc.

In the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

In the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

In the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). In the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

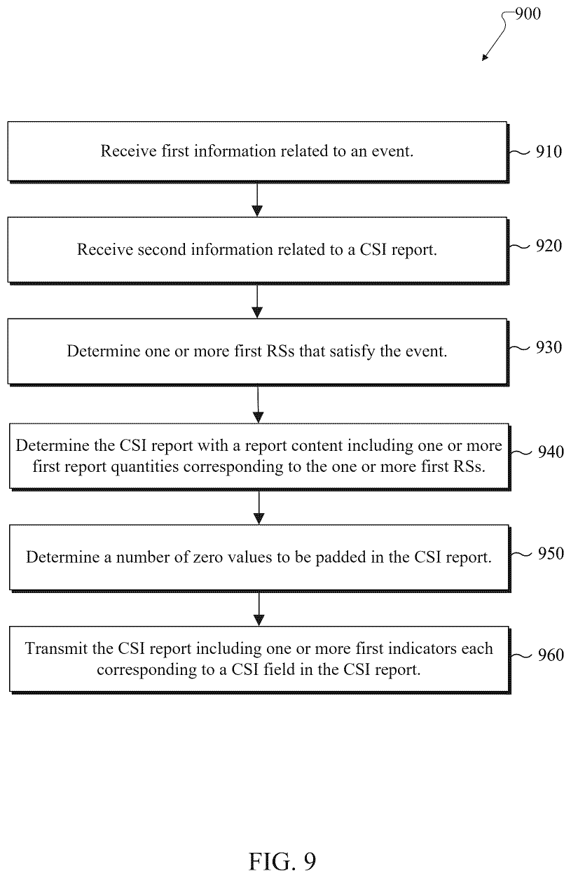

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving first information related to an event (910). In various embodiments, the first information indicates an event type and an event evaluation threshold. The UE then receives second information related to a CSI report (920). In various embodiments, the second information indicates at least one of a total number of report quantities; a number of report quantities that satisfy the event; a number of report quantities that do not satisfy the event; and a maximum number of payload sizes. In various embodiments, the number of zero values equals the maximum number of payload sizes minus a size of the report content.

The UE then determines one or more first RSs that satisfy the event (930). For example, in 930, the one or more first RSs are from a configured set of RSs and the determination is based on the first and second information. The UE then determines the CSI report with a report content including one or more first report quantities corresponding to the one or more first RSs (940). For example, in 940, the determination is based on the second information. The UE then determines a number of zero values to be padded in the CSI report (950). For example, the determination is based on the second information and the report content.

The UE then transmits the CSI report including one or more first indicators each corresponding to a CSI field in the CSI report (960). For example, in 960, each of the one or more first indicators indicates a presence or absence of a first report quantity in the corresponding CSI field. In various embodiments, a first indicator from the one or more first indicators is set to a value of 1 and the value of 1 indicates the presence of the first report quantity in the corresponding CSI field.

In various embodiments, the UE further determines, based on the first and second information, one or more second RSs, from the configured set of RSs, that do not satisfy the event and determines, based on the second information, the CSI report with the report content including one or more second report quantities corresponding to the one or more second RSs. In various embodiments, the CSI report includes one or more second indicators each corresponding to a CSI field in the CSI report, each of the one or more second indicators indicates a presence or absence of a second report quantity in the corresponding CSI field, a second indicator from the one or more second indicators is set to a value of 0, and the value of 0 indicates the presence of the second report quantity in the corresponding CSI field.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to an event; and
receive second information related to a channel state information (CSI) report; and
a processor operably coupled with the transceiver, the processor configured to:
determine, based on the first and second information, one or more first reference signals (RSs), from a configured set of RSs, that satisfy the event;
determine, based on the second information, the CSI report with a report content including one or more first report quantities corresponding to the one or more first RSs; and
determine, based on the second information and the report content, a number of zero values to be padded in the CSI report,
wherein the transceiver is further configured to transmit the CSI report including one or more first indicators each corresponding to a CSI field in the CSI report, and
wherein each of the one or more first indicators indicates a presence or absence of a first report quantity in the corresponding CSI field.

2. The UE of claim 1, wherein the first information indicates:
an event type; and
an event evaluation threshold.

3. The UE of claim 1, wherein the second information indicates at least one of:
a total number of report quantities;
a number of report quantities that satisfy the event;
a number of report quantities that do not satisfy the event; and
a maximum number of payload sizes.

4. The UE of claim 3, wherein the number of zero values equals the maximum number of payload sizes minus a size of the report content.

5. The UE of claim 1, wherein:
a first indicator from the one or more first indicators is set to a value of 1, and
the value of 1 indicates the presence of the first report quantity in the corresponding CSI field.

6. The UE of claim 1, wherein:
the transceiver is further configured to:
determine, based on the first and second information, one or more second RSs, from the configured set of RSs, that do not satisfy the event; and
determine, based on the second information, the CSI report with the report content including one or more second report quantities corresponding to the one or more second RSs.

7. The UE of claim 6, wherein:
the CSI report includes one or more second indicators each corresponding to a CSI field in the CSI report,
each of the one or more second indicators indicates a presence or absence of a second report quantity in the corresponding CSI field,
a second indicator from the one or more second indicators is set to a value of 0, and
the value of 0 indicates the presence of the second report quantity in the corresponding CSI field.

8. A base station (BS), comprising:
a processor; and
a transceiver operably coupled with the processor, the transceiver configured to:
transmit first information related to an event;
transmit second information related to a channel state information (CSI) report; and
receive the CSI report including one or more first indicators each corresponding to a CSI field in the CSI report, the CSI report further including (i) a report content including one or more first report quantities corresponding to one or more first RSs, from a configured set of RSs, that satisfy the event and (ii) a number of zero values padded in the CSI report that are based on the second information and the report content,
wherein each of the one or more first indicators indicates a presence or absence of a first report quantity in the corresponding CSI field.

9. The BS of claim 8, wherein the first information indicates:
an event type; and
an event evaluation threshold.

10. The BS of claim 8, wherein the second information indicates at least one of:
a total number of report quantities;
a number of report quantities that satisfy the event;
a number of report quantities that do not satisfy the event; and
a maximum number of payload sizes.

11. The BS of claim 10, wherein the number of zero values equals the maximum number of payload sizes minus a size of the report content.

12. The BS of claim 8, wherein:
a first indicator from the one or more first indicators is set to a value of 1, and
the value of 1 indicates the presence of the first report quantity in the corresponding CSI field.

13. The BS of claim 8, wherein:
the transceiver is further configured to:
determine, based on the first and second information, one or more second RSs, from the configured set of RSs, that do not satisfy the event; and
determine, based on the second information, the CSI report with the report content including one or more second report quantities corresponding to the one or more second RSs.

14. The BS of claim 13, wherein:
the CSI report includes one or more second indicators each corresponding to a CSI field in the CSI report,
each of the one or more second indicators indicates a presence or absence of a second report quantity in the corresponding CSI field,
a second indicator from the one or more second indicators is set to a value of 0, and
the value of 0 indicates the presence of the second report quantity in the corresponding CSI field.

15. A method performed by a user equipment (UE), the method comprising:
receiving first information related to an event;
receiving second information related to a channel state information (CSI) report;
determining, based on the first and second information, one or more first reference signals (RSs), from a configured set of RSs, that satisfy the event;
determining, based on the second information, the CSI report with a report content including one or more first report quantities corresponding to the one or more first RSs;
determining, based on the second information and the report content, a number of zero values to be padded in the CSI report;
transmitting the CSI report including one or more first indicators each corresponding to a CSI field in the CSI report,
wherein each of the one or more first indicators indicates a presence or absence of a first report quantity in the corresponding CSI field.

16. The method of claim 15, wherein the first information indicates:
an event type; and
an event evaluation threshold.

17. The method of claim 15, wherein the second information indicates at least one of:
a total number of report quantities;
a number of report quantities that satisfy the event;
a number of report quantities that do not satisfy the event; and
a maximum number of payload sizes.

18. The method of claim 17, wherein the number of zero values equals the maximum number of payload sizes minus a size of the report content.

19. The method of claim 15, wherein:
a first indicator from the one or more first indicators is set to a value of 1, and
the value of 1 indicates the presence of the first report quantity in the corresponding CSI field.

20. The method of claim 15 further comprising:
determining, based on the first and second information, one or more second RSs, from the configured set of RSs, that do not satisfy the event; and
determining, based on the second information, the CSI report with the report content including one or more second report quantities corresponding to the one or more second RSs.
